(19) United States
(12) Patent Application Publication
(10) Pub. No.: US 2014/0330691 A1
(43) Pub. Date: Nov. 6, 2014

(54) DEVICES, METHODS AND SYSTEMS RELATED TO AUTOMATION THAT PROVIDES FINANCIAL PLANNING ADVICE

(71) Applicant: Life Dreams, Inc., Seattle, WA (US)

(72) Inventor: Alejandro J. Samano Palacios, Seattle, WA (US)

(21) Appl. No.: 14/267,875

(22) Filed: May 1, 2014

Related U.S. Application Data
(60) Provisional application No. 61/817,880, filed on May 1, 2013.

(51) Int. Cl. G06Q 40/00

(52) U.S. Cl. CPC G06Q 40/00
USPC 705/35

(57) ABSTRACT

Computationally implemented methods and systems include generating at least one financial plan container that includes a template of one or more variables, said financial plan container configured to receive and/or contain client data, and said template of one or more variables is based on one or more of a type of the financial plan container and financial plan data, facilitating presentation of at least a portion of the at least one financial plan container that is configured to receive the client data, and applying one or more projection factors to the at least one financial plan container that contains the client data. In addition to the foregoing, other aspects are described in the claims, drawings, and text.

### CROSS-REFERENCE TO RELATED APPLICATIONS

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application claims benefit of priority under 35 U.S.C. §119(e) of U.S. Provisional Patent Application No. 61/817,880 titled A SYSTEM, DEVICE, AND METHODS TO PROVIDE DO-IT-YOURSELF FINANCIAL PLANNING ADVICE, naming ALEJANDRO J SAMANO PALACIOS as inventor, filed 1 May 2013, which was filed within the twelve months preceding the filing date of the present application or is an application of which a currently co-pending application is entitled to the benefit of the filing date.

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### BACKGROUND

This application is related to devices, methods and systems that include automation that assists in provision of financial planning advice.

### SUMMARY

The conventional financial planning industry is built around a traditional professional services model. For example, the customer solicits the services of an expert, a financial planner or investment advisor, who charges an hourly fee or a management fee to advise customers. This interaction relies on face to face meetings where the expert uses proprietary financial planning software tools specifically built for the financial planner, that generate reports that the financial planner then shares with clients. There are multiple challenges with this model that have limited its availability to less than 15% of the US population, which will be described briefly herein.

The first availability-limiting challenge of the traditional model is cost. Financial advisors typically require around $2,000 in services fees per year, or at least $200,000 in assets under management of the financial advisor, as a threshold for working with a client. This threshold represents more than the average family or individual can afford to pay, thus creating a barrier to entry.

The second availability-limiting challenge of the traditional model is bias. This bias may manifest itself in a number of different ways. Many financial advisors work on commission, for example, collecting 0.5% of every transaction as fees, which incentivizes a cycle of constantly moving assets around. Moreover, many financial advisors are incentivized by various product managers or fund managers, and thus receive additional compensation for directing clients to particular investments or insurance products. In addition, many financial advisors work for large corporations that, in addition to providing financial planning advice, also offer their own investment vehicles, which are heavily pushed by their financial advisor. Even if these factors do not result in noticeable bias, they create a situation in which the financial planner's goals do not necessarily align with the client's goals.

The third availability-limiting challenge of the traditional model is limited life goals. Many existing products for financial advisors to generate advice focus on a limited number of goals (e.g., retirement, college, offspring), and only refresh their cost data on a limited timeframe (e.g., every two years). The average individual and family, however, may have a much wider range of goals (e.g., a European vacation, a house remodel, a purchase of a boat), and their costs need more frequent updates, and more granulated models in order to remain accurate.

The fourth availability-limiting challenge of the traditional model is inconvenience to the client. Financial advisors often require clients to see them in-person, and on their schedule. Clients are forced to wait until they can visit their financial advisor in order to update their financial plan, rather than updating their financial plan as life events, which may be unexpected, occur.

The fifth availability-limiting challenge of the traditional model is timeliness. The plans that are produced by advisors, or that are produced by the software components relied on by the advisors, are usually refreshed only once or twice a year, and only when the client visits their financial advisor.

Thus, a need has arisen for a way to deliver financial planning advice to the estimated 85% of the population that does not have access to traditional models of financial planning, or that is not well-served by the traditional models of financial planning.

In one or more various aspects, a computationally-implemented method includes, but is not limited to, generating at least one financial plan container that includes a template of one or more variables, said financial plan container configured to receive and/or contain client data, and said template of one or more variables is based on one or more of a type of the financial plan container and financial plan data, facilitating presentation of at least a portion of the at least one financial plan container that is configured to receive the client data, and applying one or more projection factors to the at least one financial plan container that contains the client data. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for affecting the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

In one or more various aspects, a system includes, but is not limited to, means for generating at least one financial plan container that includes a template of one or more variables, said financial plan container configured to receive and/or contain client data, and said template of one or more variables is based on one or more of a type of the financial plan container and financial plan data, means for facilitating presentation of at least a portion of the at least one financial plan container that is configured to receive the client data, and means for applying one or more projection factors to the at least one financial plan container that contains the client data. In addition to the foregoing, other system aspects are described in the claims, drawings, and text forming a part of the disclosure set forth herein.

In one or more various aspects, a computer program product, comprising a signal bearing medium, bearing one or more instructions including, but not limited to, one or more instructions for generating at least one financial plan container that includes a template of one or more variables, said financial plan container configured to receive and/or contain client data, and said template of one or more variables is based on one or more of a type of the financial plan container and financial plan data, one or more instructions for facilitating presentation of at least a portion of the at least one financial plan container that is configured to receive the client data, and one or more instructions for applying one or more projection factors to the at least one financial plan container that contains the client data. In addition to the foregoing, other computer program product aspects are described in the claims, drawings, and text forming a part of the disclosure set forth herein.

In one or more various aspects, a device is defined by a computational language, such that the device comprises one or more interchained physical machines ordered for generating at least one financial plan container that includes a template of one or more variables, said financial plan container configured to receive and/or contain client data, and said template of one or more variables is based on one or more of a type of the financial plan container and financial plan data, one or more interchained physical machines ordered for facilitating presentation of at least a portion of the at least one financial plan container that is configured to receive the client data, and one or more interchained physical machines ordered for applying one or more projection factors to the at least one financial plan container that contains the client data.

In addition to the foregoing, various other method and/or system and/or program product aspects are set forth and described in the teachings such as text (e.g., claims and/or detailed description) and/or drawings of the present disclosure.

In one or more embodiments, as described above, solutions for financial planning may be obtained. In an embodiment, the solutions for financial planning may be designed and built from the root level to be unbiased, that is, unaffected by commissions, conflicts of interest, self-owned or self-managed funds, and the like. In an embodiment, the solutions for financial planning may be designed and built to be used by any person, regardless of their financial understanding. In an embodiment, the solutions for financial planning may be designed to remove the need for a personal interaction between a financial planner and a client.

In one or more embodiments, as described above, solutions for financial planning may be designed to create real-time forecasts, by leveraging actual customer data to be more accurate, and up-to-the-minute, in some cases. In one or more embodiments, solutions for financial planning may be designed to have the flexibility to use one or more mathematical forecasting methods, which may be transparent to the user, if they so desire.

In one or more embodiments, as described above, solutions for financial planning may be designed and configured to be used across a plurality of devices, e.g., desktop computers, laptop computers, mobile phones, and tablets. In one or more embodiments, as described above, the solutions for financial planning may be configured such that the user's information and plan is synchronized, current, and available, and can be changed or updated through an interaction with a simple, intuitive user interface capable of running across a plurality of different devices and types of devices.

In one or more embodiments, as described above, solutions for financial planning may be designed and built to allow a user to invite other users, and to share their plan and information with the other users, whether they are family, friends, acquaintances, and the like. In one or more embodiments, as described above, the data from a set of users that use the system may be used, anonymously, to improve portions of the forecasting models, to allow more accurate forecasting that is updated and modified in near-real-time, rather than waiting for data to be reported, studied, analyzed, and then accounted for in the various models and equations.

The foregoing is a summary and thus may contain simplifications, generalizations, inclusions, and/or omissions of detail. Consequently, those skilled in the art will appreciate that the foregoing summary is illustrative only and is not intended to define the scope of the disclosure set forth herein, or be in any way limiting. Other aspects, features, and advantages of the devices, systems, methods, and other subject matter described herein will be apparent to those of skill in the art by reference to the detailed description, the corresponding drawings, and/or the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1 shows a high-level block diagram of an exemplary environment 100, including a main service server 105, according to an embodiment.

FIG. 2 shows a high-level conceptual diagram of an operation of the system, according to an embodiment.

FIG. 3 shows an exemplary implementation of a main service server 105, according to an embodiment.

FIG. 4 shows an exemplary high-level logic flowchart of a process, e.g., operational flow 400, according to an embodiment.

FIG. 5 shows an exemplary high-level logic flowchart of a process, e.g., operational flow 500, according to an embodiment.

FIG. 6 shows an exemplary high-level logic flowchart of a process, e.g., operational flow 600, according to an embodiment.

FIG. 7 shows an exemplary high-level logic flowchart of a process, e.g., operational flow 700, according to an embodiment.

FIG. 8 shows an exemplary implementation of a main service server 105, according to an embodiment.

FIG. 9 shows an exemplary implementation of a main service server 105, according to an embodiment.

FIG. 10A shows a particular perspective of a financial plan container generating module 852, according to various embodiments.

FIG. 10B shows a particular perspective of a financial plan container generating module 852, according to various embodiments.

FIG. 10C shows a particular perspective of a financial plan container generating module 852, according to various embodiments.

FIG. 10D shows a particular perspective of a financial plan container generating module 852, according to various embodiments.

FIG. 10E shows a particular perspective of a financial plan container generating module 852, according to various embodiments.

FIG. 10F shows a particular perspective of a financial plan container generating module 852, according to various embodiments.

FIG. 10G shows a particular perspective of a financial plan container generating module 852, according to various embodiments.

FIG. 10H shows a particular perspective of a financial plan container generating module 852, according to various embodiments.

FIG. 10I shows a particular perspective of a financial plan container generating module 852, according to various embodiments.

FIG. 11A shows a particular perspective of a financial plan container portion presentation facilitating module 854, according to various embodiments.

FIG. 11B shows a particular perspective of a financial plan container portion presentation facilitating module 854, according to various embodiments.

FIG. 12A shows a projection factor applying to a financial plan container module 856, according to various embodiments.

FIG. 12B shows a projection factor applying to a financial plan container module 856, according to various embodiments.

FIG. 12C shows a projection factor applying to a financial plan container module 856, according to various embodiments.

FIG. 13 shows a financial plan container incorporation into client financial plan module 858, according to various embodiments.

FIG. 14 shows a client financial plan presentation facilitating module 859, according to various embodiments.

FIG. 15 shows an exemplary structure of a container 1500, according to an embodiment.

FIG. 16A shows a portion of an exemplary structure of one or more compartments of container 1500, according to various embodiments.

FIG. 16B shows a portion of an exemplary structure of one or more compartments of container 1500, according to various embodiments.

FIG. 16C shows a portion of an exemplary structure of one or more compartments of container 1500, according to various embodiments.

FIG. 17 shows a high-level logic flow chart of a process, e.g., operational flow 1700, according to an embodiment.

FIG. 18A shows a high-level logic flowchart of a process depicting various implementations of a generating at least one financial plan container operation 1702.

FIG. 18B shows a high-level logic flowchart of a process depicting various implementations of a generating at least one financial plan container operation 1702.

FIG. 18C shows a high-level logic flowchart of a process depicting various implementations of a generating at least one financial plan container operation 1702.

FIG. 18D shows a high-level logic flowchart of a process depicting various implementations of a generating at least one financial plan container operation 1702.

FIG. 18E shows a high-level logic flowchart of a process depicting various implementations of a generating at least one c financial plan container operation 1702.

FIG. 18F shows a high-level logic flowchart of a process depicting various implementations of a generating at least one financial plan container operation 1702.

FIG. 18G shows a high-level logic flowchart of a process depicting various implementations of a generating at least one financial plan container operation 1702.

FIG. 18H shows a high-level logic flowchart of a process depicting various implementations of a generating at least one financial plan container operation 1702.

FIG. 18I shows a high-level logic flowchart of a process depicting various implementations of a generating at least one financial plan container operation 1702.

FIG. 19A shows a high-level logic flowchart of a process depicting various implementations of a facilitating presentation of at least a portion of the at least one financial plan container operation 1704.

FIG. 19B shows a high-level logic flowchart of a process depicting various implementations of a facilitating presentation of at least a portion of the at least one financial plan container operation 1704.

FIG. 20A shows a high-level logic flowchart of a process depicting various implementations of an applying one or more projection factors to the at least one financial plan container operation 1706.

FIG. 20B shows a high-level logic flowchart of a process depicting various implementations of an applying one or more projection factors to the at least one financial plan container operation 1706.

FIG. 20C shows a high-level logic flowchart of a process depicting various implementations of an applying one or more projection factors to the at least one financial plan container operation 1706.

FIG. 21 shows a high-level logic flowchart of a process depicting various implementations of an incorporating the at least one container into a client financial plan operation 1708.

FIG. 22 shows a high-level logic flowchart of a process depicting various implementations of a facilitating presentation of the client financial plan operation 1709.

FIG. 23 shows an exemplary generation of a portion of a client interface that shows the financial plan, according to an embodiment.

FIG. 24 shows an exemplary generation of a portion of a client interface that shows a health of the financial plan, according to an embodiment.

FIG. 25 shows an exemplary generation of various portions of a client interface, according to an embodiment.

FIG. 26 shows an exemplary generation of various portions of a client interface, according to an embodiment.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Thus, in accordance with various embodiments, computationally implemented methods, systems, circuitry, articles of manufacture, ordered chains of matter, and computer program products are designed to, among other things, provide an interface for generating at least one financial plan container that includes a template of one or more variables, said financial plan container configured to receive and/or contain client data, and said template of one or more variables is based on one or more of a type of the financial plan container and financial plan data, facilitating presentation of at least a portion of the at least one financial plan container that is configured to receive the client data, and applying one or more projection factors to the at least one financial plan container that contains the client data.

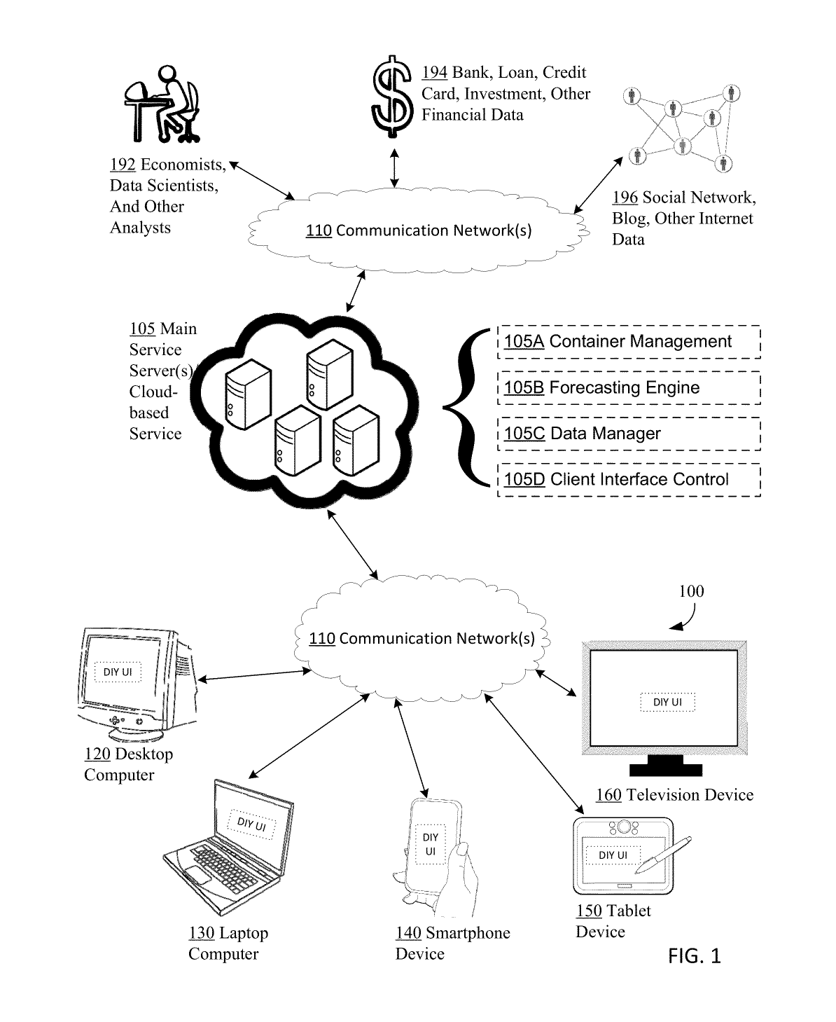

Referring now to FIG. 1, FIG. 1 shows a high-level view of the entire system of automating and democratizing financial planning, according to one or more embodiments. For example, in an embodiment, a main service server 105 is present in an exemplary environment 100. Main service server 105 may be a collection of one or more computers, servers, and computer equipment, that is designed to handle the data in the systems, including receiving and distributing financial data. Main service server 105 will be described in more detail herein. In an embodiment, main service server 105 may communicate with one or more devices that are operated by clients, e.g., users of the financial planning services. For example, as shown in FIG. 1, main service server 105 may communicate with desktop computer 120, laptop computer 130, smartphone device 140, tablet device 150, and television device 160. As will be discussed in more detail herein, main service server 105 allows a consistent, friendly user interface to be presented across many devices. In an embodiment, this user interface may display various containers, e.g., Life Cards, to users of the system. As will be discussed in more detail herein, the Life Cards may be designed to allow the clients (e.g., the users of the system) to enter in enough data to obtain a personalized forecasting model, without requiring the client to know any specific information about financial planning or financial understanding. Each Life Card may be tightly controlled to create a user interface in which the client is asked one or a series of simple questions, and for which limited input is accepted. The Life Card, which may have its own economic data associated with it, then can be combined with other Life Cards, which, when inputted into a forecasting model, allow a specifically tailored financial plan to be presented to the client, with minimal strain on the client's resources. These features will be discussed in more detail herein.

Referring again to FIG. 1, main service server 105 may include a container management feature 105A that manages the containers, e.g., the Life Cards, a forecasting engine 105B that handles the forecasting of the financial plan, a data manager 105C that manages the data in the system, including the containers, and a user interface control 105D that manages the overarching user interface, of which the Life Cards are a part. Each of these features will be discussed in more detail herein.

Referring again to FIG. 1, main service server 105 may receive data from a variety of sources. One example of those sources may be from analysts 192. Analysts 192 may include economists, data scientists, statisticians, financial planners, modelers, and the like. Another example of those sources is financial institutions 194. Financial institutions 194 may include banks, credit card companies, investment companies, and any other financial institution with an online presence. In an embodiment, the data stored electronically by financial institutions 194 that is made available to the various clients, may be accessed by the main service server 105, e.g., with the particular client's permission and a copy of their credentials. A third example of those sources may be social network 196. For example, life data, e.g., relationship status, large purchase data, location information, educational information, and the like, may be publicly available on various social networks, or may be accessed, with the client's permission and credentials, by main service server 105.

Main service server 105 may communicate with various client devices 120, 130, 140, and 150, and various data sources 192, 194, and 196 through one or more communication networks 110. Communication network 110 may be any type of network, including, but not limited to one or more of a local area network (LAN), a wide area network (WAN), a metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, and so forth. The communication networks 110 may be wired, wireless, or a combination of wired and wireless networks. It is noted that “communication network” as used herein and in the drawings refers to one or more communication networks, which may or may not interact with each other and which, in some embodiments, may work in concert, wittingly or unwittingly, to facilitate communication between one or more entities.

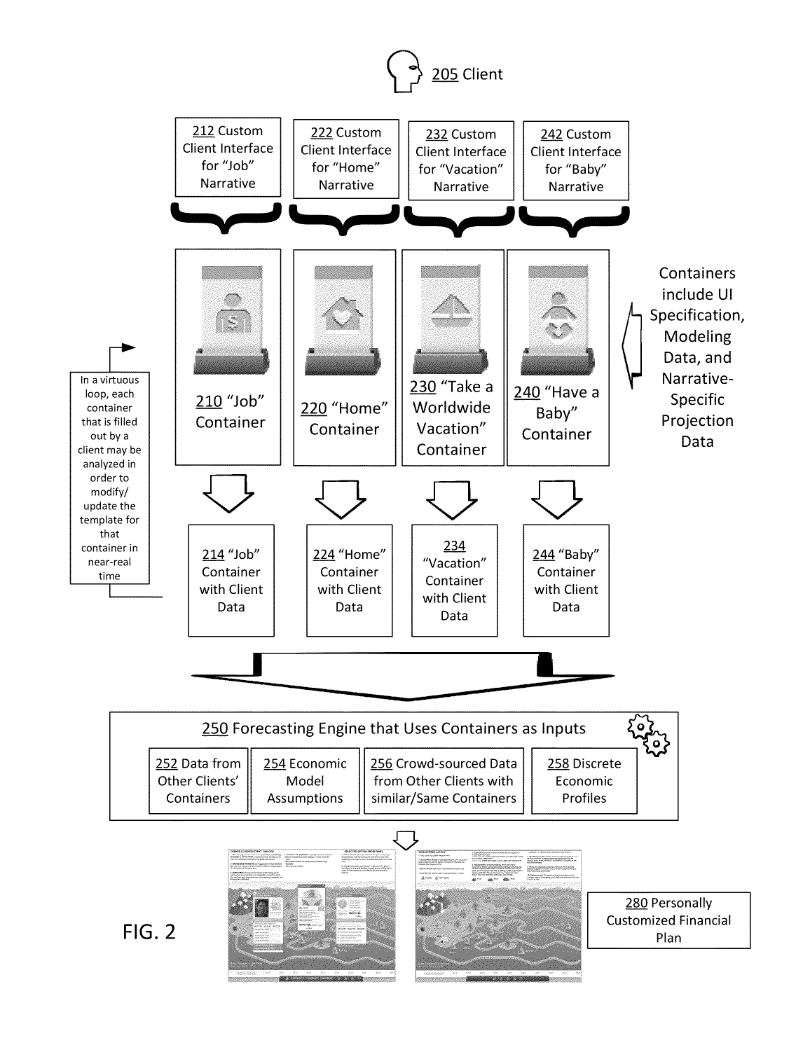

Referring now to FIG. 2, FIG. 2 shows a high-level implementation of the system according to various embodiments. In an embodiment, a user, e.g., a client 205 logs onto the system for the first time. In response to seeing that the user has logged on for the first time, the system presents the user with one or more containers, e.g., Life Cards. These containers will be discussed in more detail herein, but as a summary, in an embodiment, each container contains a narrative. The narrative may be an event, occurrence, or a condition. Each container has a specification for the user interface which is designed to reduce the complexity of the queries to the user, so that the user can obtain a customized, accurate financial plan simply by answering the queries that are tied to each container. For example, when a client 205 logs on for the first time, they may be led to fill out various containers, e.g., a “job,” container 210, which prompts the client 205 to answer basic questions about the client's job. Depending on the answers to the questions specified by the “job” container 210, the “job” container 210 may generate different questions. Moreover, depending on the answers to the questions specified by the “job” container, other containers may be generated, and presented to the client 205 for filling in the client data. For example, if, in the interface of “job” container 210, the client 205 specifies that she is “self-employed,” that may generate a “small business” container that the client 205 will then fill out. Other examples of containers include a “home” container 220, where the client 205 can enter in information about her home, a “vacation” container 230 where the client 205 can enter data about a vacation the client would like to take, and a “baby” container 240 where the user can enter her family information and/or family plans.

Referring again to FIG. 2, one or more of the containers may contain a specification for the client interface, modeling data that is specific to that type of container, and narrative-specific projection data, which will all be discussed in more detail later. After the client 205 has entered in her data into the containers, the filled out containers 214, 224, 234, and 244 are generated. The filled-out client data containers 214, 224, 234, and 244 will be entered as inputs to a forecasting engine 250, which may also include data from other clients' containers 252, economic model assumptions 254, crowd-sourced data 256, and discrete economic profiles 258. Forecasting engine 250 may take the inputted containers and select an economic profile to apply to the containers. This economic profile, along with the container data, and model data built into the forecasting engine, will generate a personally customized financial plan 280, which can be built for the client 205 without requiring complicated client inputs.

Referring again to FIG. 2, in an embodiment, when a data is added to a container by a client, that data is added to the collection of all the various inputs to that type of container. This data may be used to modify or update the container, for example, tailoring the default values, so that, for the next person that uses the system, the container may be more user-friendly and accurate. Moreover, the data from one container may be used in other containers, so that, for example, after a client fills out their “job” container, the data from the “job” container may be used to modify the “college savings” container that the client fills out next. Moreover, once the client has filled out the “job” container, and moves to the “college savings” container, the system may find other clients that have filled out the “job” container similarly to the current client, and modify the “college savings” container for the current client, based on the “college savings” containers from the similar other clients. In this way, the containers may self-tailor to the client as the client is filling out the containers, based on one or more of crowd-sourcing various container data, receiving data from third parties regarding what the container should look like, and from previously inputted data by the client herself.

The diagram in FIG. 2 is merely high-level and exemplary, and more detail of the workings of the system will be discussed herein, with respect to various embodiments.

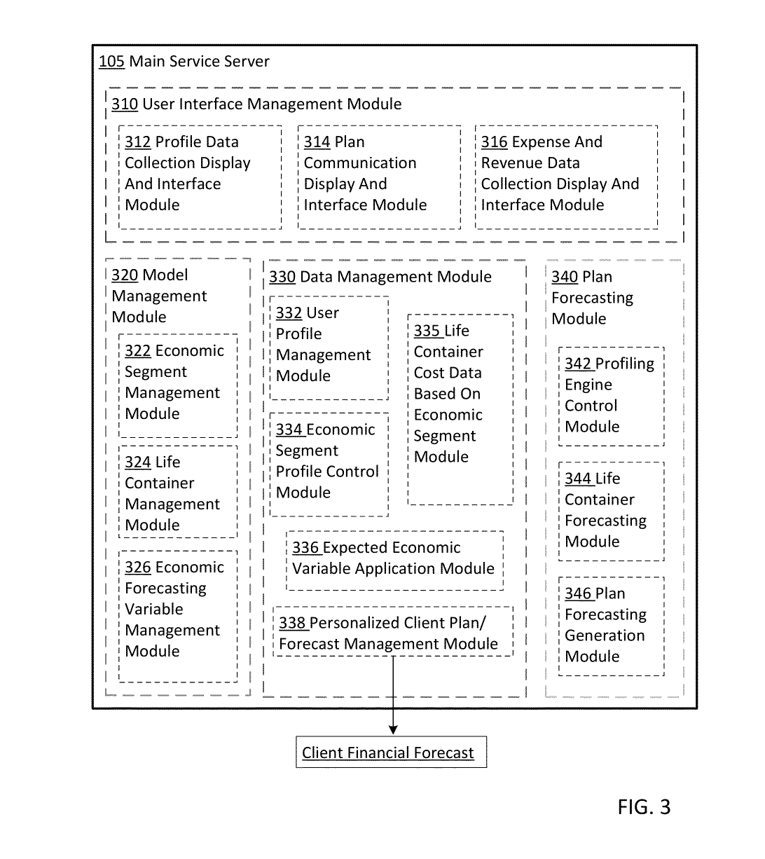

Referring now to FIG. 3, FIG. 3 shows an implementation of main service server 105 according to various embodiments. For example, as shown in FIG. 3, main service server 105 may include one or more of a user interface management module 310, a model management module 320, a data management module 330, and a plan forecasting engine module 340.

Throughout the instant application, reference may be made to “life containers,” which are representations of various occurrences, events, conditions, or other things that may have financial data associated with them. A “life container” may be an event, e.g., a marriage, a birth of a child, a purchase of a house, but is not limited to events. Life containers may include assets, events, people, debts, insurances, taxes, incomes, goals, current possessions, vacations, and so forth. In an embodiment of the invention, the “life container” is instantiated as a “life card,” for ease in presentation to the client interface, but this should not be considered to be a limiting feature. Any suitable interface that can be used to express a container should be considered within the scope of the following.

Referring again to FIG. 3, in an embodiment, user interface management module 310 manages the user interface that is displayed at the various client devices, e.g., desktop computer 120, laptop computer 130, smartphone device 140, and tablet device 150, as shown in FIG. 1. In an embodiment, the user interface is handled through a web browser that a client, e.g., client 205, accesses by directing their web browser to a public-facing web site that is operated by main service server 105. In an embodiment, the public-facing web site is hosted by a different server, e.g., a third party hosting service, than main service server 105, but main service server 105 controls at least a portion of the data flow through the system. In an embodiment, user interface management module 310 includes profile data collection display and interface module 312. In an embodiment, profile data collection display and interface module 312 may control the display of a profile screen, in which a new client to the system is presented with an opportunity to fill out one or more containers, e.g., Life Cards, corresponding to common life containers. For example, a new client may be prompted to fill out a Life Card for one or more of their housing situation, their job situation, their family situation, their vehicle situation, their outstanding debt situation, and their current savings situation. In an embodiment, as will be discussed in more detail herein, each Life Card, in conjunction with the overall system, e.g., profile data collection display and interface module 312, controls the various inputs that will be accepted. It is one purpose of the system to generate prompts for inputs that allow even unsophisticated clients to provide all the necessary data to the system to generate an initial profile, as will be discussed in more detail herein.

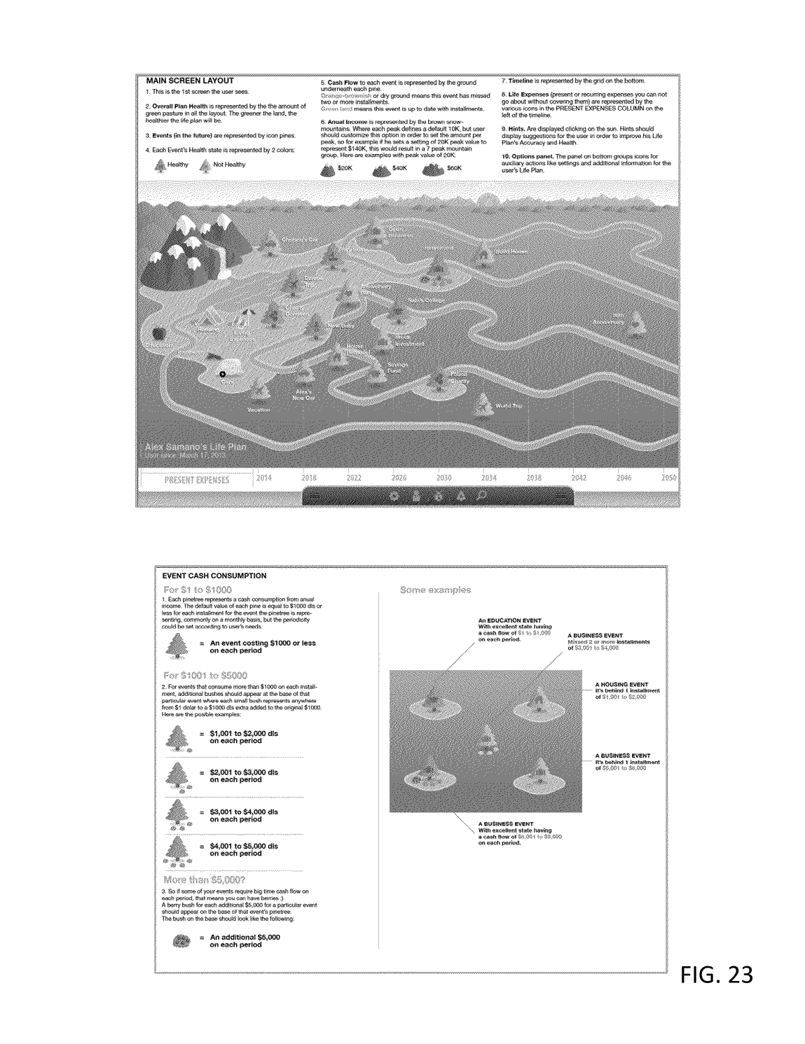

Referring again to FIG. 3, in an embodiment, user interface management module 310 includes plan communication display and interface module 314. Plan communication display and interface module 314 may be configured to facilitate the presentation of a visual representation of the client's financial plan, once that plan has been assembled, modified, updated, or otherwise operated upon. In an embodiment, the visual representation of the client's financial plan may be non-numeric. Some examples of the visual representation may be seen in FIGS. 23-26. In an embodiment, the visual representation of the client's financial plan may be numerical, and may be exported for storage on the client's system in a variety of formats.

Referring again to FIG. 3, in an embodiment, user interface management module 310 includes expense and revenue data collection display and interface module 316. Expense and revenue data collection display and interface module 316 may be configured to gather actual revenue/expense data about the client, for example, from electronic sources. For example, expense and revenue data collection display and interface module 316 may contact one or more financial institutions of the client, and with the client's permission, download bank or credit card statements from that institution. In this way, the system can update projections with actual numbers, without requiring data entry from the client, which may reduce mistakes made in transcribing the data, as well as ensuring that the data is timely updated, and accurate.

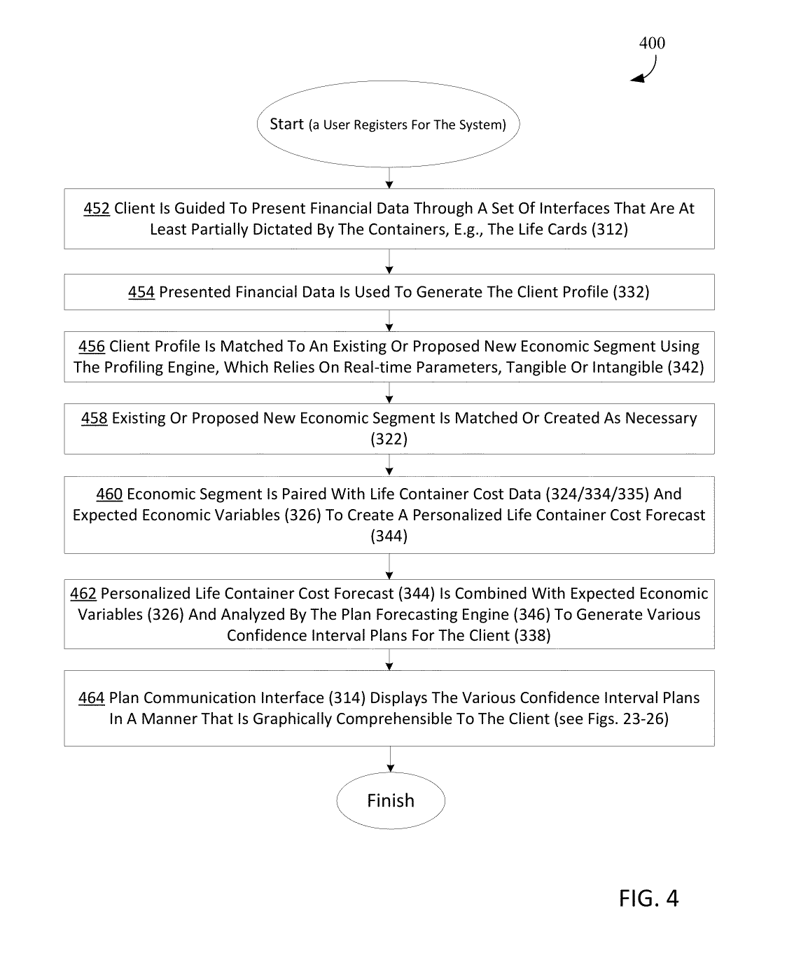

Referring again to FIG. 3, in an embodiment, main service server 105 may include model management module 320. Model management module 320 may include one or more of an economic segment management module 322, a life container management module 324, and an economic forecasting variable management module 326. Model management module 320 may be responsible for managing and controlling the various models that are used as the underlying framework for generating the financial plans. Each module of model management module 320 represents a different management process, and, although they are depicted separately in FIG. 3, in various embodiments, they may be intermingled or interdependent. As will be discussed in more detail in FIG. 4, economic segment management module 322 may operate when an economic change triggers one or more economists to update variables in the planning model, whether those variables are local, state, national, world, sector-based, market-based, index-based, or the like. As will be discussed in more detail in FIG. 4, life container management module 334 may monitor and/or receive data as actual expense data from various clients is tracked, monitored, and compared against projection data. When enough data has been collected to draw various correlations, the life container management module may use the collected data, and, in an embodiment, economist input, to modify various settings, or to create a new economic profile segment to take into account the real-world data that is tracked across clients. As will be discussed in more detail in FIG. 4, economic forecasting variable management module 326 may monitor macro and microeconomic effects, and consider industry or sector specific changes that may prompt a change in one or more variables in the various models.

Referring again to FIG. 3, in an embodiment, main service server 105 includes data management module 330. Data management module 330 may include a user profile management module 332 that is configured to store and track the user profile. Data management module 330 may include an economic segment profile control module 334 that may be configured to manage the profiles for various economic segments, with input from economic segment management module 322 of model management module 320. Data management module 330 may include life container cost data based on economic segment module 335, which may receive input from life container management module 324, as well as from other sources, and may be configured to track how much life containers that form the basis for containers will cost across various economic segments (for example, a house for a wealthy family in New York City will cost more than the same house for a middle-class family in West Virginia). Data management module 330 may include expected economic variable application module 336, which may receive input from economic forecasting variable management module 326, and which may control projections for various probability scenarios (e.g., 90% certainty intervals, 75% certainty intervals, 50% certainty intervals, and so on). Data management module 330 may include personalized client plan/forecast management generation module 338, which may receive the personalized client plan from the plan forecasting engine module, and feed the plan to the plan communication display and interface module 314, where the plan will be presented to the client.

Referring again to FIG. 3, in an embodiment, main service server 105 includes plan forecasting module 340, which generally may include the plan forecasting engine that generates the client plan from the various containers, e.g., the Life Cards, that contain the user input. Plan forecasting module 340 may include profiling engine control module 342, which may manage the variables, processes, and models that make up the profiling engine. The management of profiling engine control module 342 may, in some embodiments, happen in real-time or near real-time, in response to various tangible and intangible parameters. Profiling engine control module 342 may be wholly automated in various embodiments, or in other embodiments may receive inputs and directions from human operators. Plan forecasting module 340 may include life container forecasting module 344, which may generate forecasts for the various life containers that are associated with one or more of the containers. In an embodiment, plan forecasting module 340 may include plan forecasting generation module 346, which may receive the data from one or more other sources in the engine, and, combined with the containers that include the client data, may generate the client financial forecast.

FIG. 3 describes some of the modules of which main service server 105 is composed, in one or more embodiments. FIGS. 4-6 illustrate flow diagrams that describe how these modules interact, in various embodiments and under various scenarios. Referring now to FIG. 4, FIG. 4 shows an exemplary action of client plan creation and a management overview, according to various embodiments. A process 400 shown in FIG. 4 begins when a client registers for the system. At step 452, the client is guided to present financial data through a set of interfaces. These interfaces are designed to be minimally sophisticated, e.g., requiring little to no knowledge of financial mechanisms, and adaptable, e.g., an answer to one question has an effect on the next question that is asked. The interfaces are tied to one or more containers, e.g., a set of Life Cards. When a client first registers for the system, a standard set of Life Cards are presented to the user, representing the most common narratives, e.g., job, housing, family, debts, and savings. Once the user has interacted with these containers, and provided the needed information, processing moves to step 454. The interaction with the client and the data collection from the client may, in an embodiment, be handled by profile data collection display and interface module 312 of user interface management module 310 of main service server 105.

Referring again to FIG. 4, in an embodiment, after the financial data has been inputted by the user, in a minimally complicated manner, processing may move to step 454, where the presented financial data is used to generate the client profile. In an embodiment, this may be accomplished at least in part through user profile management module 332, which may receive the collected profile data from profile data collection display and interface module 312, and use that information to generate the client profile.

Referring again to FIG. 4, in an embodiment, after the client profile has been generated at step 454, then, in an embodiment, at step 456, the client profile is matched to an existing or proposed new economic segment using the profiling engine. The profiling engine, which may be a part of, or controlled by, profiling engine control module 342 of plan forecasting module 340, may compare the client profile to the existing economic segments, and, if a match is not found, propose that a new economic segment be generated to match the created client profile.

Referring again to FIG. 4, in an embodiment, after the client profile is matched at step 456, then, in an embodiment, at step 458, an existing or proposed new economic segment is matched or created as necessary. In an embodiment, step 458 may include input from the economic team of economists, data scientists, mathematicians, statisticians, and the like. In an embodiment, the existing economic segment is selected, or the new economic segment created, in part by economic segment management module 322 of model management module 320.

Referring again to FIG. 4, in an embodiment, after the economic segment is matched/created at step 458, then, in an embodiment, at step 460, the economic segment is paired with life container cost data, which may be generated from one or more of the life container management module 324, the economic segment profile control module 334, and the life container cost data based on economic segment module 335. This life container cost data may be paired with expected economic variables, e.g., from economic forecasting variable management module 326, to create a personalized life container cost forecast. The personalized life container cost forecast may be generated by life container forecasting module 344 of plan forecasting module 340.

Referring again to FIG. 4, in an embodiment, after the personalized life container cost forecast is generated in step 460, then, in an embodiment, at step 462, the personalized life container cost forecast may be combined with expected economic variables (e.g., from economic forecasting variable management module 326), and analyzed by the plan forecasting engine, e.g., by the plan forecasting generation module 346. Then, various confidence interval plans may be generated for the client, and transmitted to personalized client plan/forecast management module 338 of data management module 330.

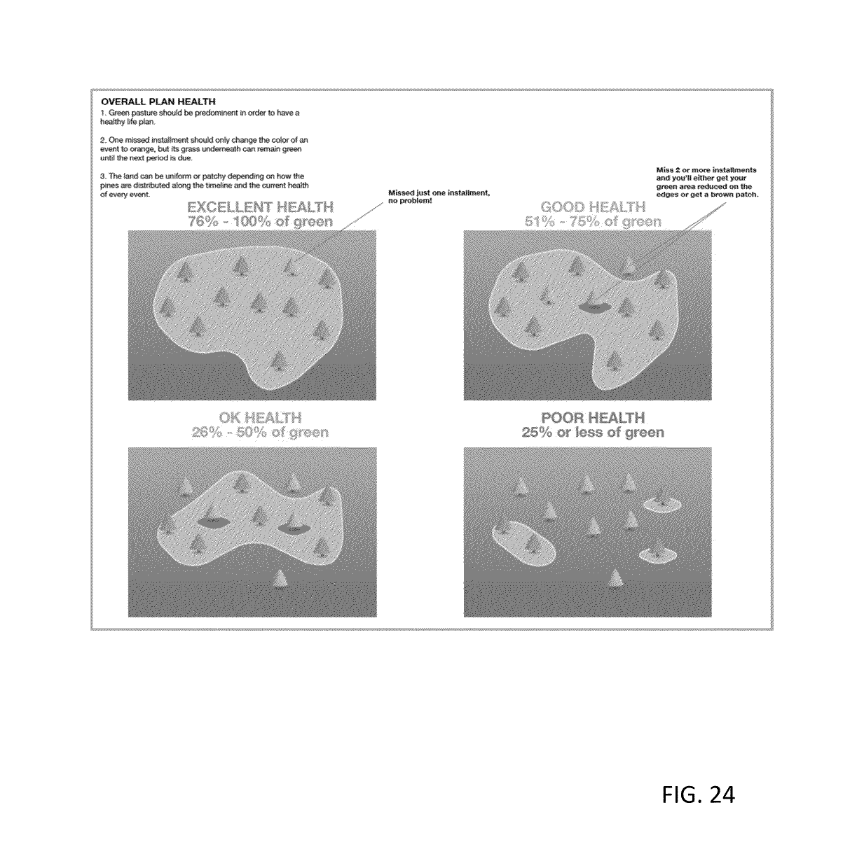

Referring again to FIG. 4, in an embodiment, after the confidence interval plans are generated for the client at step 462, then, at step 464, the plan communication interface may display the various confidence interval plans in a manner that is graphically comprehensible to the client. This display may occur at plan communication display and interface module 314 of user interface management module 310. An example of the graphical display of the plans may be found in one or more of FIGS. 23 and 24.

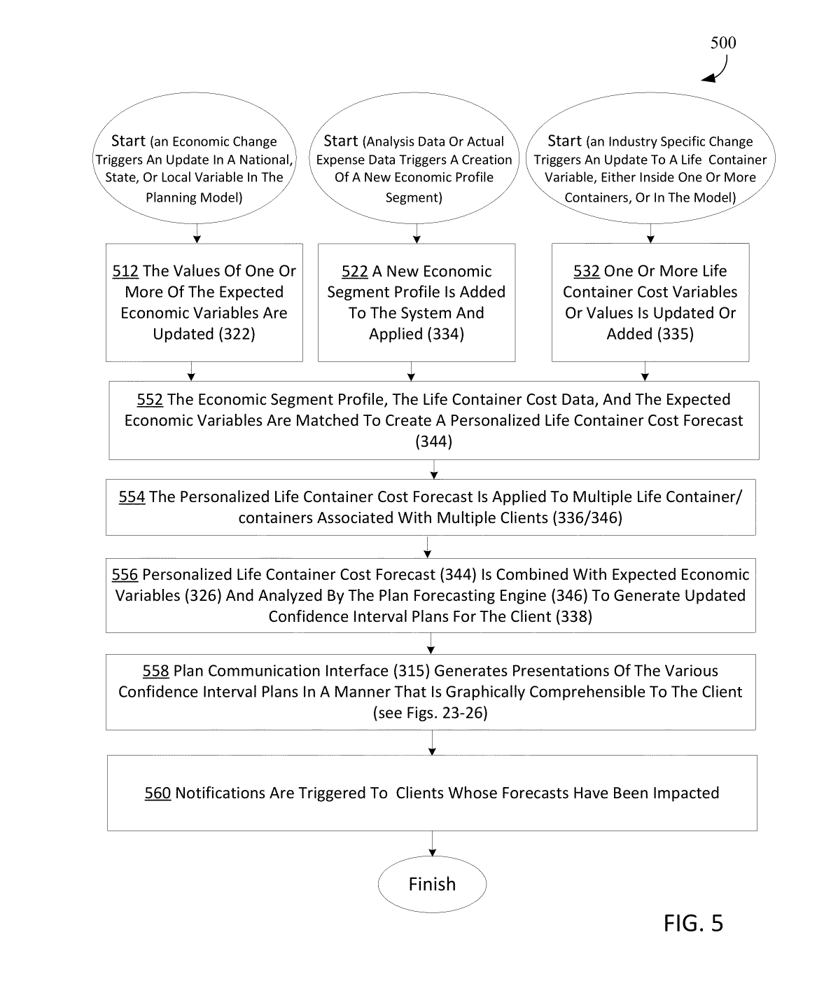

Referring now to FIG. 5, FIG. 5 shows an exemplary action of a real-time or near-real-time update of plan or life container variables, and propagating that change through the system, and notifying the clients of the updates.

Referring again to FIG. 5, there may be several different triggers for an update. In an embodiment, one trigger is an economic change that triggers an update in a national, state, or local variable in the planning model. For example, in an embodiment, such a change may invoke step 512 of FIG. 5, e.g., updating the values of one or more of the expected economic variables. In an embodiment, step 512 may involve economic segment management module 322, which may manage the control of the various variables, and the scopes to which the various variables are applied. For example, in an embodiment, another trigger is an analysis data, or a receipt of sufficient actual data, e.g., expense data, that is sufficient to trigger a creation of a new economic profile segment. This creation of the new economic profile segment may be done automatically, or with the assistance of one or more economists, data scientists, analysts, and statisticians. In an embodiment, this may trigger step 522, in which a new economic segment profile is added to the system and applied. In an embodiment, step 522 may invoke economic segment profile control module 334, which may manage the various economic segment profiles and their application. For example, yet another trigger may be an industry specific change that causes an update to a life container variable, e.g., a rise in home cost inflation. This life container variable may be present in a container (e.g., a “home” narrative container), or it may be part of the overall model that takes the containers as input. In an embodiment, this trigger may invoke step 532 to update or add one or more life container cost variables or values. In an embodiment, step 532 may be carried out by life container cost data based on economic segment module 335.

Referring again to FIG. 5, in an embodiment, any of steps 512, 522, and 532 may result in processing continuing to step 552, in which the economic segment profile, the life container cost data, and the expected economic variables are matched to create a personalized life container cost forecast. This creation of a personalized life container cost forecast may be similar to the step 460 of FIG. 4. In an embodiment, the personalized life container cost forecast may be generated by life container forecasting module 344 of plan forecasting module 340.

Referring again to FIG. 5, in an embodiment, after step 552 is carried out, processing may move to step 554, in which the personalized life container cost forecast generated in step 552 is applied to multiple life containers or containers associated with multiple clients in the system. Step 554 may be carried out by one or more of expected economic variable application module 336, which may be applied at the container level, and plan forecasting generation module 346, which may be applied at the overall forecast level.

Referring again to FIG. 5, in an embodiment, after step 554 is carried out, then processing may move to step 556. In an embodiment, step 556 may be a step of combining the personalized life container cost forecast (e.g., which may be produced by the life container forecasting module 344) with the expected economic variables (e.g., which may be stored in the economic forecasting variable management module 326). This combination may then be analyzed by the plan forecasting engine, as directed by the plan forecasting generation module 346, to generate updated confidence interval plans for multiple clients. These updated confidence interval plans may be stored and managed by personalized client plan/forecast management module 338.

Referring again to FIG. 5, in an embodiment, after step 556 is carried out, processing may move to step 558. In an embodiment, step 558 may be similar to step 464 of FIG. 4. In an embodiment, step 558 describes that the plan communication interface may generate the various confidence interval plans in a manner that is graphically comprehensible to the client. This generation may occur at plan communication display and interface module 314 of user interface management module 310. The generation may happen as needed, e.g., just-in-time generation, or the generation of the graphically comprehensible confidence interval plans may be done in advance, and retrieved when needed, or a combination thereof. An example of the graphical display of the plans may be found in one or more of FIGS. 23 and 24.

Referring again to FIG. 5, in an embodiment, after presentations of the various confidence interval plans are generated at step 558, then, in an embodiment, in step 560, notifications are triggered to multiple clients whose forecasts have been impacted. In an embodiment, the clients whose forecasts have been impacted, whether positively or negatively, are notified, and clients whose forecasts are not impacted, may not be notified.

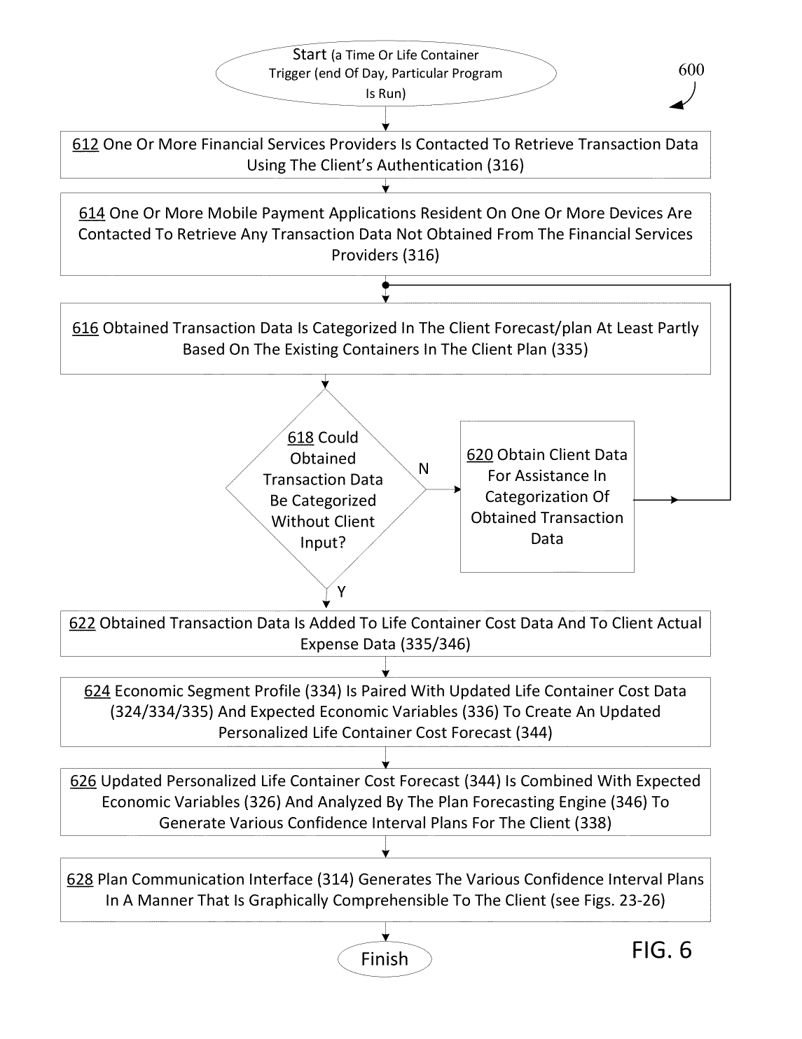

Referring now to FIG. 6, FIG. 6 shows an exemplary action of tracking the client financial forecast/plan in real time or near real-time, and/or collecting and categorizing expense data. In an embodiment, FIG. 6 shows process 600, which may start with a step 612 of contacting one or more financial services providers to retrieve transaction data using the client's authentication. For example, a client may give the system permission to access one or more bank accounts, investment accounts, credit card accounts, and the like. The client may provide the login credentials to the system, so that the system can automatically retrieve transaction data, e.g., purchases, credits, debits, deposits, appreciation, depreciation, interest, penalties, and the like, from the various financial services providers. In an embodiment, this information gathering may be handled by expense and revenue data collection display and interface module 316 of user interface management module 310 of main service server 105, as shown in FIG. 3.

Referring again to FIG. 6, in process 600, after step 612, processing may move to step 614, which includes contacting one or more mobile payment applications resident on one or more devices. These mobile payment applications may reside on a client's computer, laptop, tablet, or smartphone device, and may include transaction data that is not readily retrieved from the financial services providers. In an embodiment, step 614 also may be carried out by expense and revenue data collection display and interface module 316 of user interface management module 310 of main service server 105, as shown in FIG. 3.

Referring again to FIG. 6, in process 600, in an embodiment, after step 614, processing may move to step 616, in which the obtained transaction data about the client's expenses and incomes is categorized according to the containers, e.g., the narratives, e.g., the Life Cards, associated with that client. In an embodiment, if the obtained transaction data can be categorized at step 618, them processing moves to step 622. If the obtained transaction data cannot be categorized, e.g., it is not recognized as one of the existing categories, then a request is sent for client data to assist in the categorization of the data at step 620.

Referring again to FIG. 6, in process 600, in an embodiment, processing may move to step 622, which describes that the obtained transaction data is factored into the life container cost data, which may be managed by life container cost data based on economic segment module 335, and to actual expense data of the client, which may be managed by life container cost data based on economic segment module 335 and plan forecasting generation module 346.

Referring again to FIG. 6, in process 600, in an embodiment, after step 622 is completed, processing may move to step 624, in which the economic segment is paired with the updated life container cost data, which may be generated from one or more of the life container management module 324, the economic segment profile control module 334, and the life container cost data based on economic segment module 335, and that has been updated with the categorized transaction data. This life container cost data may be paired with expected economic variables, e.g., from economic forecasting variable management module 326, to create a personalized life container cost forecast. The personalized life container cost forecast may be generated by life container forecasting module 344 of plan forecasting module 340.

Referring again to FIG. 6, in process 600, after step 624 is completed, processing may move to step 626, in which the updated personalized life container cost forecast may be combined with expected economic variables (e.g., from economic forecasting variable management module 326), and analyzed by the plan forecasting engine, e.g., by the plan forecasting generation module 346. Then, various confidence interval plans may be generated for the client, and transmitted to personalized client plan/forecast management module 338 of data management module 330.

Referring again to FIG. 6, in process 600, after step 626 is completed, processing may move to step 628, in which the plan communication interface may generate the various confidence interval plans in a manner that is graphically comprehensible to the client. This generation may occur at plan communication display and interface module 314 of user interface management module 310. The generation may happen as needed, e.g., just-in-time generation, or the generation of the graphically comprehensible confidence interval plans may be done in advance, and retrieved when needed, or a combination thereof. An example of the graphical display of the plans may be found in one or more of FIGS. 23 and 24.

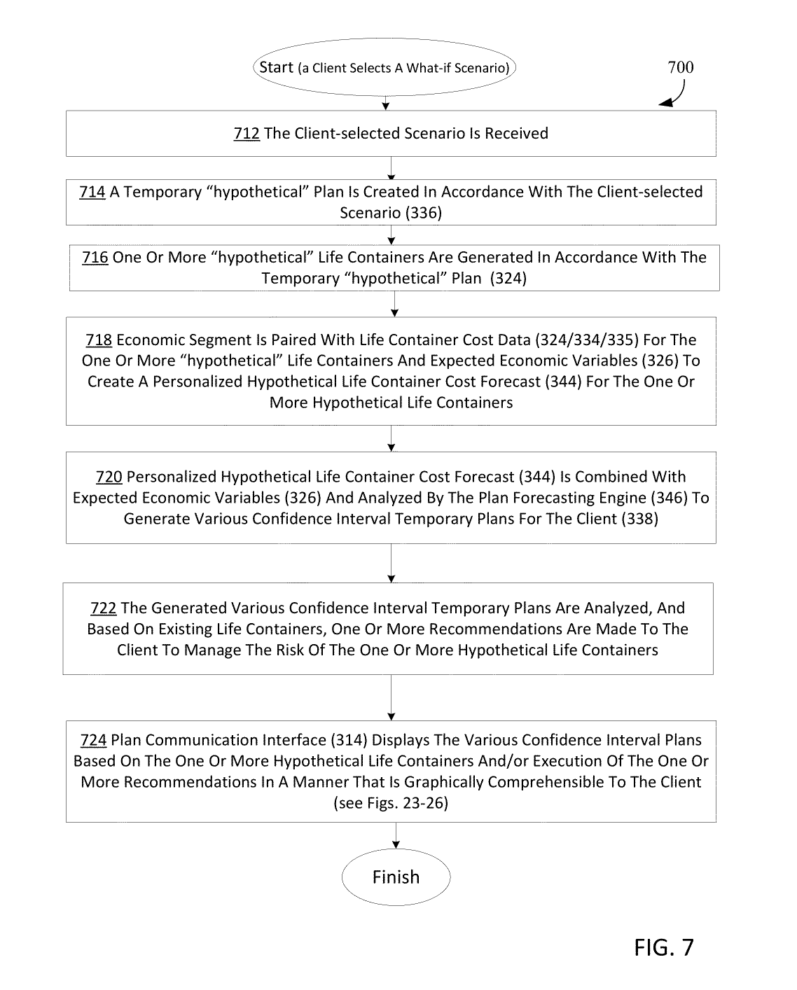

Referring now to FIG. 7, FIG. 7 shows an exemplary action of running a simulation on an existing client profile, to determine one or more effects on said existing client profile. In an embodiment, FIG. 7 shows process 700, which may start with a step 712, in which a scenario selected by the client is received. The scenario selected by the client may be based on one or more life narratives, e.g., narratives for which containers exist in the system. Examples of the scenarios may include unexpected job loss, injury, sickness, or a death. In an embodiment, these options may be presented to the client through the profile data collection display and interface module 312, and received at the profile data collection display and interface module 312.

Referring again to FIG. 7, in an embodiment, in process 700, step 712 may lead to step 714, in which a temporary hypothetical plan is created in accordance with the client-selected scenario. The temporary hypothetical client plan may be generated by expected economic variable application module 336, which may apply the expected economic variables to the hypothetical plan factors.

Referring again to FIG. 7, in an embodiment, in process 700, step 714 may lead to step 716, in which one or more hypothetical life containers are generated in accordance with the temporary hypothetical plan. In an embodiment, the hypothetical life containers may be dictated by the client-selected scenario. In an embodiment, the hypothetical life containers may be generated and/or managed by life container management module 324.

Referring again to FIG. 7, in an embodiment, in process 700, step 716 may lead to step 718, in which an economic segment is paired with hypothetical life container cost data for the one or more hypothetical life containers, and also with expected economic variables (e.g., from economic forecasting variable management module 326), to create a personalized hypothetical life container cost forecast for the one or more hypothetical life containers. The personalized hypothetical vent cost forecast may be managed by life container forecasting module 344.

Referring again to FIG. 7, in an embodiment, in process 700, step 718 may lead to step 720, in which the personalized hypothetical life container cost forecast from step 718 is combined with expected economic variables (e.g., which may be retrieved from economic forecasting variable management module 326) and analyzed by the plan forecasting engine (e.g., which may be controlled by the plan forecasting generation module 346), to generate various confidence interval temporary plans for the client.

Referring again to FIG. 7, in an embodiment, in process 700, step 720 may lead to step 722, in which the generated various confidence interval temporary plans are analyzed (e.g., by the plan forecasting generation module 346 that generated the temporary plans), and recommendations may be made to the client to manage the risk scenarios spelled out by the client and received in previous steps.

Referring again to FIG. 7, in an embodiment, in process 700, step 722 may lead to step 724, in which the various confidence interval plans, said plans that are based on the one or more hypothetical life containers, and/or execution of the one or more recommendations, may be displayed in a manner that is graphically comprehensible to the client.

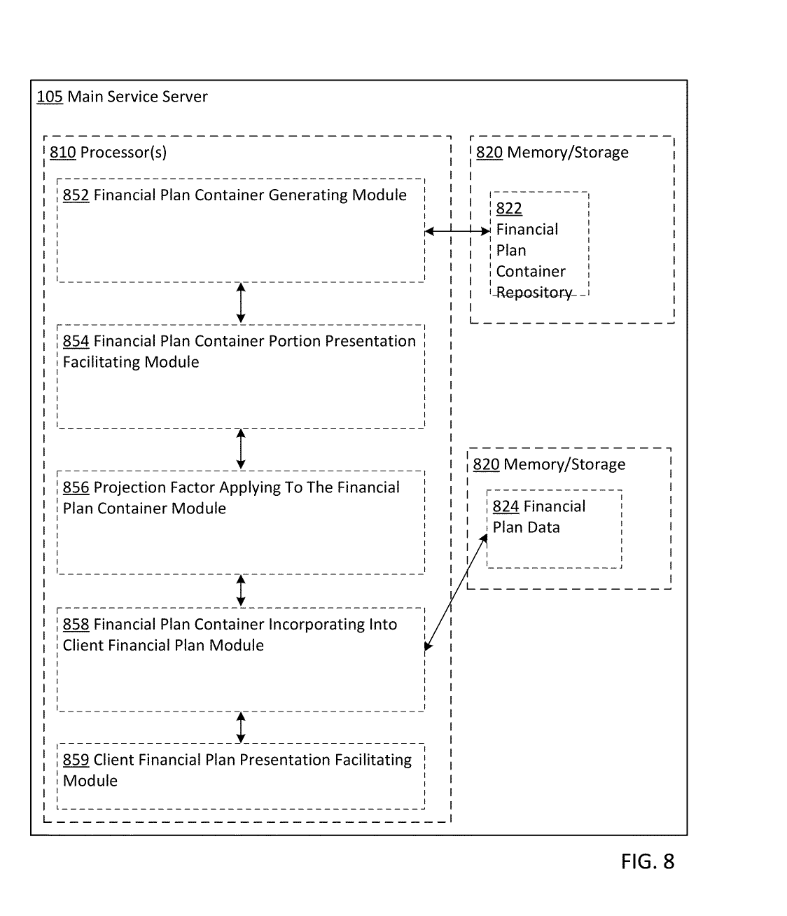

FIGS. 8-14 describe various implementations of main service server 105, which, as previously described, may operate on a single server, or be on a distributed or scaleable server, or present in the “cloud.” One or more portions of main service server 105 may be described herein as “modules.” The term module, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of module (e.g., at a first time), as a second type of module (e.g., at a second time, which may in some instances coincide with, overlap, or follow a first time), and/or as a third type of module (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first module that has a first purpose, then a second module that has a second purpose and then, a third module that has a third purpose, and so on. The transition of a reconfigurable and/or controllable component may occur in as little as a few nanoseconds, or may occur over a period of minutes, hours, or days.

In some such examples, at the time the component is configured to carry out the second purpose, the component may no longer be capable of carrying out that first purpose until it is reconfigured. A component may switch between configurations as different modules in as little as a few nanoseconds. A component may reconfigure on-the-fly, e.g., the reconfiguration of a component from a first module into a second module may occur just as the second module is needed. A component may reconfigure in stages, e.g., portions of a first module that are no longer needed may reconfigure into the second module even before the first module has finished its operation. Such reconfigurations may occur automatically, or may occur through prompting by an external source, whether that source is another component, an instruction, a signal, a condition, an external stimulus, or similar.

For example, a central processing unit of a personal computer may, at various times, operate as a module for displaying graphics on a screen, a module for writing data to a storage medium, a module for receiving user input, and a module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple modules, the example includes the possibility that the same hardware may implement more than one of the recited modules, either contemporaneously or at discrete times or timings. The implementation of multiple modules, whether using more components, fewer components, or the same number of components as the number of modules, is merely an implementation choice and does not generally affect the operation of the modules themselves. Accordingly, it should be understood that any recitation of multiple discrete modules in this disclosure includes implementations of those modules as any number of underlying components, including, but not limited to, a single component that reconfigures itself over time to carry out the functions of multiple modules, and/or multiple components that similarly reconfigure, and/or special purpose reconfigurable components.

Referring now to FIG. 8, FIG. 8 shows an exemplary implementation of main service server 105. It is noted that portions of main service server 105 that are not relevant to the particular examples set forth herein are not pictured in FIGS. 3, 8, 9, and other figures in this drawing. For clarity and conciseness, modules that are not necessary to the workings of main service server 105 may occasionally be omitted. Moreover, there may be overlap between modules of main service server 105 that are not explicitly set forth here, and nothing in this application should be taken as a prohibition on such overlap, even if it is complete. For example, container generating module 852 of processor 810 of FIG. 8 may, in an embodiment, be part of or be wholly subsumed by data management module 330 of FIG. 3. To the extent these combinations are not inconsistent with each other, or directly contradicted in this text, such combinations should be considered within the scope of this disclosure and the associated claims.

Referring again to FIG. 8, in an embodiment, main service server 105 may include a processor 810 that is operably coupled to a memory/storage 820. It is noted that processor 810 may be instantiated as many distributed processors across many different computers that may be linked together. One or more of processor 810 and memory 820 may be linked to cloud storage, cloud services, or cloud processing.

In various embodiments, processor 810 may include one or more microprocessors, Central Processing Units (“CPU”), a Graphics Processing Units (“GPU”), Physics Processing Units, Digital Signal Processors, Network Processors, Floating Point Processors, and the like. In some embodiments, processor 810 may be a server. In some embodiments, processor 810 may be a distributed-core processor. Although processor 810 is depicted as a single processor that is part of a main service server 105, processor 810 may be multiple processors distributed over one or many server devices, which may or may not be configured to operate together. Processor 810 is illustrated as being configured to execute computer readable instructions in order to execute one or more operations described above, and as illustrated in the foregoing and following examples. In some embodiments, processor 810 is designed to configure itself as one or more of a financial plan container generating module 852, a financial plan container portion presentation facilitating module 854, a projection factor applying to a financial plan container module 856, and a financial plan container incorporation into a client financial plan module 858, which will be discussed in more detail herein. In an embodiment, processor 810 may include a client financial plan presentation facilitating module 859.

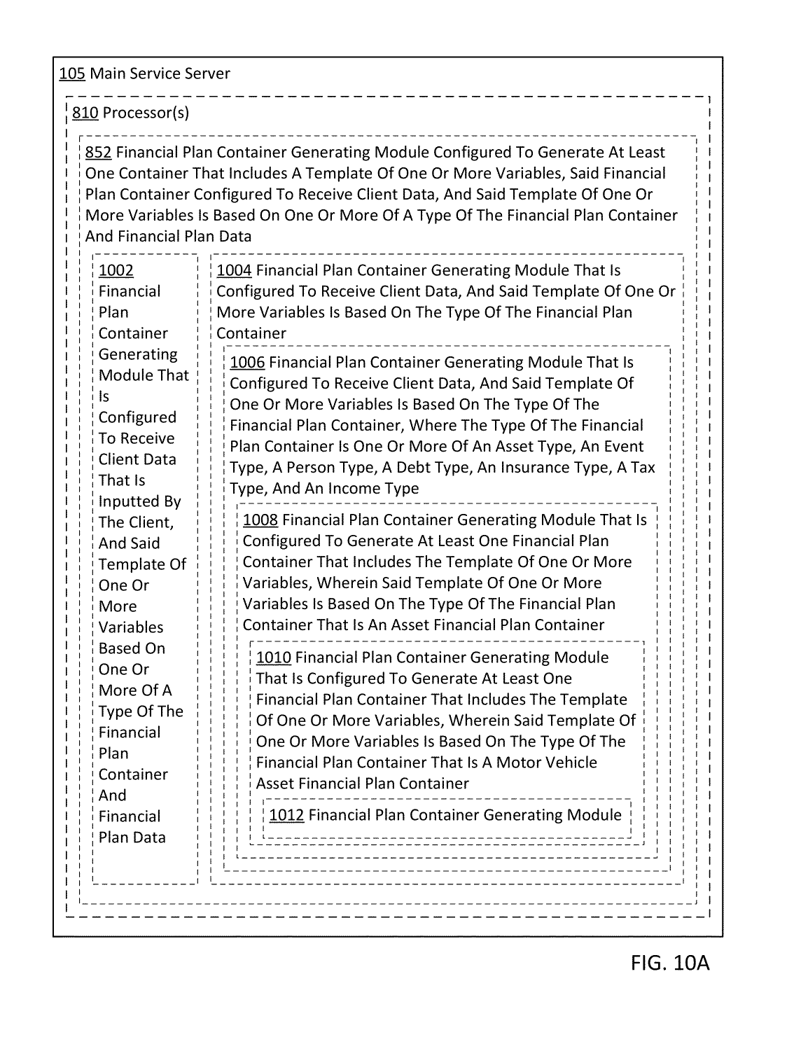

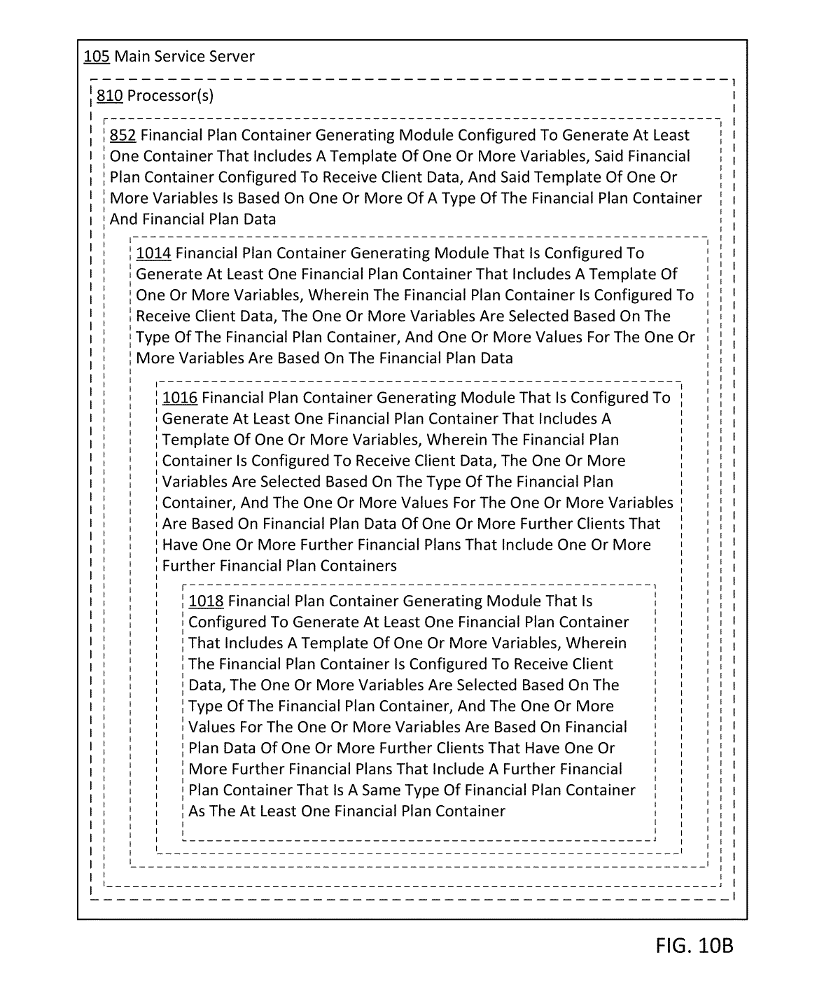

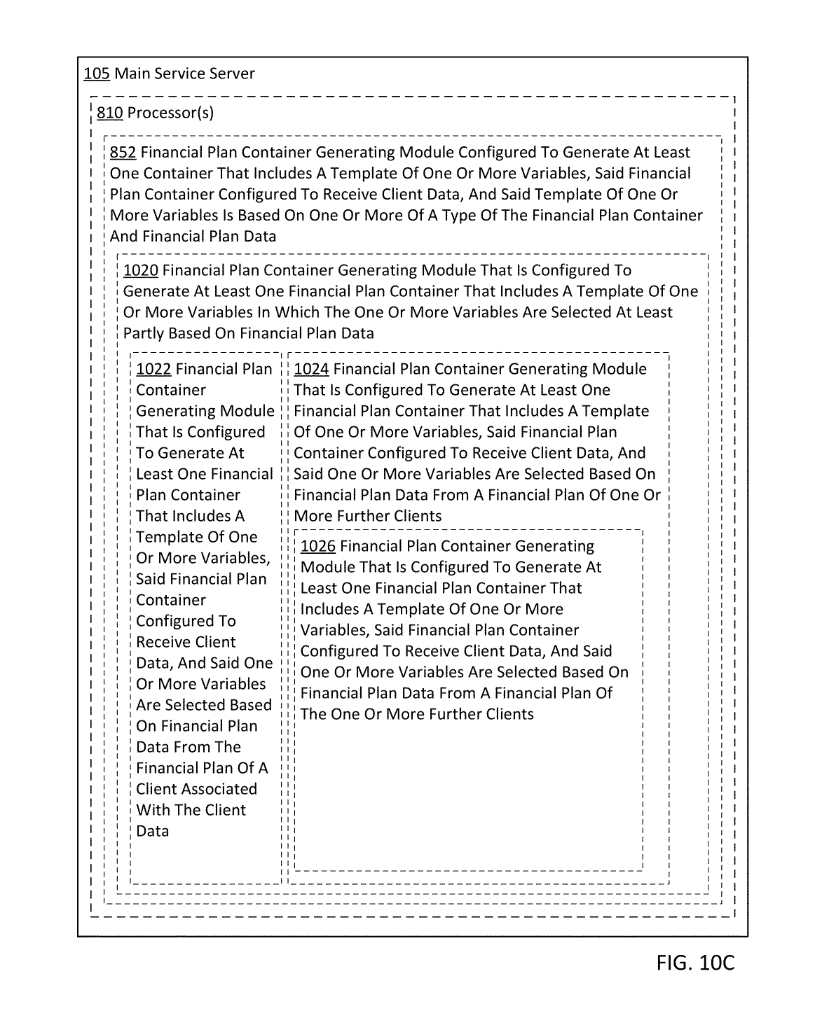

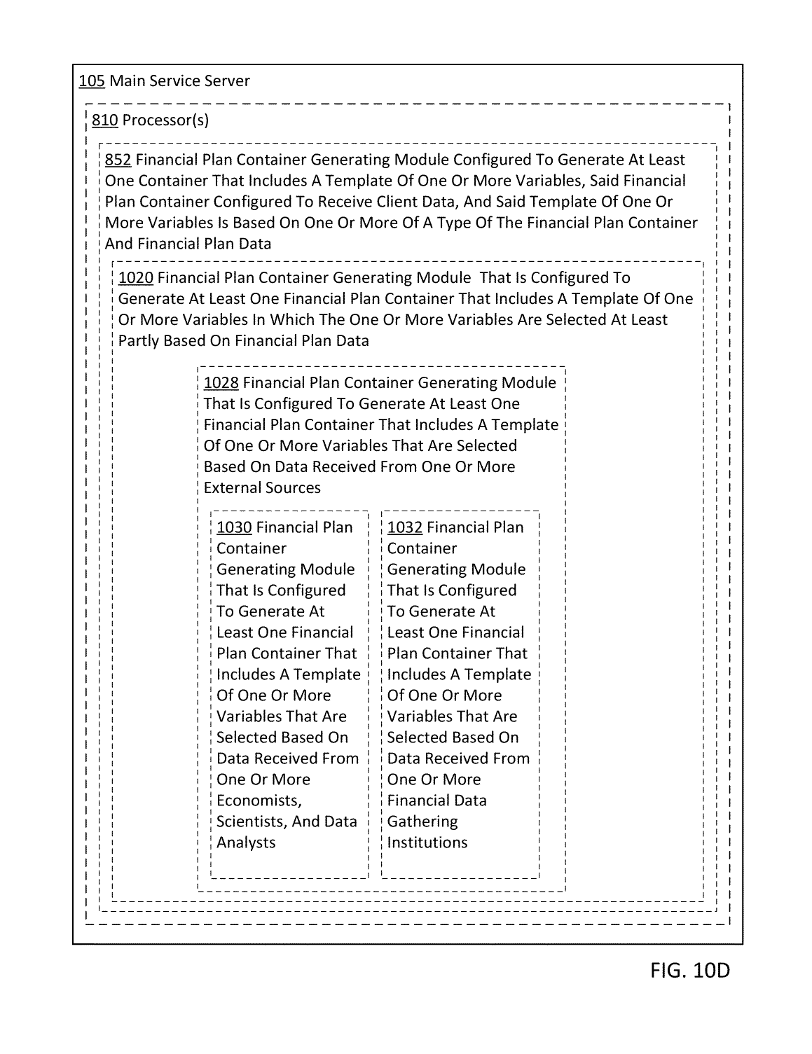

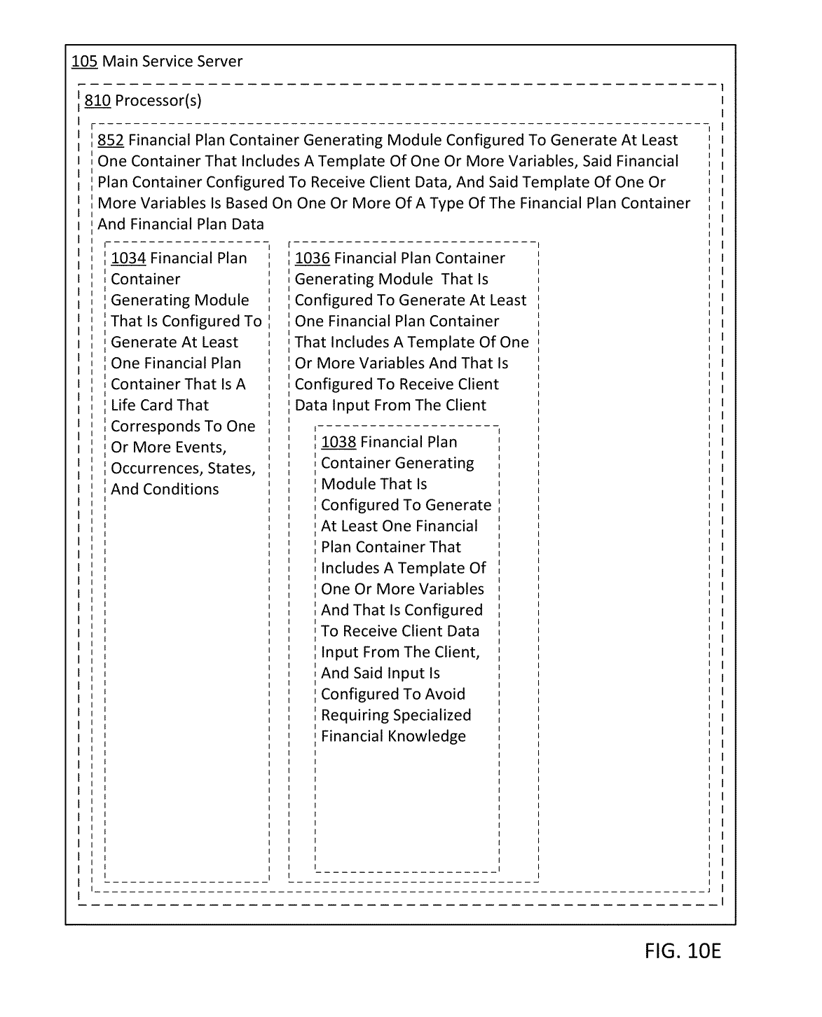

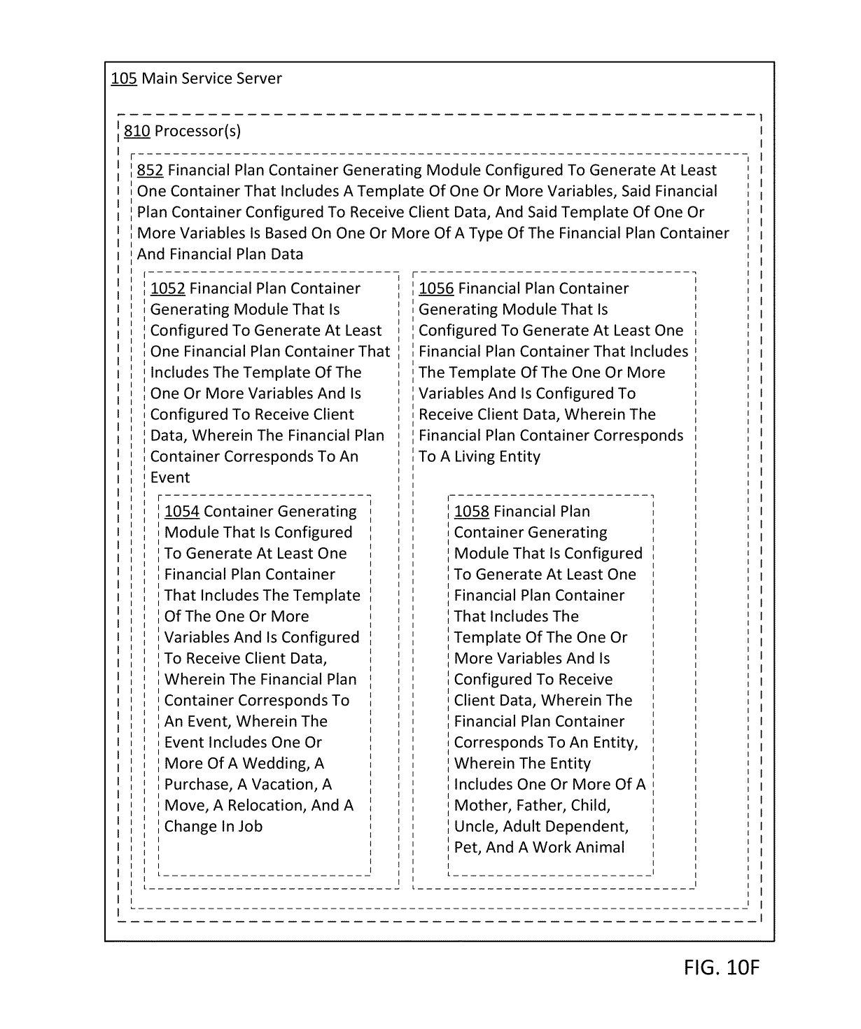

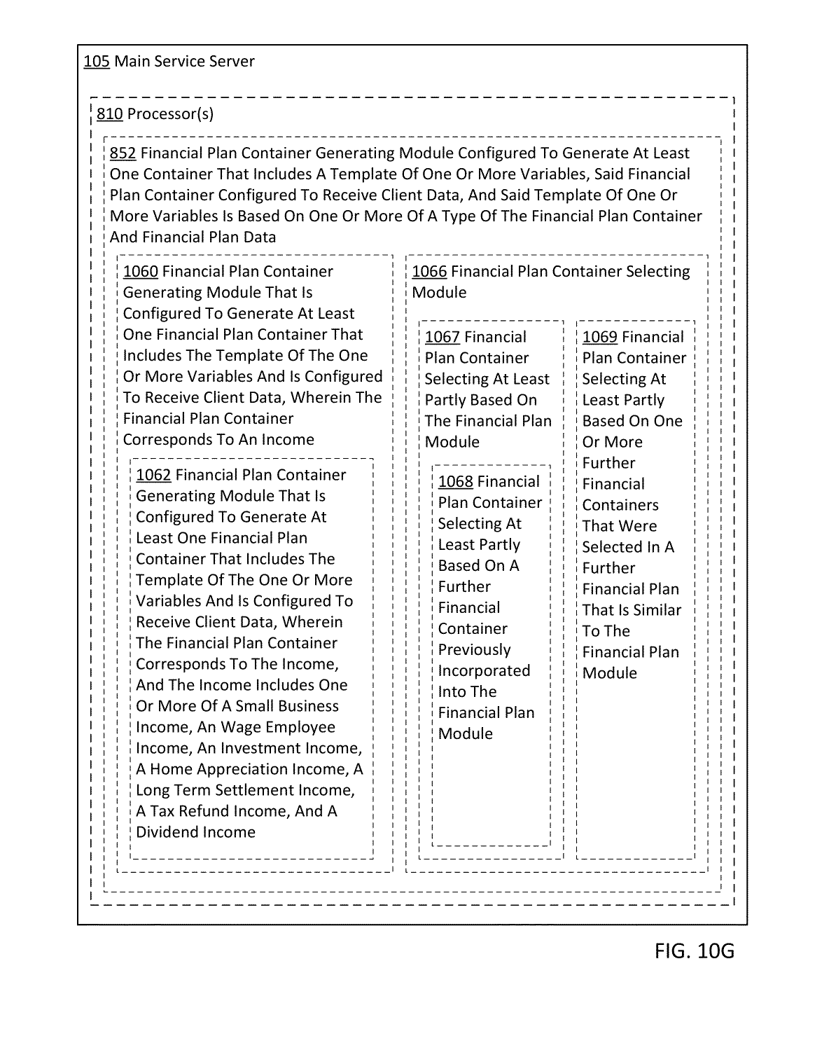

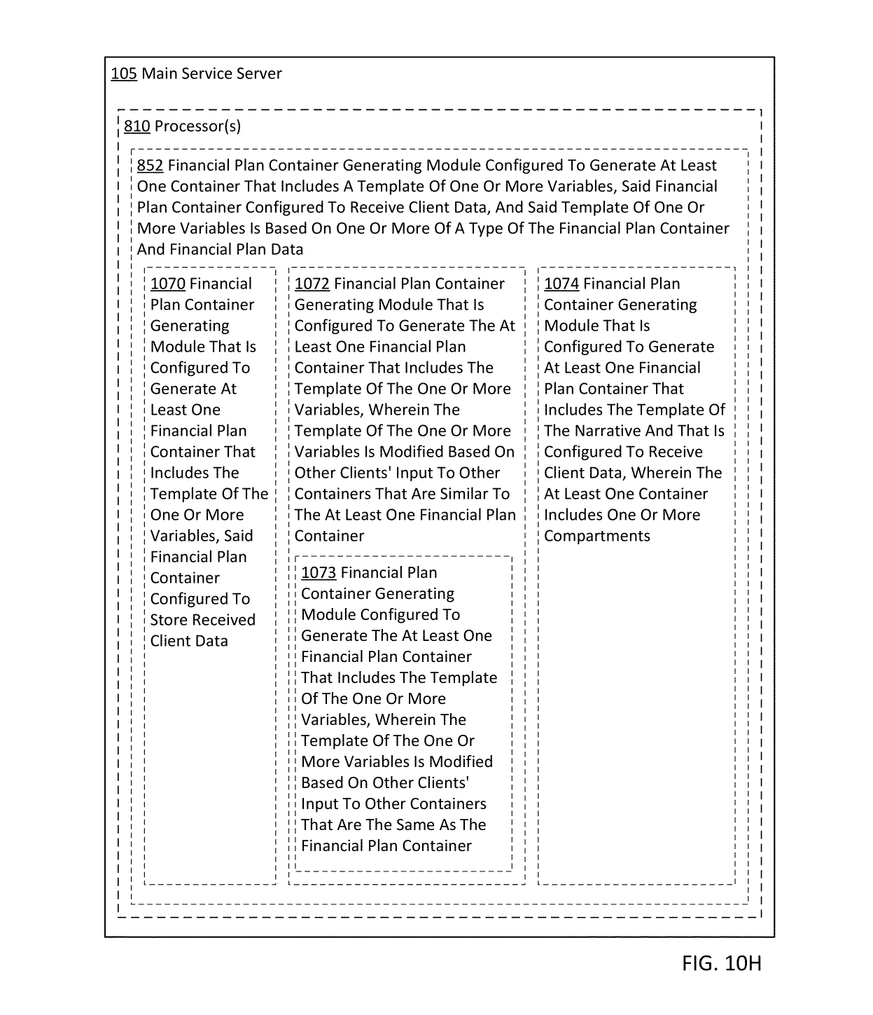

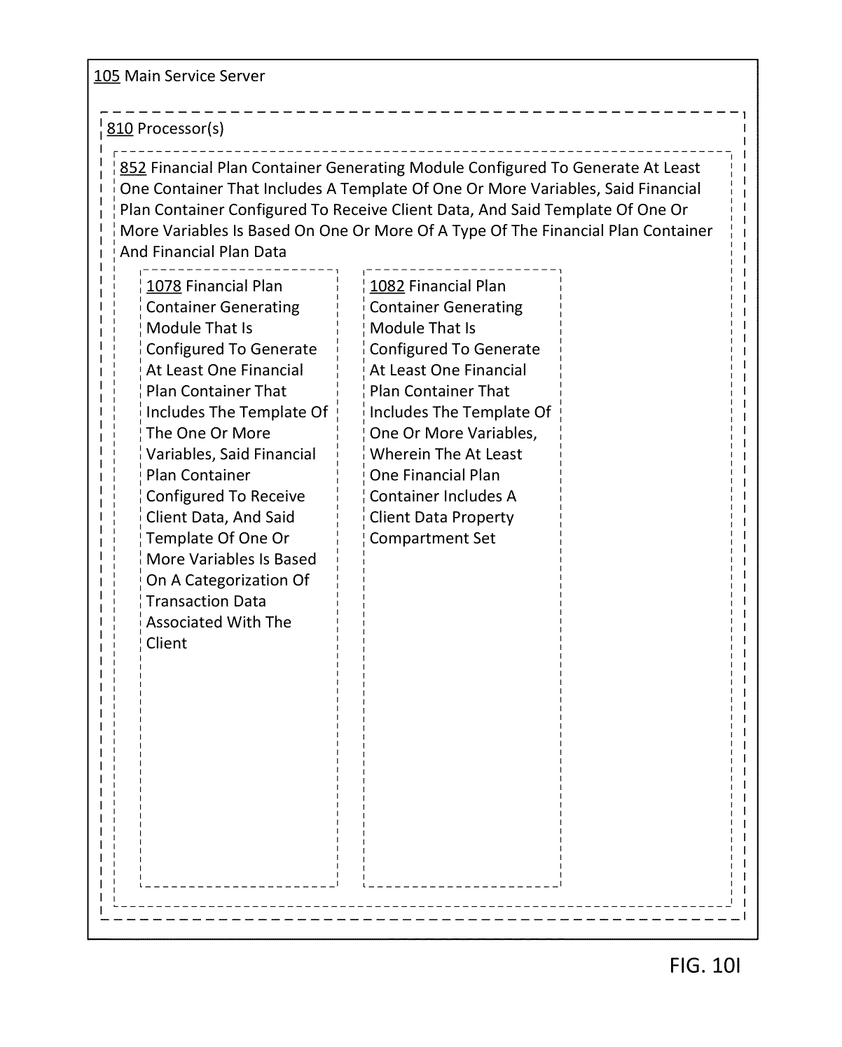

Referring again to FIG. 8, as set forth above, processor 810 may include financial plan container generating module 852. Financial plan container generating module 852 may be embodied in various ways, some examples of which are described in FIGS. 10A-10I. In an embodiment, financial plan container generating module 852 may be configured to generate at least one container that includes a template of one or more variables. In an embodiment, the financial plan container generating module may be configured to receive client data. In an embodiment, the template of the one or more variables is based on one or more of a type of the financial plan container and the financial plan data. It is noted that, as used in the independent claim and in other claims, “based on,” does not require that something be “solely based on,” but rather that it is a factor. For example, if the one or more variables are based on a type of container, they also may be based on an economic model projection programmed by a data scientist, and also may be based on data stored in other containers, and may be based on data stored about other clients.

As described in the previous paragraph, financial plan container generating module 852 may be configured to generate at least one container that includes a template of one or more variables. In an embodiment, financial plan container generating module 852 may generate the container by selecting from a set of pre-made containers. In another embodiment, financial plan container generating module may generate the container by selecting from a set of pre-made partial containers, and filling in the other details based on other factors, e.g., other containers, or other client data.

In an embodiment, financial plan container generating module 852 may be configured to receive client data, e.g., may be configured to facilitate the receipt of client data, e.g., through a user interface. In an embodiment, the client data may be stored in the financial plan container.

Referring again to FIG. 8, as set forth above, processor 810 may include financial plan container portion presentation facilitating module 854. Financial plan container portion presentation facilitating module may be configured to facilitate presentation of at least a portion of the at least one financial plan container that is configured to receive the client data. For example, the system may interact with a client through an interface, e.g., a web browser. Financial plan container portion presentation facilitating module 854 may carry out one or more steps to assist in that presentation, even though those steps may occur on the back end. For example, one example of facilitating the presentation of the container is to use the template of variables to determine how the container will be presented, e.g., which questions will be asked first, how the question will be asked, and what the default value answers for those questions may be. In an embodiment, financial plan container portion presentation facilitating module may provide specifications, algorithms, or solutions for the design of the interface, which may be actually implemented by another component (e.g., a web server), by a remote component (e.g., the local computer running the web browser), or a combination thereof, with the facilitating taking place in the main service server 105.

Referring again to FIG. 8, as set forth above, processor 810 may include projection factor applying to the financial plan container module 856, which may be configured to apply a projection factor to a financial plan container that contains the client data (e.g., that has received the client data that it was configured to receive).

Referring again to FIG. 8, as set forth above, processor 810 may include financial plan container incorporating into a client financial plan module 858. In an embodiment, financial plan container incorporating into a client financial plan module 858 may be configured to incorporate the financial plan container into the client financial plan, which may include other financial plan containers with their own templates of variables, which, in an embodiment, may be partly interconnected to each other.

As set forth above, main service server 105 may be implemented as a server device, or it may be implemented as a combination of one or more of hardware, software, applications, APIs, and other items that are present in a “cloud.” Referring now to the term “cloud,” and the associated “cloud computing,” for the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

Referring again to FIG. 8, processor 810 may be operably coupled to memory 820. In various embodiments, memory 820 may include one or more of mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In some embodiments, memory 820 may be located at a single site, or a network site. In other embodiments, memory 820 may be located at multiple network sites, including sites that are distant from each other. In various embodiments, one or more of processor 810 and memory 820 may be scaleable, or scaleable-on-demand, or scaleable-on-the-fly.

Referring again to FIG. 8, processor 810 may include one or more modules. In an embodiment, processor 810 may be hard-wired to include those modules. In another embodiment, processor 810 may be programmable through the receipt of various instructions, to configure one or more portions of itself as the various modules, which may exist sequentially, contemporaneously, or any combination thereof. For example, in an embodiment, processor 810 may configure itself as financial plan container generating module 852 at time T1, and then may configure itself as container portion presentation facilitating module 854 at time T2. By utilizing pipelining and distributing various tasks, in an embodiment, processor 810 may be reconfiguring itself into container portion presentation facilitating module 854, while still executing portions of instructions as financial plan container generating module 852.

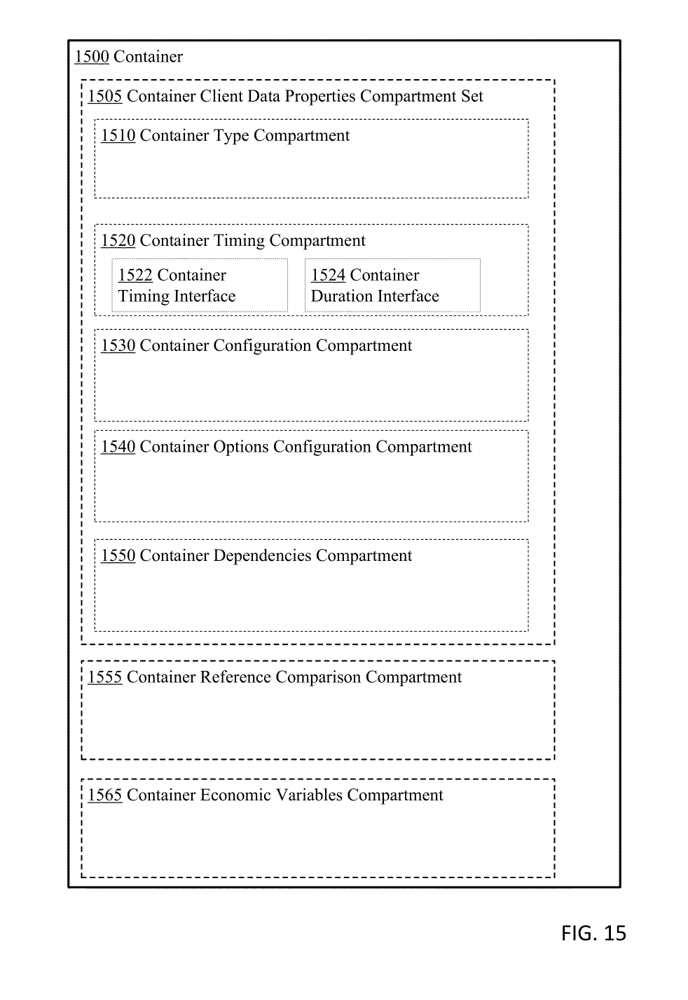

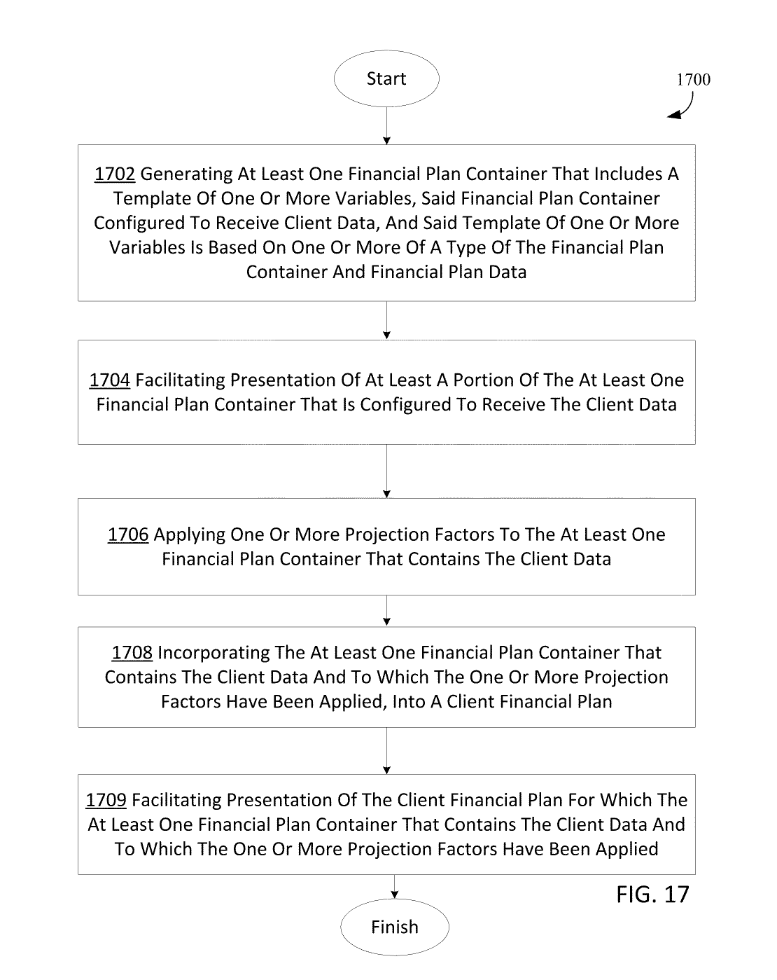

Referring again to FIG. 8, processor 810 may include a financial plan container generating module 852. Financial plan container generating module 852 may be configured to generate at least one financial plan container that includes a template of one or more variables, said financial plan container configured to receive and/or contain client data, and said template of one or more variables is based on one or more of a type of the financial plan container and financial plan data. Financial plan container generating module 852 may be configured to generate, by creating, or retrieving from memory, one or more containers, e.g., container 1500 of FIG. 15, which will be discussed in more detail herein. In an embodiment, financial plan container generating module 852 may select a financial plan container from financial plan container repository 822, which may be part of memory 820, as shown in FIG. 8 In an embodiment, financial plan container generating module 852 may be configured to carry out operation 1702 depicting generating at least one financial plan container that includes a template of one or more variables, said financial plan container configured to receive and/or contain client data, and said template of one or more variables is based on one or more of a type of the financial plan container and financial plan data, as shown in FIG. 17. Financial plan container generating module 852, and the various sub-modules of which it is composed, may be discussed in more detail with respect to FIG. 10.

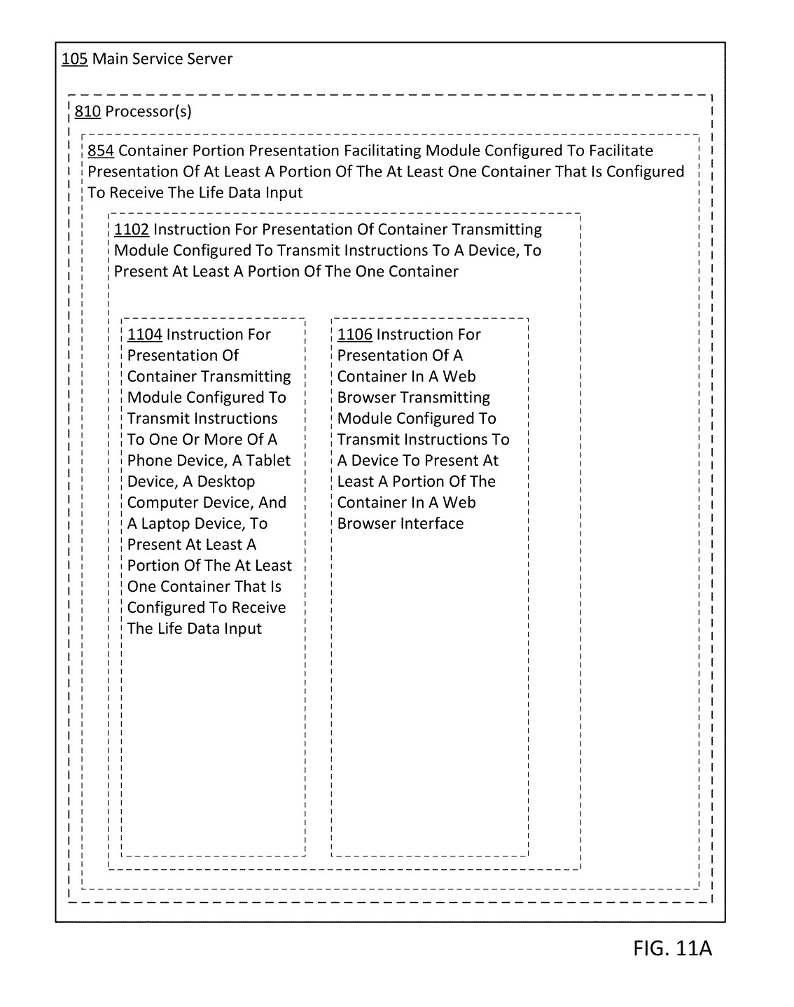

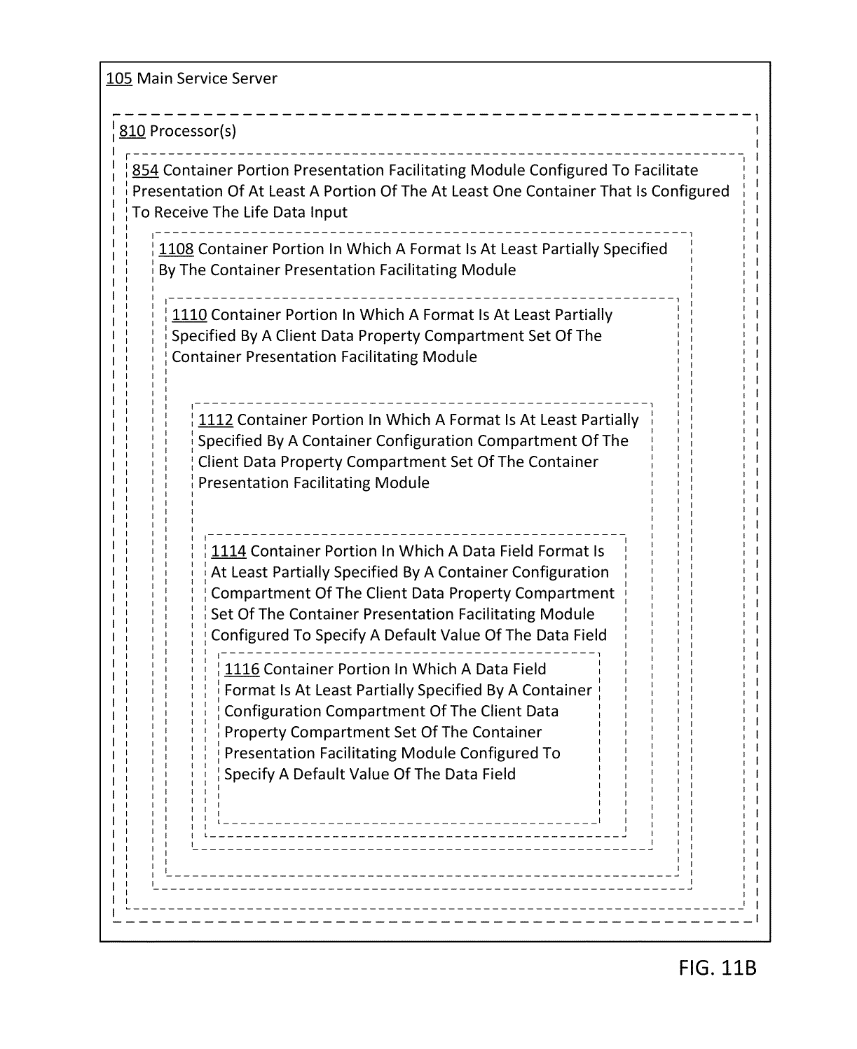

Referring again to FIG. 8, processor 810 may include a financial plan container portion presentation facilitating module 854. Financial plan container portion presentation facilitating module 854 may be configured to facilitate a presentation of at least a portion of the at least one container that is configured to receive the life data input. That is, financial plan container portion presentation facilitating module 854 may use the data in a container, e.g., a container 1500, to determine the client interface to be presented to the client, e.g., presentation of questions like “Do you own or rent a home,” and “how much do you pay per month in rent.” In an embodiment, the presentation is configured by the container to minimize the sophistication level required by a client in order to operate the system. For example, the system strives to ask real-world questions in context, e.g., “how much do you pay per month in rent,” which is a simpler question to understand, versus, “what are you total living expenses for the year.” In an embodiment, container portion presentation facilitating module may be configured to carry out at least a portion of operation 1704 depicting facilitating presentation of at least a portion of the at least one financial plan container that is configured to receive the client data, as shown in FIG. 17. Financial plan container portion presentation facilitating module 854, and the various sub-modules of which it is composed, may be discussed in more detail with respect to FIG. 11.

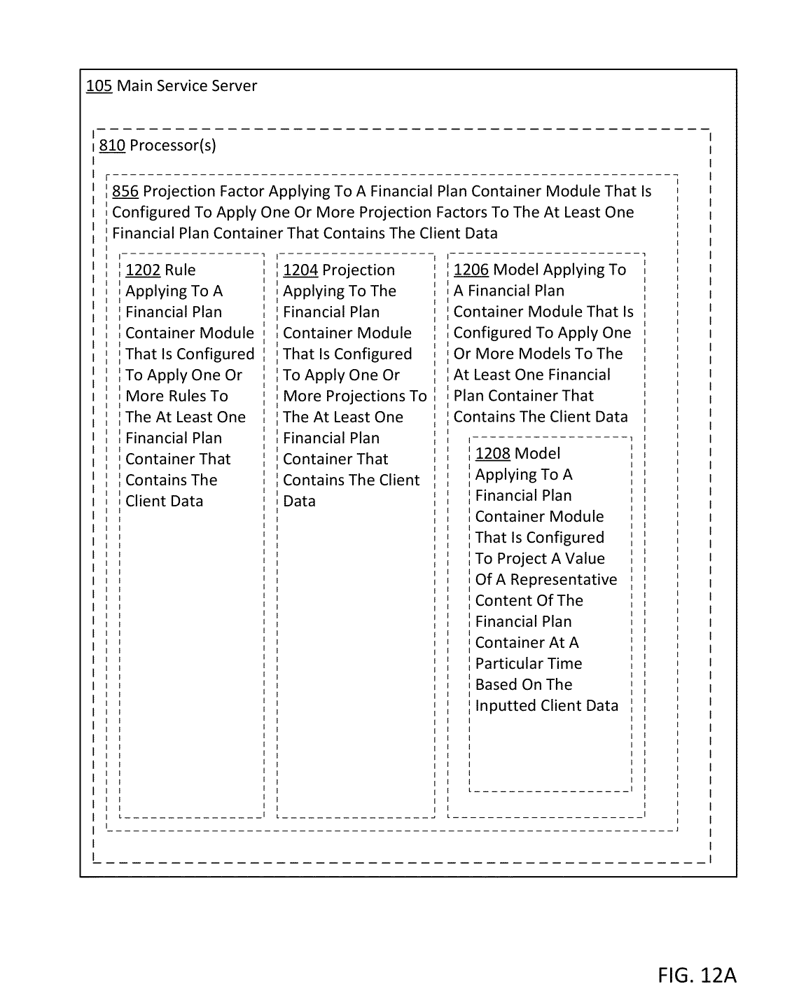

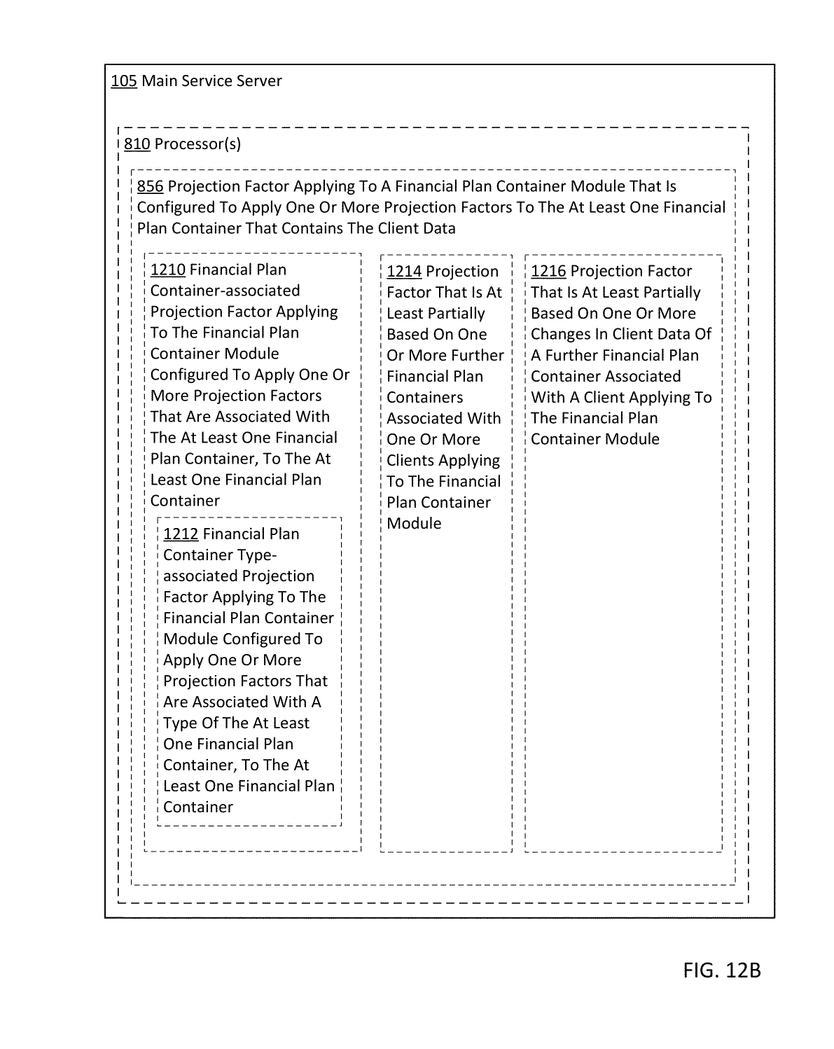

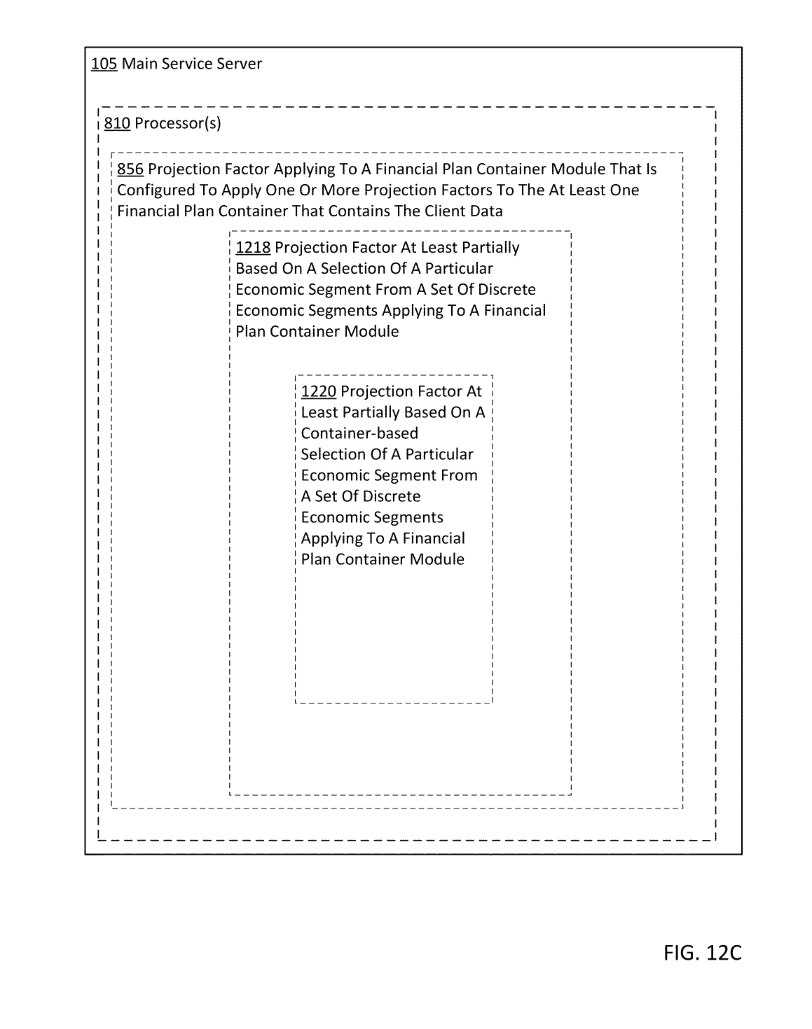

Referring again to FIG. 8, processor 810 may include a projection factor application to a financial plan container module 856. Projection factor application to a container module 856 may be configured to apply one or more projection factors to the at least one container that contains the client data. A projection factor may be one or more rules, projections, models, and variables that may operate on the data in the container. In an embodiment, the projection factor may be container-specific, e.g., the projection factor associated with the container may be configured to modify the data in that specific container. In an embodiment, projection factor application to a container module 856 may be configured to carry out at least a portion of operation 1706 depicting applying one or more projection factors to the at least one financial plan container that contains the client data, as shown in FIG. 17. Projection factor application to a container module 856, and the various sub-modules of which it may be composed, will be discussed in more detail with respect to FIG. 12.

Referring again to FIG. 8, processor 810 may include a financial plan container incorporating into a financial plan module 858. Financial plan container incorporating into a financial plan module 858 may be configured to incorporate the at least one container that contains the client data and to which the one or more rules have been applied. For example, in an embodiment, financial plan container incorporating into a financial plan module 858 may take one or more containers, e.g., container 1500 from FIG. 15, and use the one or more financial plan containers as input or as factors in generating a financial plan that is configured to be presented to the client. In an embodiment, financial plan container incorporating into a financial plan module 858 may include other financial plan data 824, e.g., retrieved from memory 820, as shown in FIG. 8. In an embodiment, financial plan container incorporating into a financial plan module 858 may be configured to carry out at least a portion of operation 1708 depicting incorporating the at least one financial plan container that contains the client data and to which the one or more projection factors have been applied, into a client financial plan, as shown in FIG. 17.

Referring again to FIG. 8, in an embodiment, processor 810 may include a client financial plan presentation facilitating module 859. Client financial plan presentation facilitating module 859 may be configured to facilitate presentation of the client financial plan into which the one or more containers, e.g., containers 1500 of FIG. 15, are incorporated. In an embodiment, client financial plan presentation facilitating module may be configured to carry out at least a portion of operation 1709 depicting facilitating presentation of the client financial plan for which the at least one financial plan container that contains the client data and to which the one or more projection factors have been applied, as shown in FIG. 17. In an embodiment, the client financial plan may be presented as visual representations, e.g., as shown in one or more of FIGS. 23-26.

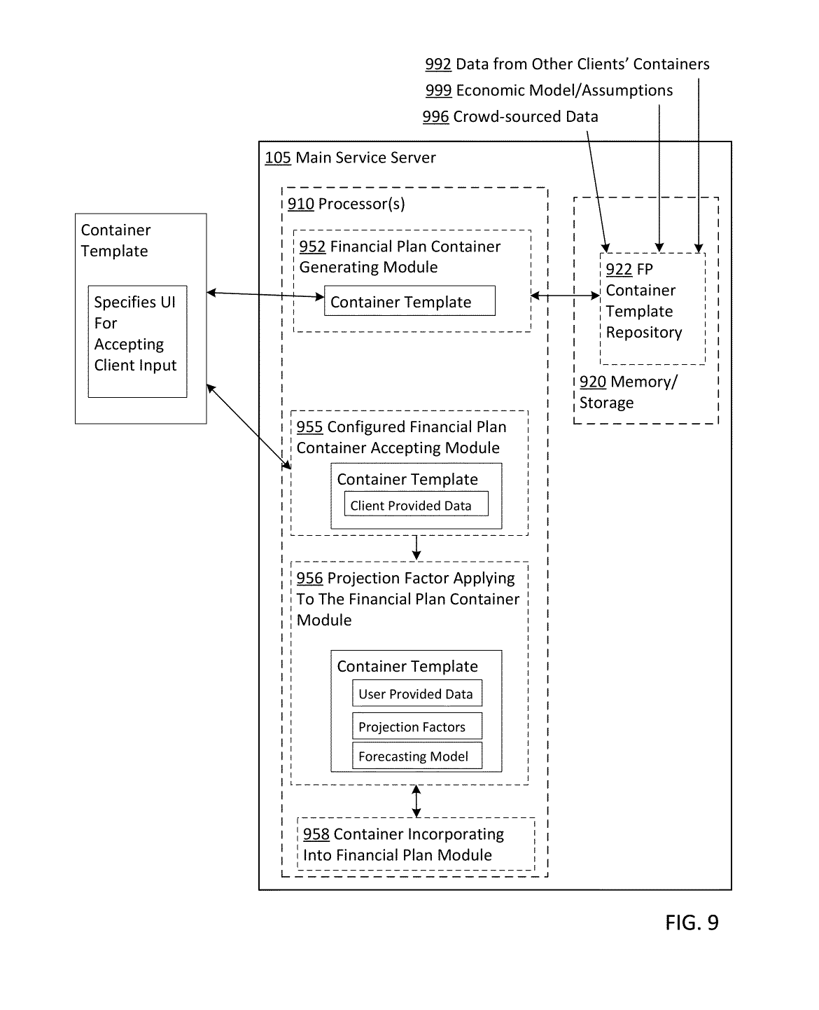

Referring now to FIG. 9, FIG. 9 shows an implementation of main service server 105, according to another embodiment. As shown in FIG. 9, main service server 105 may include a processor 910 that is operably coupled to a memory/storage 920. It is noted that processor 910 may be instantiated as many distributed processors across many different computers that may be linked together. One or more of processor 910 and memory 920 may be linked to cloud storage, cloud services, or cloud processing. Processor 910 and memory 920 may share one or more characteristics with processor 810 and memory 820 described above, respectively.

Referring again to FIG. 9, processor 910 may include a container generating module 952. Container generating module 952 may be configured to generate at least one financial plan container that includes a template of one or more variables, said financial plan container configured to receive and/or contain client data, and said template of one or more variables is based on one or more of a type of the financial plan container and financial plan data. Container generating module 952 may be configured to generate, by creating, or retrieving from memory, one or more containers, e.g., container 1500 of FIG. 15, which will be discussed in more detail herein. In an embodiment, financial plan container generating module 952 may be configured to carry out operation 1702 depicting generating at least one financial plan container that includes a template of one or more variables, said financial plan container configured to receive and/or contain client data, and said template of one or more variables is based on one or more of a type of the financial plan container and financial plan data, as shown in FIG. 17. In an embodiment, financial plan container generating module 952 may retrieve a container from container repository 922 of memory 920. In an embodiment, a container, e.g., container 1500, may reside in container repository 922, where the container may be modified by various inputs, e.g., data from other clients' containers 992, economic models and/or assumptions 999, and crowd-sourced data 996. In an embodiment, the container template may specify a user interface for accepting client input.

Referring again to FIG. 9, processor 910 may include a configured financial plan container accepting module 955. Configured financial plan container accepting module 955 may be configured to accept a financial plan container for which the client data has been entered by the client, as shown in FIG. 9. In an embodiment, processor 910 may include one or more of projection factor applying to a container module 956 and container incorporating into a financial presentation module 958, which may be similar to projection factor applying to a container module 856 and container incorporating into a financial plan module 858 of FIG. 8.

Following are a series of modules, which may be described in conjunction with a series of flowcharts depicting implementations. It is noted that, although a particular module may be described as carrying out a particular operation, or configured to carry out a particular operation, the module is not linked solely to that operation, nor is that operation linked solely to that module. Rather, the module and operation are presented together as an example for ease of understanding, rather than listing each possible operation that could be carried out for each module, or listing each possible module that could carry out an operation, either of which are impractical due to space and understanding considerations.

For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIGS. 17-22, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIGS. 17-22 as well as the other operations to be described herein may be performed by at least one of a machine, an article of manufacture, or a composition of matter.

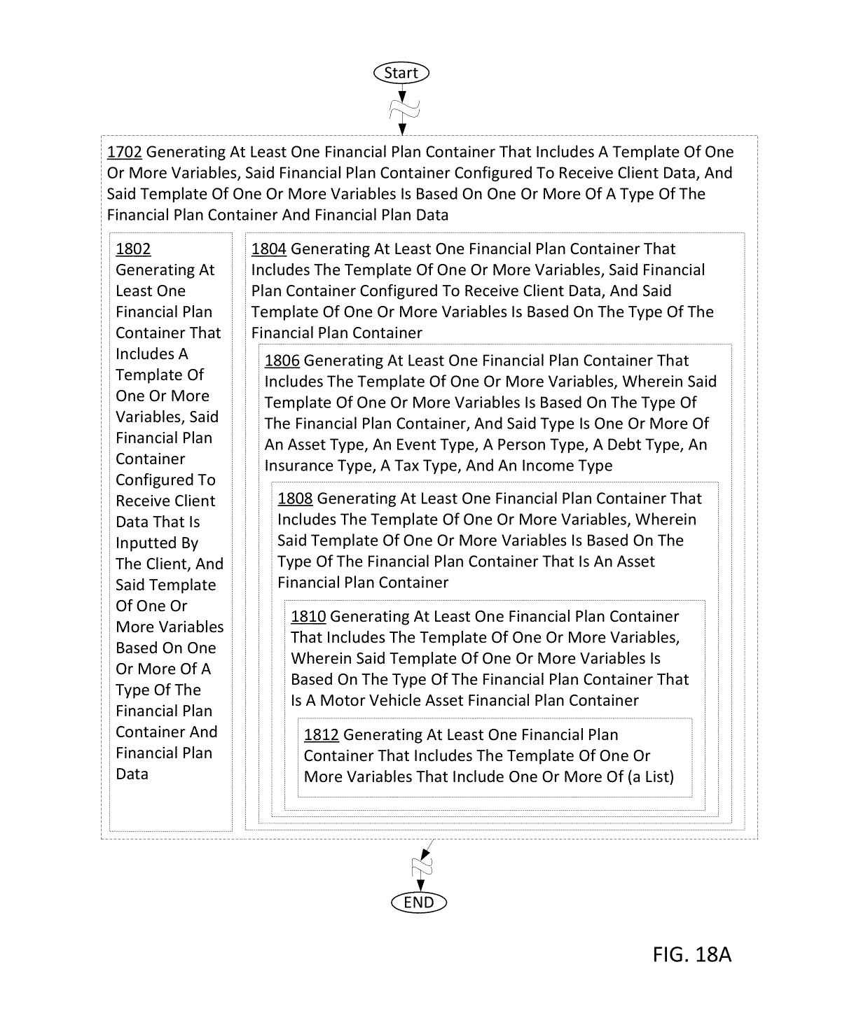

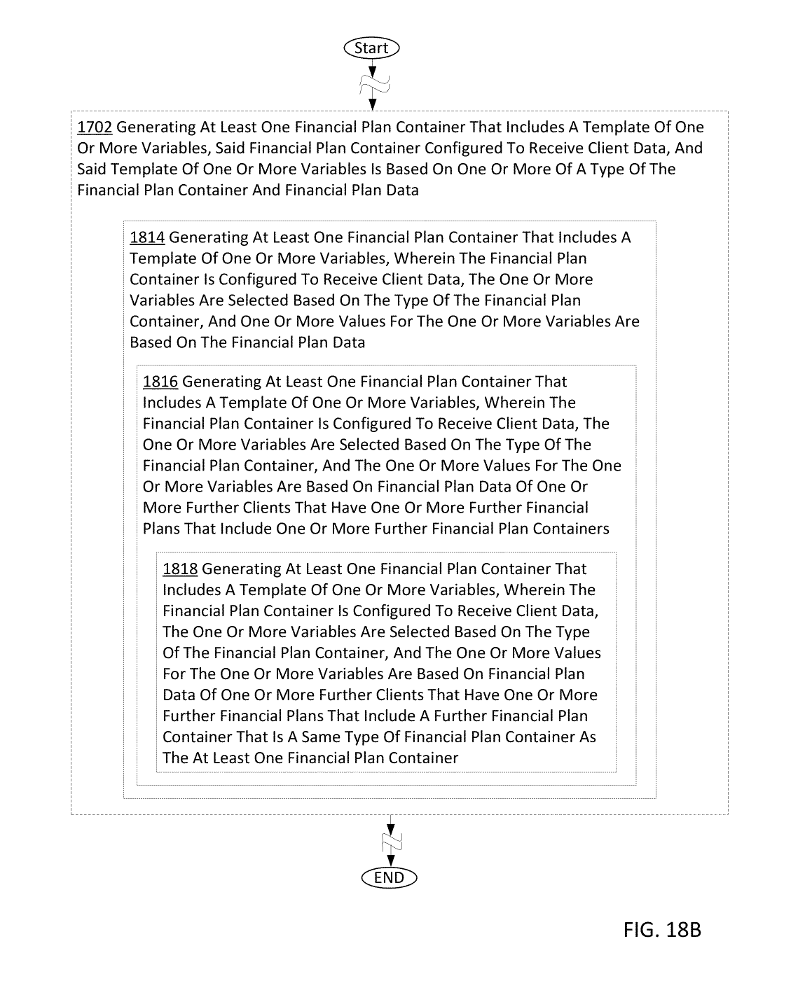

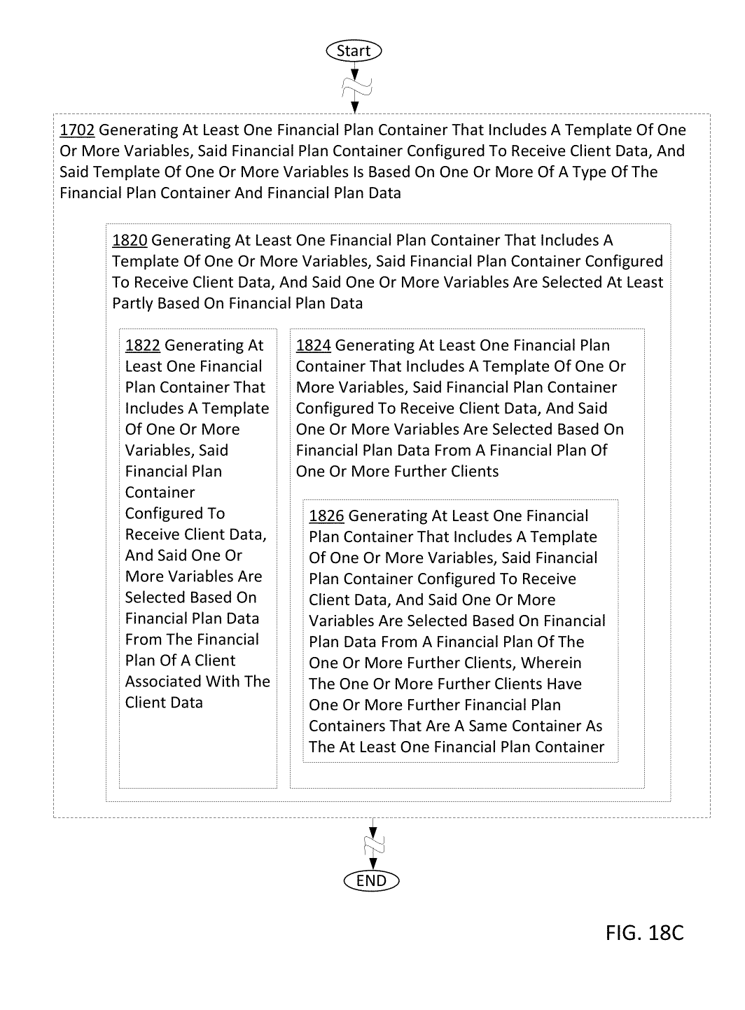

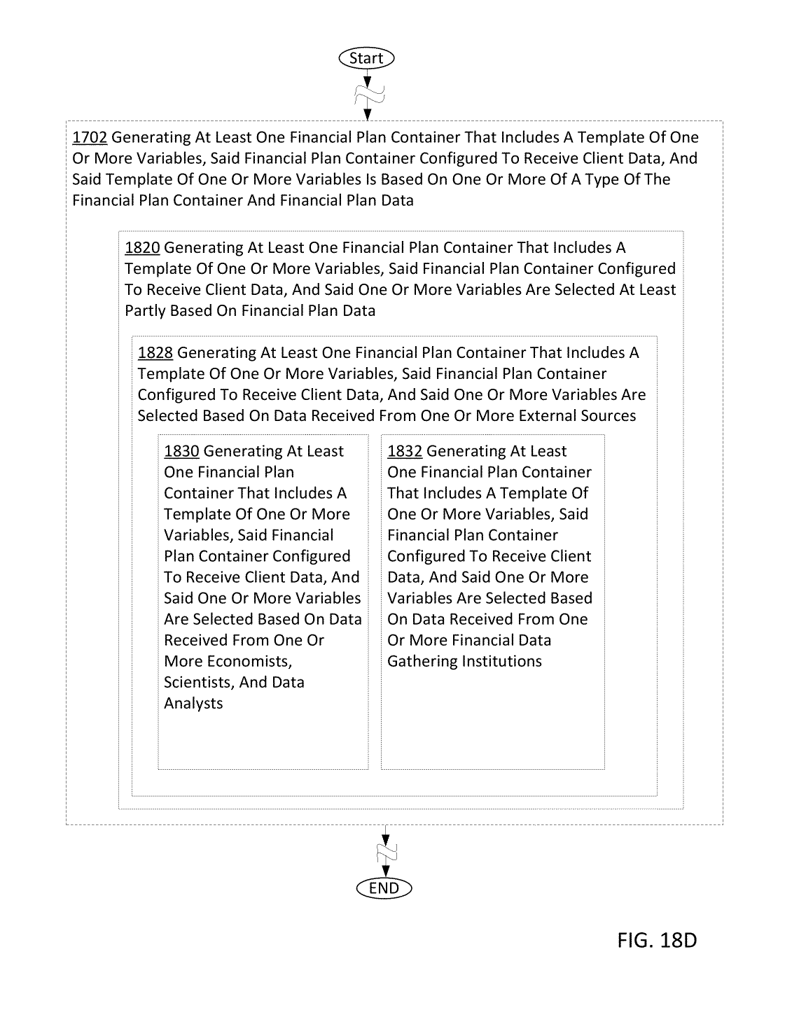

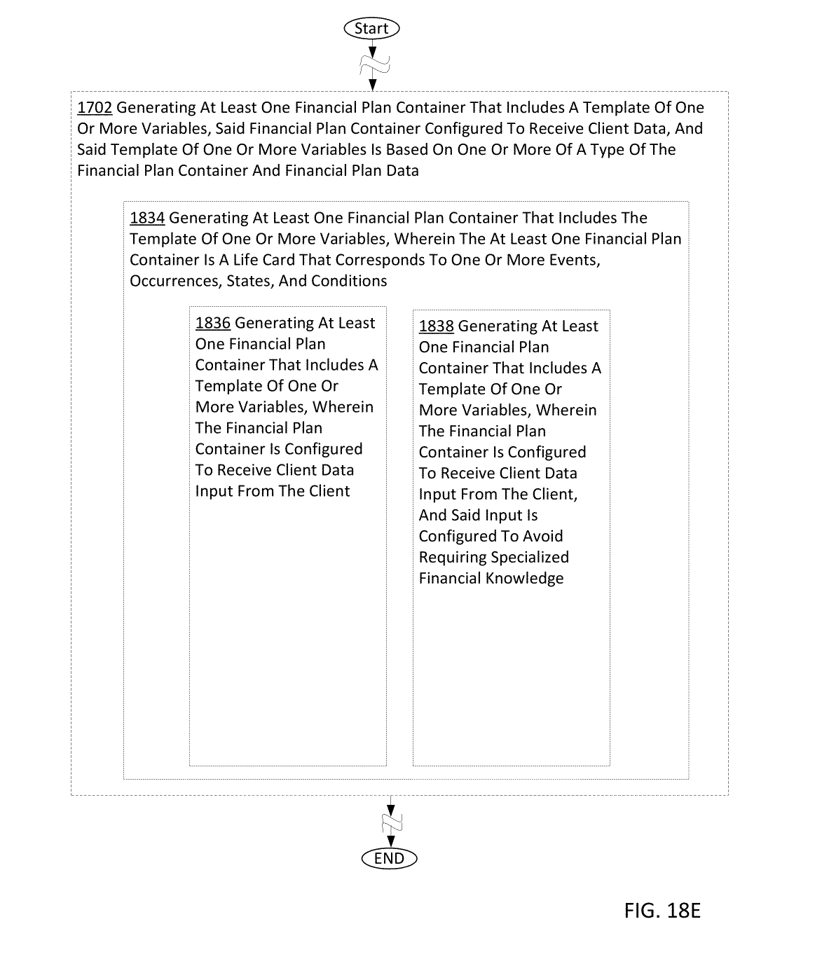

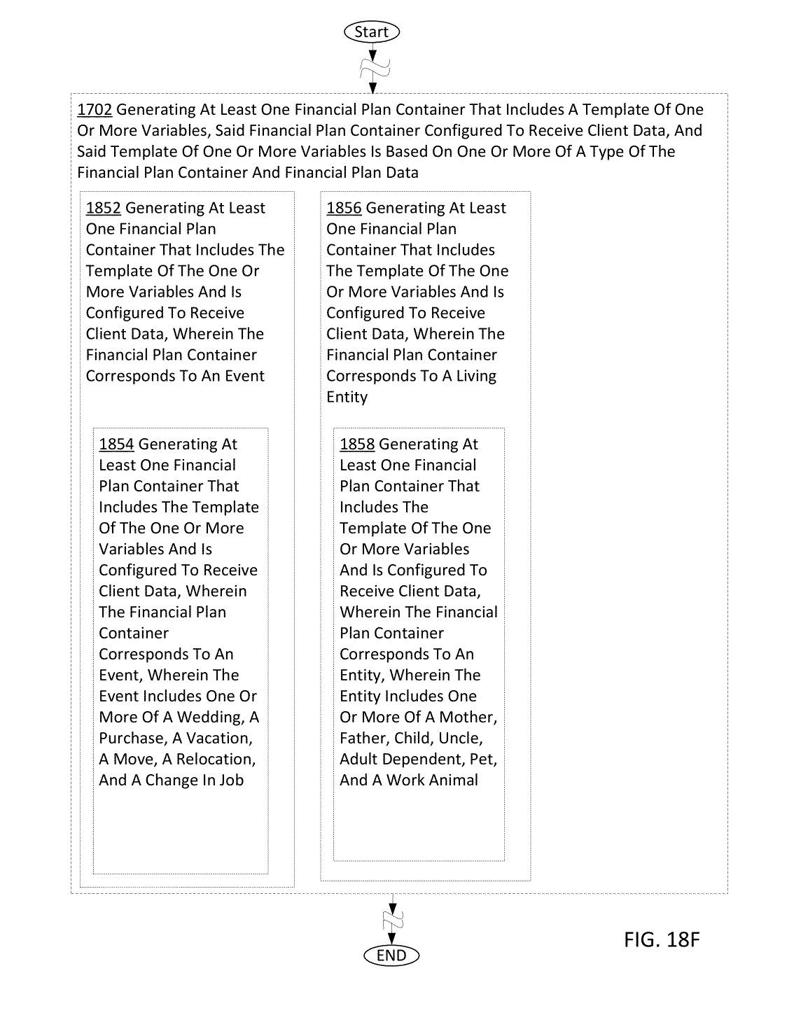

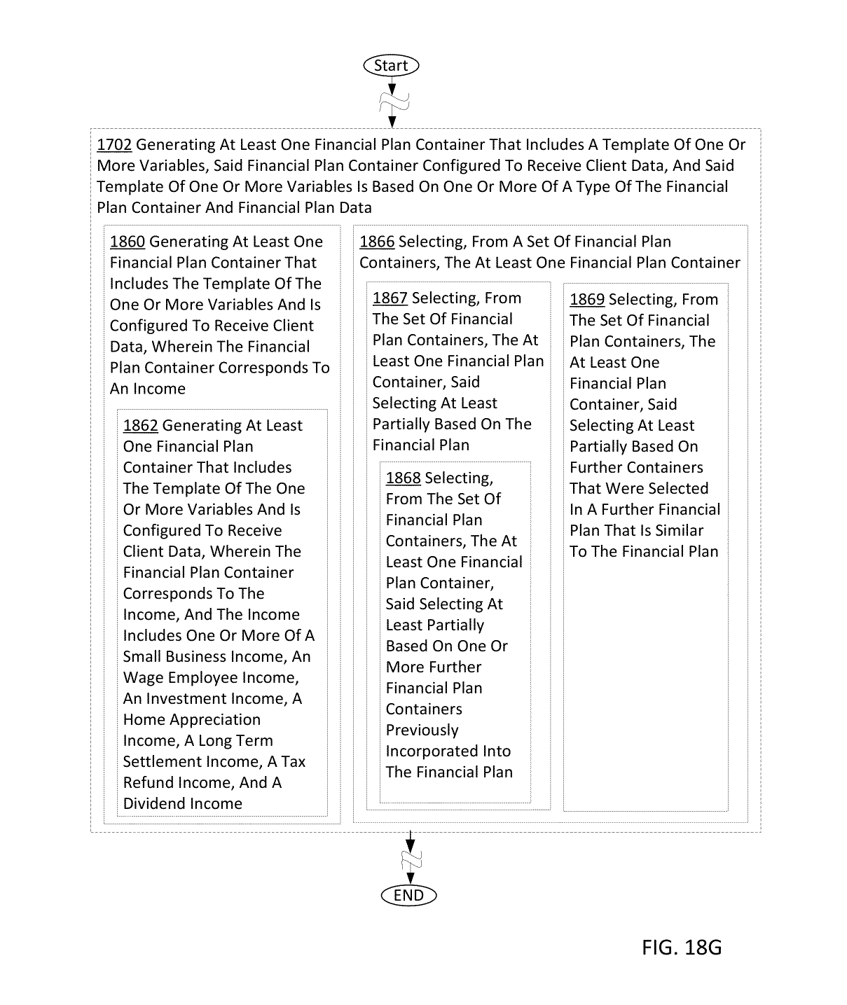

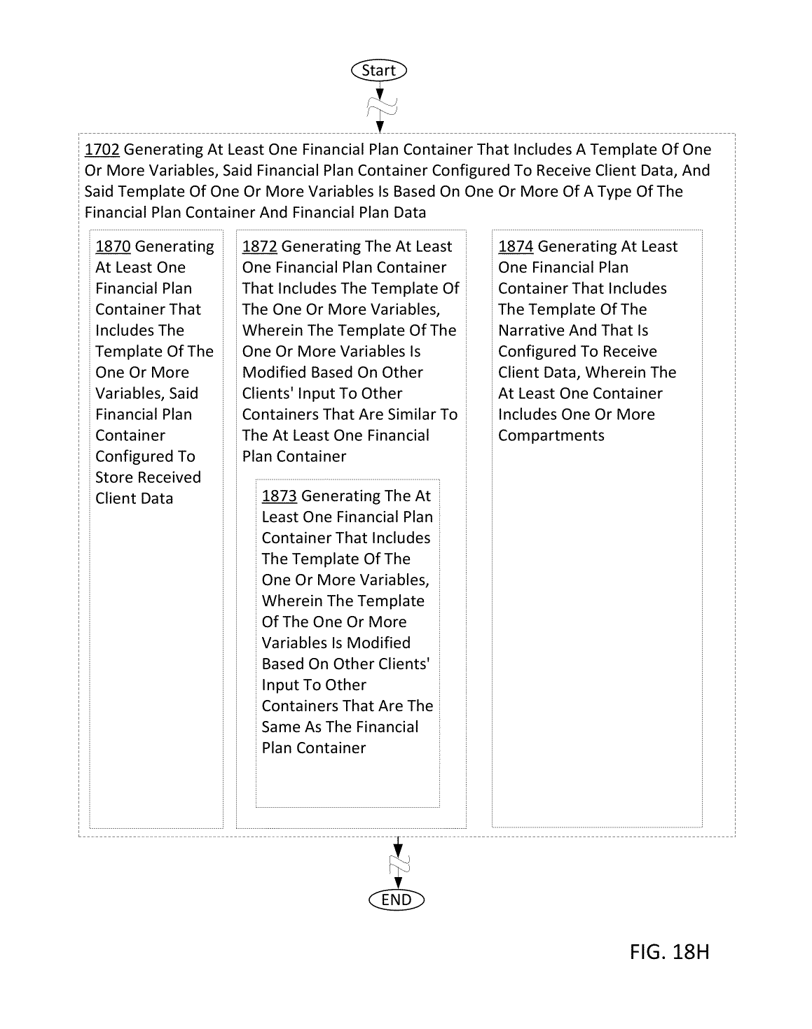

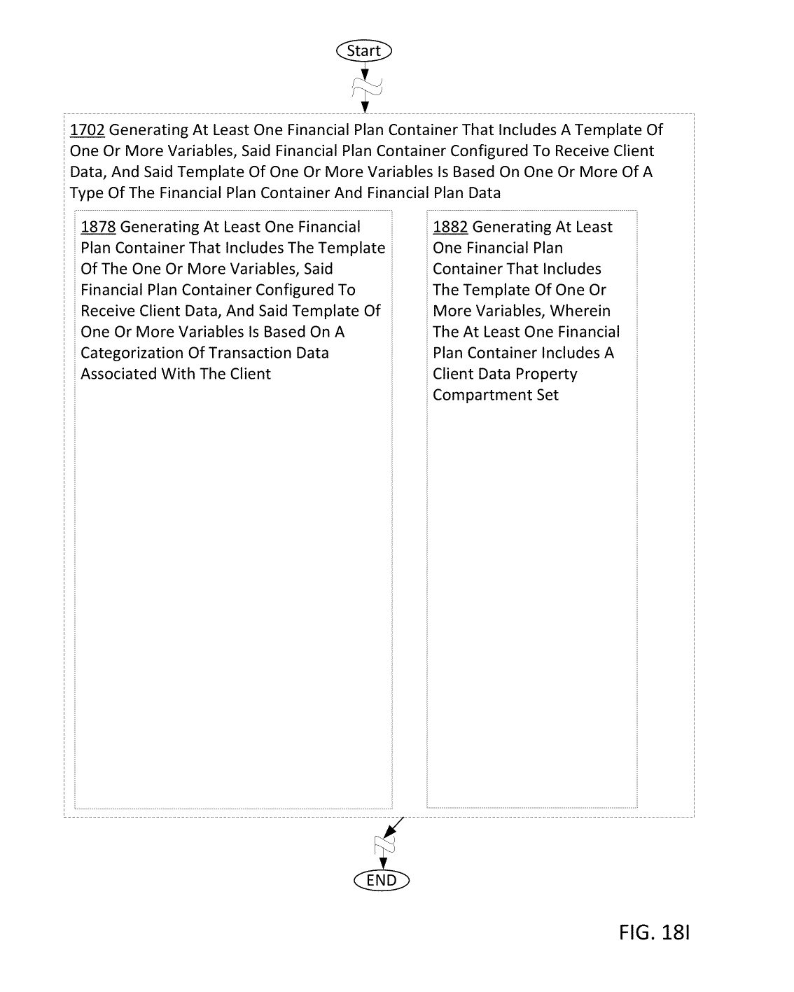

FIGS. 10A-10I show various implementations of financial plan container generating module 852 configured to generate at least one container that includes a template of one or more variables, said financial plan container configured to receive client data, and said template of one or more variables is based on one or more of a type of the financial plan container and financial plan data. For example, referring to FIG. 10A, in an embodiment, financial plan container generating module 852 may include a financial plan container generating module 1002 that is configured to receive client data that is inputted by the client, and said template of one or more variables based on one or more of a type of the financial plan container and financial plan data. For example, in an embodiment, the container, e.g., the container variables, may determine the interface by which the client inputs the client data that will be used to build the financial plan. Referring now to FIG. 18A, in an embodiment, financial plan container generating module 1002 may be configured to carry out at least a portion of operation 1802 depicting generating at least one financial plan container that includes a template of one or more variables, said financial plan container configured to receive client data that is inputted by the client, and said template of one or more variables based on one or more of a type of the financial plan container and financial plan data.

In an embodiment, a container, in addition to including a template of one or more variables, may further include data that describes how that container behaves, e.g., how the container presents data to the client, how the container accepts data from the client, how the container interacts with the larger models that generate the client financial plan, and so forth. The template of variables included in the container may define one or more properties of the container. This template of variables may be configured to change without disturbing data stored in the container.

For example, in an embodiment, the template of variables included in the container may change as a client inputs data into a container, or into other containers. For example, in an embodiment, a client may log onto the system for the first time. In such an example, the system may activate a container that corresponds to a job, e.g., a job container, or a job “Life Card,” in an embodiment. The job container may use the template of variables to determine what the interface looks like to the client, e.g., what options are presented, and what the default values of those options are. Moreover, the job container may have one or more variables that are related to the specific economic performance of that card, which may, in an embodiment, be hidden from the client to prevent confusion of the client. After the client has entered in all the requested inputs from the “job” container, the system may prompt the user to fill out a “house” container. The template of variables associated with the house container may depend on the data that was inputted into the job container.

In an embodiment, the changing of the template of the variables associated with the house container may occur in a number of different ways. In an embodiment, the data inputted into the job container may be used in an algorithm to predict the client's behavior in the house container, and to adjust accordingly. In another embodiment, the data inputted into the job container may be used to search other client's profiles that have job containers with similar data. Then, house containers that are associated with other clients that have similar job containers as the client using the system, are used to modify the template of the variables associated with the house container. For example, in an embodiment, the client enters into the job container that she makes over one million dollars per year. The system then searches other clients that have job containers indicating a job income of over one million dollars per year, and finds that all of those clients also have house containers where the value of the house is greater than 500,000 dollars. Then, when the system displays the house container to this client, the “starting value” of the client's house may be changed from a default value of 100,000 dollars, to an updated value of 500,000 dollars.

In an embodiment, this process may happen in real time or in near real time, and, in an embodiment, with each card that is added to the system, the system grows better at predicting how to modify the template of variables for each card for a particular client. Thus, in an embodiment, if a client is the thousandth client to use the system, the cards may appear less tailored than if the client is the millionth client to use the system.

Referring again to FIG. 10A, in an embodiment, financial plan container generating module 852 may include a financial plan container generating module 1004 that is configured to receive client data, and said template of one or more variables is based on the type of the financial plan container. For example, in an embodiment, the template of one or more variables is controlled by the type of the financial plan container. For example, if the type of the financial plan container is “taxes,” then there may be a field for “tax rate,” for “deductions,” for “taxable income,” for “non-taxable income,” and the like. If, more specifically, the type of the financial plan container is “Virginia state taxes,” then there may be a field for “Virginia tax rate,” that is filled in with the values for the Virginia taxes, and separate fields for Virginia-specific deductions. Referring again to FIG. 18A, in an embodiment, financial plan container generating module 1004 may be configured to carry out at least a portion of operation 1804 depicting generating at least one financial plan container that includes the template of one or more variables, said financial plan container configured to receive client data, and said template of one or more variables is based on the type of the financial plan container.

Referring again to FIG. 10A, in an embodiment, financial plan container generating module 1004 may include a financial plan container generating module 1006 that is configured to receive client data, and said template of one or more variables is based on the type of the financial plan container, where the type of the financial plan container is one or more of an asset type, an event type, a person type, a debt type, an insurance type, a tax type, and an income type. For example, if the type of the financial plan container is “taxes,” then there may be a field for “tax rate,” for “deductions,” for “taxable income,” for “non-taxable income,” and the like. If, more specifically, the type of the financial plan container is “Virginia state taxes,” then there may be a field for “Virginia tax rate,” that is filled in with the values for the Virginia taxes, and separate fields for Virginia-specific deductions. Referring again to FIG. 18A, in an embodiment, financial plan container generating module 1006 may be configured to carry out at least a portion of operation 1806 depicting generating at least one financial plan container that includes the template of one or more variables, wherein said template of one or more variables is based on the type of the financial plan container, and said type is one or more of an asset type, an event type, a person type, a debt type, an insurance type, a tax type, and an income type.

Referring again to FIG. 10A, in an embodiment, financial plan container generating module 1006 may include financial plan container generating module 1008 that is configured to generate at least one financial plan container that includes the template of one or more variables, wherein said template of one or more variables is based on the type of the financial plan container that is an asset financial plan container. For example, in an embodiment, the asset financial plan container may be a “boat” financial plan container. Thus, the template of variables may include one or more variables that request client input regarding docking fees, gasoline fees, cost of boat, etc. In an embodiment, the template of variables may include one or more variables that are internal to the container, that describe boat depreciation. This template of variables may be based on data inputted by economists in the back end of the system, or, in an embodiment, may be based on the behavior of other “boat” containers of other clients, or a combination thereof. Referring again to FIG. 18A, in an embodiment, financial plan container generating module 1008 may be configured to carry out at least a portion of operation 1808 depicting generating at least one financial plan container that includes the template of one or more variables, wherein said template of one or more variables is based on the type of the financial plan container that is an asset financial plan container.

Referring again to FIG. 10A, in an embodiment, financial plan container generating module 1008 may include financial plan container generating module 1010 that is configured to generate at least one financial plan container that includes the template of one or more variables, wherein said template of one or more variables is based on the type of the financial plan container that is a motor vehicle asset financial plan container. For example, the “asset” container may be a motor vehicle asset financial plan container that is configured to ask “own or lease.” In an embodiment, the client's answer to that question may change the template of variables, e.g., causing the container to reconfigure itself to take into account “trade-in value” or other factors that are specific to owning the car or leasing the car. These factors may be programmed in by data scientists and/or economists, or may be based on observed behavior from other clients filling out other motor vehicle containers. Referring again to FIG. 18A, in an embodiment, financial plan container generating module 1010 may be configured to carry out at least a portion of operation 1810 depicting generating at least one financial plan container that includes the template of one or more variables, wherein said template of one or more variables is based on the type of the financial plan container that is a motor vehicle asset financial plan container.

Referring again to FIG. 10A, in an embodiment, financial plan container generating module 1010 may include financial plan container generating module 1012 (not pictured in FIG. 10A due to size constraints) that is configured to generate at least one financial plan container, wherein the one or more variables include one or more of an asset value, an asset loan value, an asset interest rate, an asset monthly payment, and an asset monthly gasoline cost, wherein said template of one or more variables is based on the type of the financial plan container that is a motor vehicle asset financial plan container. Referring again to FIG. 18A, in an embodiment, financial plan container generating module 1012 may be configured to carry out at least a portion of operation 1812 depicting generating at least one financial plan container that includes the template of one or more variables that include one or more of an asset value, an asset loan value, an asset interest rate, an asset monthly payment, and an asset monthly gasoline cost, wherein said template of one or more variables is based on the type of the financial plan container that is a motor vehicle asset financial plan container.

Referring now to FIG. 10B, in an embodiment, financial plan container generating module 852 may include financial plan container generating module 1014 that is configured to generating at least one financial plan container that includes a template of one or more variables, wherein the financial plan container is configured to receive client data, the one or more variables are selected based on the type of the financial plan container, and one or more values for the one or more variables are based on the financial plan data. For example, the values for the variables may be default values that are based on other clients who have filled out the input in the container, or they may be default values programmed into the container by data analysts or economists, or they may be values that are based on data that the client has already entered into different containers, e.g., whether it is in a previous session in which the client generated a financial plan and now is updating the financial plan, or in a new session in which the client is entering data into the fourth of five containers to generate an initial financial plan. Referring now to FIG. 18B, in an embodiment, financial plan container generating module 1014 may be configured to carry out at least a portion of operation 1814 depicting generating at least one financial plan container that includes a template of one or more variables, wherein the financial plan container is configured to receive client data, the one or more variables are selected based on the type of the financial plan container, and one or more values for the one or more variables are based on the financial plan data.

Referring again to FIG. 10B, in an embodiment, financial plan container generating module 1014 may include financial plan container generating module 1016 that is configured to generating at least one financial plan container that includes a template of one or more variables, wherein the financial plan container is configured to receive client data, the one or more variables are selected based on the type of the financial plan container, and the one or more values for the one or more variables are based on financial plan data of one or more further clients that have one or more further financial plans that include one or more further financial plan containers. For example, referring to FIG. 18B, in an embodiment, financial plan container generating module 1016 may be configured to carry out at least a portion of operation 1816 depicting generating at least one financial plan container that includes a template of one or more variables, wherein the financial plan container is configured to receive client data, the one or more variables are selected based on the type of the financial plan container, and the one or more values for the one or more variables are based on financial plan data of one or more further clients that have one or more further financial plans that include one or more further financial plan containers.

Referring again to FIG. 10B, in an embodiment, financial plan container generating module 1016 may include financial plan container generating module 1018 that is configured to generating at least one financial plan container that includes a template of one or more variables, wherein the financial plan container is configured to receive client data, the one or more variables are selected based on the type of the financial plan container, and the one or more values for the one or more variables are based on financial plan data of one or more further clients that have one or more further financial plans that include a further financial plan container that is a same type of financial plan container as the at least one financial plan container. For example, referring again to FIG. 18B, in an embodiment, financial plan container generating module 1018 may be configured to carry out at least a portion of operation 1018 depicting generating at least one financial plan container that includes a template of one or more variables, wherein the financial plan container is configured to receive client data, the one or more variables are selected based on the type of the financial plan container, and the one or more values for the one or more variables are based on financial plan data of one or more further clients that have one or more further financial plans that include a further financial plan container that is a same type of financial plan container as the at least one financial plan container.

Referring now to FIG. 10C, in an embodiment, financial plan container generating module 852 may include financial plan container generating module 1020 that is configured to generate at least one financial plan container that includes a template of one or more variables in which the one or more variables are selected at least partly based on financial plan data. For example, referring now to FIG. 18C, in an embodiment, financial plan container generating module 1020 may be configured to carry out at least a portion of operation 1820 depicting generating at least one financial plan container that includes a template of one or more variables, said financial plan container configured to receive client data, and said one or more variables are selected at least partly based on financial plan data.

Referring again to FIG. 10C, in an embodiment, financial plan container generating module 1020 may include financial plan container generating module 1022 that is configured to generate at least one financial plan container that includes a template of one or more variables, said financial plan container configured to receive client data, and said one or more variables are selected based on financial plan data from the financial plan of a client associated with the client data. For example, if the client has previously filled out client data for an “income” container, that will affect the variables when the “taxes” container is generated. Referring again to FIG. 18C, in an embodiment, financial plan container generating module 1022 may be configured to carry out at least a portion of operation 1822 depicting generating at least one financial plan container that includes a template of one or more variables, said financial plan container configured to receive client data, and said one or more variables are selected based on financial plan data from the financial plan of a client associated with the client data.

Referring again to FIG. 10C, in an embodiment, financial plan container generating module 1020 may include financial plan container generating module 1024 that is configured to generate at least one financial plan container that includes a template of one or more variables, said financial plan container configured to receive client data, and said one or more variables are selected based on financial plan data from a financial plan of one or more further clients. For example, if the client is filling out an “asset” container, then the system may retrieve one or more asset containers that were filled out by other clients. In an embodiment, the system may select one or more asset containers that were filled out by other clients that have similar characteristics to the client that is filling out the data in the container, as determined by containers previously filled out by the client. Referring again to FIG. 18C, in an embodiment, financial plan container generating module 1024 may be configured to carry out at least a portion of operation 1824 depicting generating at least one financial plan container that includes a template of one or more variables, said financial plan container configured to receive client data, and said one or more variables are selected based on financial plan data from a financial plan of one or more further clients.

Referring again to FIG. 10C, in an embodiment, financial plan container generating module 1024 may include financial plan container generating module 1026 that is configured to generate at least one financial plan container that includes a template of one or more variables, said financial plan container configured to receive client data, and said one or more variables are selected based on financial plan data from a financial plan of the one or more further clients. Referring again to FIG. 18C, in an embodiment, financial plan container generating module 1026 may be configured to carry out at least a portion of operation 1826 depicting generating at least one financial plan container that includes a template of one or more variables, said financial plan container configured to receive client data, and said one or more variables are selected based on financial plan data from a financial plan of the one or more further clients, wherein the one or more further clients have one or more further financial plan containers that are a same container as the at least one financial plan container.

Referring now to FIG. 10D, in an embodiment, financial plan container generating module 1020 may include financial plan container generating module 1028 that is configured to generate at least one financial plan container that includes a template of one or more variables that are selected based on data received from one or more external sources. For example, in an embodiment, these external sources may be other computer systems located in a cloud or on various servers, which may represent financial institution data, stock market data, alternate market data, news data, and the like. In another embodiment, the external sources may refer to one or more operators of the system that manually update variables and parameters of the various models, algorithms, and/or formulae used in part to generate the containers. Referring now to FIG. 18D, in an embodiment, financial plan container generating module 1028 may be configured to carry out at least a portion of operation 1828 depicting generating at least one financial plan container that includes a template of one or more variables, said financial plan container configured to receive client data, and said one or more variables are selected based on data received from one or more external sources.

Referring again to FIG. 10D, in an embodiment, financial plan container generating module 1028 may include financial plan container generating module 1030 that is configured to generate at least one financial plan container that includes a template of one or more variables that are selected based on data received from one or more economists, scientists, and data analysts. Referring again to FIG. 18D, in an embodiment, financial plan container generating module 1030 may be configured to carry out at least a portion of operation 1830 depicting generating at least one financial plan container that includes a template of one or more variables, said financial plan container configured to receive client data, and said one or more variables are selected based on data received from one or more economists, scientists, and data analysts.

Referring again to FIG. 10D, in an embodiment, financial plan container generating module 1028 may include financial plan container generating module 1032 that is configured to generate at least one financial plan container that includes a template of one or more variables that are selected based on data received from one or more financial data gathering institutions. For example, banks, investment companies, news aggregators (e.g., Bloomberg), may contribute data to module 1032, e.g., via a network, e.g., network 110 of FIG. 1. Referring again to FIG. 18D, in an embodiment, financial plan container generating module 1032 may be configured to carry out at least a portion of operation 1832 depicting generating at least one financial plan container that includes a template of one or more variables, said financial plan container configured to receive client data, and said one or more variables are selected based on data received from one or more financial data gathering institutions.

Referring now to FIG. 10E, in an embodiment, financial plan container generating module 852 may include a financial plan container generating module 1034 that is configured to generate at least one financial plan container that is a life card that corresponds to one or more events, occurrences, states, and conditions. An example life card is shown in FIG. 2, e.g., one or more of job container 210, home container 220, vacation container 230, and baby container 240, according to various embodiments. Referring now to FIG. 18E, in an embodiment, financial plan container generating module 1034 may be configured to carry out at least a portion of operation 1834 depicting generating at least one financial plan container that includes the template of one or more variables, wherein the at least one financial plan container is a life card that corresponds to one or more events, occurrences, states, and conditions.

Referring again to FIG. 10E, in an embodiment, financial plan container generating module 852 may include a financial plan container generating module 1036 that is configured to generate at least one financial plan container that includes a template of one or more variables and that is configured to receive client data input from the client. For example, in an embodiment, a container, e.g., job container 210 in FIG. 2, may generate a custom client interface 212 so that a client 205 may enter their data into the job container 210. Referring again to FIG. 18E, in an embodiment, financial plan container generating module 1036 may be configured to carry out at least a portion of operation 1836 depicting generating at least one financial plan container that includes a template of one or more variables, wherein the financial plan container is configured to receive client data input from the client.

Referring again to FIG. 10E, in an embodiment, financial plan container generating module 852 may include a financial plan container generating module 1038 that is configured to generate at least one financial plan container that includes a template of one or more variables and that is configured to receive client data input from the client, and said input is configured to avoid requiring specialized financial knowledge. For example, the input may be receive from the client, without the client knowing such things as rate of return, service fees, opportunity costs, compound interest, risk tolerance levels, confidence intervals, or other concepts in traditional financial planning Referring again to FIG. 18E, in an embodiment, financial plan container generating module 1038 may be configured to carry out at least a portion of operation 1838 depicting generating at least one financial plan container that includes a template of one or more variables, wherein the financial plan container is configured to receive client data input from the client, and said input is configured to avoid requiring specialized financial knowledge.

Referring now to FIG. 10F, in an embodiment, financial plan container generating module 852 may include a financial plan container generating module 1052 that is configured to generate at least one financial plan container that includes the template of the one or more variables and is configured to receive client data, wherein the financial plan container corresponds to an event. Referring now to FIG. 18F, in an embodiment, financial plan container generating module 1052 may be configured to carry out at least a portion of operation 1852 depicting generating at least one financial plan container that includes the template of the one or more variables and is configured to receive client data, wherein the financial plan container corresponds to an event. In an embodiment, the event may represent one or more of a wedding, a purchase, a vacation, a move, a relocation, and a change in job. For example, referring again to FIG. 10F, container generating module 1052 may include container generating module 1054 that is configured to generate at least one financial plan container that includes the template of the one or more variables and is configured to receive client data, wherein the financial plan container corresponds to an event, wherein the event includes one or more of a wedding, a purchase, a vacation, a move, a relocation, and a change in job. Referring again to FIG. 18F, in an embodiment, financial plan container generating module 1054 may be configured to carry out at least a portion of operation 1854 depicting generating at least one financial plan container that includes the template of the one or more variables and is configured to receive client data, wherein the financial plan container corresponds to an event, wherein the event includes one or more of a wedding, a purchase, a vacation, a move, a relocation, and a change in job.

Referring again to FIG. 10F, in an embodiment, financial plan container generating module 852 may include financial plan container generating module 1056 that is configured to generate at least one financial plan container that includes the template of the one or more variables and is configured to receive client data, wherein the financial plan container corresponds to a living entity. For example, referring again to FIG. 18F, in an embodiment, financial plan container generating module 1056 may carry out at least a portion of operation 1856 depicting generating at least one financial plan container that includes the template of the one or more variables and is configured to receive client data, wherein the financial plan container corresponds to a living entity.

Referring again to FIG. 10F, container generating module 1056 may include financial plan container generating module 1058 that is configured to generate at least one financial plan container that includes the template of the one or more variables and is configured to receive client data, wherein the financial plan container corresponds to an entity, wherein the entity includes one or more of a mother, father, child, uncle, adult dependent, pet, and a work animal. Referring again to FIG. 18F, in an embodiment, financial plan container generating module 1058 may be configured to carry out at least a portion of operation 1858 depicting generating at least one financial plan container that includes the template of the one or more variables and is configured to receive client data, wherein the financial plan container corresponds to an entity, wherein the entity includes one or more of a mother, father, child, uncle, adult dependent, pet, and a work animal.

Referring now to FIG. 10G, in an embodiment, financial plan container generating module 852 may include financial plan container generating module 1060 that is configured to generate at least one financial plan container that includes the template of the one or more variables and is configured to receive client data, wherein the financial plan container corresponds to an income. For example, referring now to FIG. 18G, in an embodiment, container generating module 1060 may carry out at least a portion of operation 1860 depicting generating at least one financial plan container that includes the template of the one or more variables and is configured to receive client data, wherein the financial plan container corresponds to an income. For example, the condition may include one or more of a married condition, a single condition, a childless condition, a single child condition, a two or more children condition, a supporting an elderly relative condition, an owner of rental property condition, and a small business owner condition.

Referring again to FIG. 10G, container generating module 1060 may include financial plan container generating module 1062 that is configured to generate at least one financial plan container that includes the template of the one or more variables and is configured to receive client data, wherein the financial plan container corresponds to the income, and the income includes one or more of a small business income, an wage employee income, an investment income, a home appreciation income, a long term settlement income, a tax refund income, and a dividend income. Referring again to FIG. 18F, in an embodiment, container generating module 1062 may be configured to carry out at least a portion of operation 1862 depicting generating at least one financial plan container that includes the template of the one or more variables and is configured to receive client data, wherein the financial plan container corresponds to the income, and the income includes one or more of a small business income, an wage employee income, an investment income, a home appreciation income, a long term settlement income, a tax refund income, and a dividend income.

Referring again to FIG. 10G, in an embodiment, financial plan container generating module 852 may include a financial plan container selecting module 1066. For example, container selecting module may be configured to select a container, from a set of containers, e.g., a set of containers stored in memory 820 of main service server 105. Referring again to FIG. 18G, in an embodiment, container selecting module 1066 may be configured to carry out at least a portion of operation 1866 depicting selecting, from a set of financial plan containers, the at least one financial plan container.

Referring again to FIG. 10G, in an embodiment, financial plan container selecting module 1066 may include financial plan container selecting at least partly based on the financial plan module 1067. Referring again to FIG. 18G, in an embodiment, financial plan container selecting at least partially based on existing client financial plan module 1067 may carry out at least a portion of operation 1867 depicting selecting, from the set of financial plan containers, the at least one financial plan container, said selecting at least partially based on the financial plan.

Referring again to FIG. 10G, in an embodiment, financial plan container selecting module 1067 may include financial plan container selecting at least partly based on further financial container previously incorporated into the financial plan module 1068. Referring again to FIG. 18G, in an embodiment, financial plan container selecting module 1068 may be configured to carry out at least a portion of operation 1868 depicting selecting, from the set of financial plan containers, the at least one financial plan container, said selecting at least partially based on one or more further financial plan containers previously incorporated into the financial plan.

Referring again to FIG. 10G, in an embodiment, financial plan container selecting module 1066 may include financial plan container selecting at least partly based on one or more further financial containers that were selected in a further financial plan that is similar to the financial plan module 1069. Referring again to FIG. 18G, in an embodiment, financial plan container selecting module 1069 may be configured to carry out at least a portion of operation 1869 depicting selecting, from the set of financial plan containers, the at least one financial plan container, said selecting at least partially based on further containers that were selected in a further financial plan that is similar to the financial plan.

Referring now to FIG. 10H, in an embodiment, financial plan container generating module 852 may include financial plan container generating module 1070 that is configured to generate at least one financial plan container that includes the template of the one or more variables, said financial plan container configured to store received client data. Referring now to FIG. 18H, in an embodiment, container generating module 1070 may carry out at least a portion of operation 1870 depicting generating at least one financial plan container that includes the template of the one or more variables, said financial plan container configured to store received client data.

Referring again to FIG. 10H, in an embodiment, financial plan container generating module 852 may include financial plan container generating module 1072 that is configured to generate the at least one financial plan container that includes the template of the one or more variables, wherein the template of the one or more variables is modified based on other clients' input to other containers that are similar to the at least one financial plan container. Referring now to FIG. 18H, in an embodiment, financial plan container generating module 1072 may be configured to carry out at least a portion of operation 1872 depicting generating the at least one financial plan container that includes the template of the one or more variables, wherein the template of the one or more variables is modified based on other clients' input to other containers that are similar to the at least one financial plan container.

Referring again to FIG. 10H, in an embodiment, financial plan container generating module 1072 may include financial plan container generating module 1073 configured to generate the at least one financial plan container that includes the template of the one or more variables, wherein the template of the one or more variables is modified based on other clients' input to other containers that are the same as the financial plan container. Referring now to FIG. 18H, in an embodiment, financial plan container generating module 1073 may be configured to carry out at least a portion of operation 1873 depicting generating the at least one financial plan container that includes the template of the one or more variables, wherein the template of the one or more variables is modified based on other clients' input to other containers that are the same as the financial plan container.

Referring again to FIG. 10H, in an embodiment, financial plan container generating module 852 may include financial plan container generating module 1074 that is configured to generate at least one financial plan container that includes the template of the narrative and that is configured to receive client data, wherein the at least one container includes one or more compartments. For example, referring to FIG. 15, a container, e.g., container 1500, may include one or more compartments, e.g., a container client data properties compartment set 1505, a container reference comparison compartment 1555, and a container economic variables compartment 1565. These compartments will be discussed in more detail herein with respect to FIG. 15. Referring again to FIG. 18H, in an embodiment, container generating module 1074 may carry out at least a portion of operation 1874 depicting generating at least one financial plan container that includes the template of the narrative and that is configured to receive client data, wherein the at least one container includes one or more compartments.

Referring now to FIG. 10I, in an embodiment, financial plan container generating module 852 may include financial plan container generating module 1078 that is configured to generate at least one financial plan container that includes the template of the one or more variables, said financial plan container configured to receive client data, and said template of one or more variables is based on a categorization of transaction data associated with the client. Referring now to FIG. 18I, in an embodiment, container generating module 1078 may carry out at least a portion of operation 1878 depicting generating at least one financial plan container that includes the template of the one or more variables, said financial plan container configured to receive client data, and said template of one or more variables is based on a categorization of transaction data associated with the client.

Referring again to FIG. 10I, in an embodiment, financial plan container generating module 852 may include financial plan container generating module 1082 that is configured to generate at least one financial plan container that includes the template of one or more variables, wherein the at least one financial plan container includes a client data property compartment set. Referring again to FIG. 18I, in an embodiment, container generating module 1082 may carry out at least a portion of operation 1 depicting generating at least one financial plan container that includes the template of one or more variables, wherein the at least one financial plan container includes a client data property compartment set.

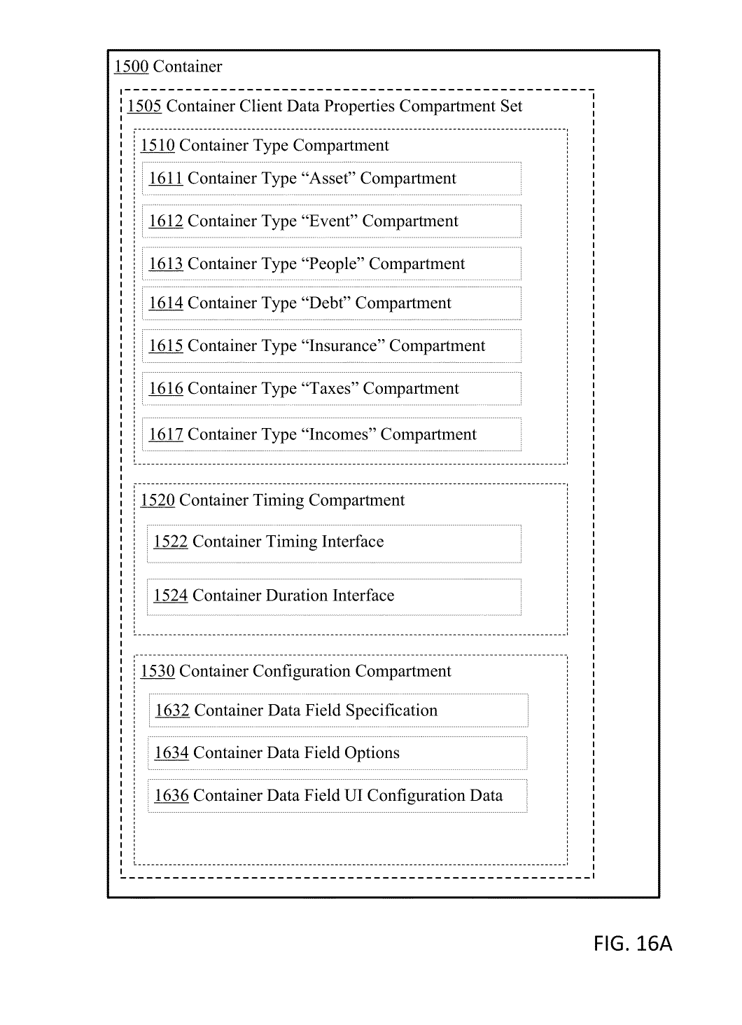

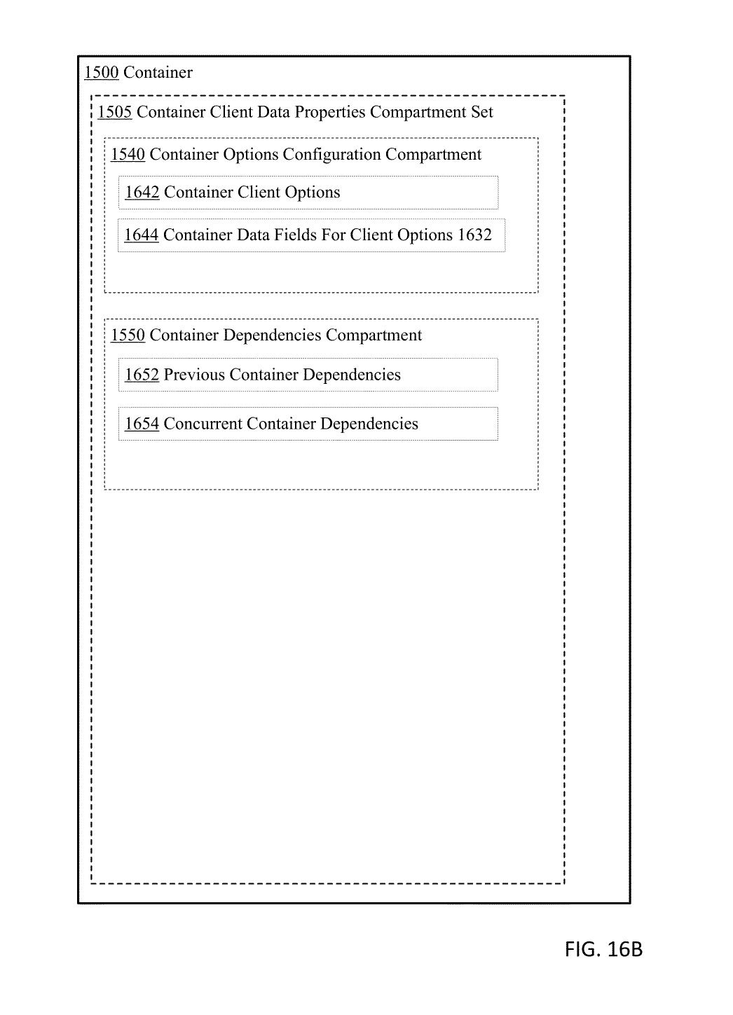

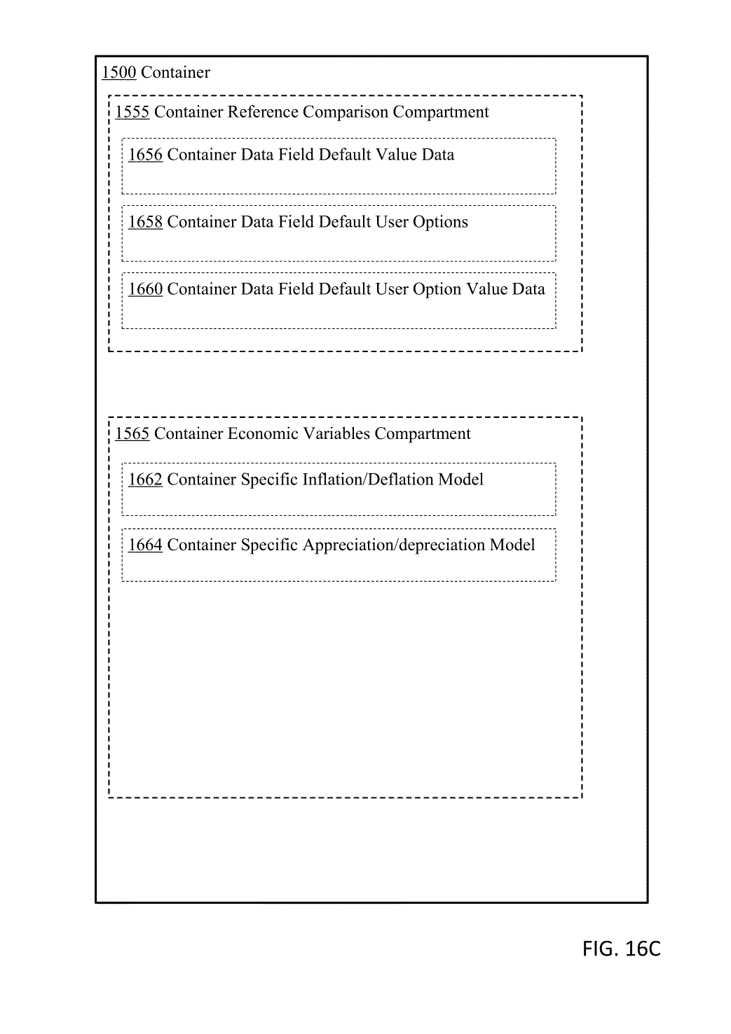

In an embodiment, containers are used to manage client data, create client interactions with the interface, provide data to the various forecasting equations and models, and the like. In an embodiment, containers may be implemented as “Life Cards,” which, as previously described, may correspond to events in a user's life, occurrences in a user's life, and conditions in a user's life. In an embodiment, these “Life Cards” may be instantiated as containers, e.g., containers 1500, as shown in FIG. 15. Container 1500 may include any combination of compartments, which may be various specifications, data structures, databases, templates, or other forms of data in the container that specify container operations. Some examples of container compartments are shown in FIGS. 15 and 16A-16C, which will be discussed herein.

Referring now to FIG. 15, in an embodiment, a container 1500 may include one or more compartments. For example, a container 1500 may include a container client data properties compartment set 1505. The container client data properties compartment set 1505 may include a container type compartment, which may define a type of container. The type of container may be broad, e.g., “assets,” or may be narrower, e.g., “vehicle” container type, “boat” container type, “house” container type. Container type compartment 1510 may store the type of container. Referring to FIG. 16A, container type compartment 1510 may include one or more container types. For example, container type compartment 1510 may include a container type “asset” compartment 1611, which may include a “home” container type, a “vehicle” container type, a “boat” container type, a “home” container type, a “computer” container type, a “jewelry” container type, a “paintings” container type, and so forth. In an embodiment, the container type “asset” compartment 1611 may include intangible assets, e.g., a “stock” container type, a “bond” container type, a “savings bond” container type, a “retirement account from company A” container type, a “retirement account from company B” container type, a “money market” container type, an “IRA” container type, and so forth.

Referring again to FIG. 16A, container type compartment 1510 may include a container type “event” compartment 1612. This compartment may include different types of “event” containers, e.g., a “European vacation” container type, a “Retirement” container type, a “Daughter's Wedding” container type, and so forth. Referring again to FIG. 16A, container type compartment 1510 may include a container type “people” compartment 1613, which may include various containers of people related to the client, e.g., a “Mom” container type, a “Dad” container type, a “Child” container type, a “Spouse” container type, an “Adult dependent” container type, and so forth. Referring again to FIG. 16A, container type compartment 1510 may include a container type “debt” compartment 1614, which may include a “credit card debt” container type, a “college loan debt” container type, a “mortgage debt” container type, and so forth.

Referring again to FIG. 16A, container type compartment 1510 may include a container type “insurance” compartment 1615. This compartment may include different types of “insurance” containers, e.g., a “life insurance” container type, a “medical insurance” container type, a “disability insurance,” container type, a “fire insurance” container type, a “car insurance” container type, and so forth. Referring again to FIG. 16A, container type compartment 1510 may include a container type “taxes” compartment 1616. This compartment may include different types of “tax” containers, e.g., a “state income tax” container, a “federal income tax” container, a “sales tax” container, a “property tax,” container, and so forth. Referring again to FIG. 16A, container type compartment 1510 may include a container type “incomes” compartment 1617. This compartment may include different types of “income” containers, e.g., a “self-employment income” container, an “interest income,” container, a “settlement payout” container, and so forth.

Referring back to FIG. 15, in an embodiment, container client data properties compartment set 1505 may include a container timing compartment 1520. Container timing compartment 1520 may include time-related properties of the container. In an embodiment, there may be two main types of time-related properties of the container, although other properties may exist. One type of time-related property is associated with a container timing interface 1522, which specifies the timing that the container represents, e.g., “past,” “present,” “future,” “hypothetical,” or a combination thereof. Another type of time-related property is associated with a container duration interface 1524, which specifies the expected duration of the container, e.g., for a “home” container, the expected duration might be 30 years, for a “child” container, the expected duration may be 18 years.

Referring again to FIG. 15, in an embodiment, container client data properties compartment set 1505 may include a container configuration compartment 1530. Container configuration compartment 1530 may include one or more data fields that specify properties of the container. For example, the data fields that are included in container configuration compartment 1530 may include container name, internal container ID, container duration, container start date, container end date, container graphic display, container color, and so on. Referring again to FIG. 16A, in an embodiment, container configuration compartment 1530 may include one or more of a container data field specification 1632 that defines the various data fields present in the container, a container data field options 1634 that specifies the options for the container data fields (e.g., there may be limited data entry into the data fields), and a container data field user interface configuration data 1636 that specifies how the container will be presented to the client to acquire the client data.

Referring again to FIG. 15, in an embodiment, container client data properties compartment set 1505 may include container options configuration compartment 1540. Container options configuration compartment 1540 may be configured to manage lists of options that can be selected through the user interface (e.g., for a container configuration of “home type,” the options can be “apartment, townhouse, condominium, single family home, ranch.” Referring now to FIG. 16B, container options configuration compartment 1540 may include container client options 1642 and container data fields for client options 1644.

Referring again to FIG. 15, in an embodiment, container client data properties compartment set 1505 may include a container dependencies compartment 1550 that specifies various dependencies for the container 1500. For example, referring again to FIG. 16B, container dependencies compartment 1550 may include previous container dependencies 1652 and concurrent container dependencies 1654.

Referring again to FIG. 15, in an embodiment, container 1500 may include a container reference comparison compartment 1555. Container reference comparison compartment 1555 may be configured to be modified by various data scientists that monitor and analyze the various workings of the models and the containers, as well as the values that are inputted into the containers. For example, referring now to FIG. 16C, container reference comparison compartment 1555 may include a container data field default value data 1656, e.g., which may use standard values for “life expectancy,” e.g., of 72 years, and so forth. Referring again to FIG. 16C, container reference comparison compartment 1555 may include container data field default user option 1658 and container data field default user option value data 1660.

Referring again to FIG. 15, in an embodiment, container 1500 may include a container economic variables compartment 1565, which may include one or more of a container-specific inflation/deflation module 1662 and a container-specific appreciation/depreciation module 1664, as shown in FIG. 16C. In an embodiment, these values may be modified by economists or other managers of the system that monitor the economy and various factors that affect the economy.

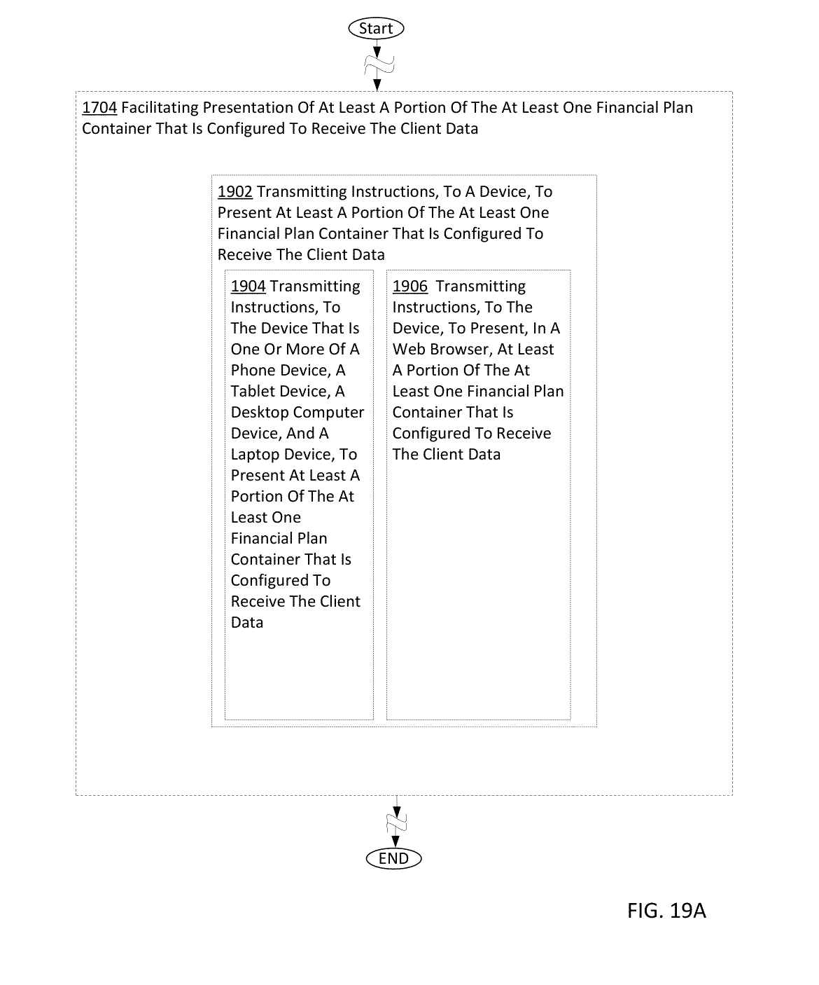

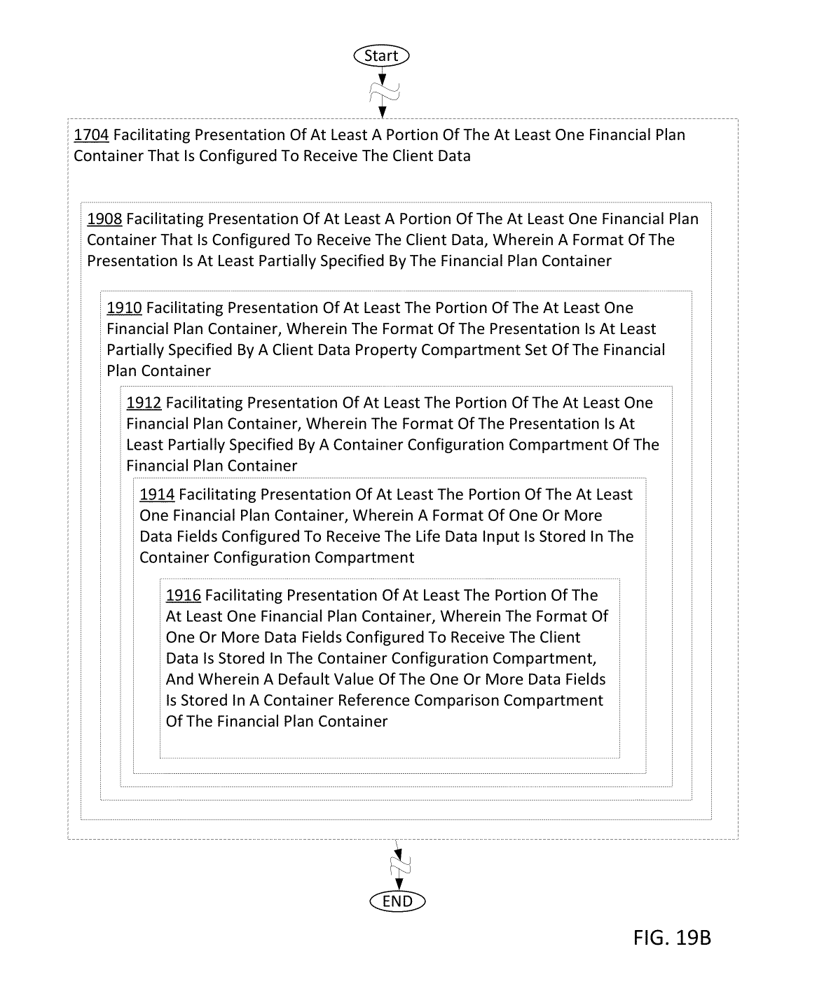

Referring now to FIG. 11, FIGS. 11A-11B show various implementations of financial plan container portion presentation facilitating module 854 configured to facilitate presentation of at least a portion of the at least one financial plan container that is configured to receive the client data. For example, referring to FIG. 11A, in an embodiment, financial plan container portion presentation facilitating module 854 may include an instruction for presentation of the financial plan container transmitting module 1102 that is configured to transmit instructions to a device, to present at least a portion of the one container. Referring now to FIG. 19A, in an embodiment, container portion presentation facilitating module 1102 may carry out at least a portion of operation 1902 depicting transmitting instructions, to a device, to present at least a portion of the at least one financial plan container that is configured to receive the client data.

Referring again to FIG. 11A, in an embodiment, instruction for presentation of financial plan container transmitting module 1102 may include an instruction for presentation of financial plan container transmitting module 1104 that is configured to transmit instructions to one or more of a phone device, a tablet device, a desktop computer device, and a laptop device, to present at least a portion of the at least one financial plan container that is configured to receive the client data. Referring again to FIG. 19A, in an embodiment, instruction for presentation of container transmitting module 1104 may carry out at least a portion of operation 1904 depicting transmitting instructions, to the device that is one or more of a phone device, a tablet device, a desktop computer device, and a laptop device, to present at least a portion of the at least one financial plan container that is configured to receive the client data.

Referring again to FIG. 11A, in an embodiment, instruction for presentation of a financial plan container transmitting module 1102 may include an instruction for presentation of a financial plan container in a web browser transmitting module 1106 that is configured to transmit instructions to present at least a portion of the at least one financial plan container that is configured to receive the client data through a web browser interface. Referring again to FIG. 19A, in an embodiment, an instruction for presentation of a container in a web browser transmitting module 1106 may carry out at least a portion of operation 1906 depicting transmitting instructions, to the device, to present, in a web browser, at least a portion of the at least one financial plan container that is configured to receive the client data.

Referring now to FIG. 11B, in an embodiment, financial plan container portion presentation facilitating module 854 may include financial plan container portion in which a format is at least partially specified by the financial plan container presentation facilitating module 1108 that is configured to facilitate presentation of at least a portion of the at least one container that is configured to receive the life data input, wherein a format of the presentation is at least partially specified by the container. Referring now to FIG. 19B, in an embodiment, financial plan container portion in which a format is at least partially specified by the financial plan container presentation facilitating module 1108 may carry out at least a portion of operation 1908 depicting facilitating presentation of at least a portion of the at least one financial plan container that is configured to receive the client data, wherein a format of the presentation is at least partially specified by the financial plan container.

Referring again to FIG. 11B, in an embodiment, financial plan container portion in which a format is at least partially specified by the financial plan container presentation facilitating module 1108 may include financial plan container portion in which a format is at least partially specified by a client data property compartment set of the financial plan container presentation facilitating module 1110. Referring again to FIG. 19B, in an embodiment, container portion in which a format is at least partially specified by a client data property compartment set of the container presentation facilitating module 1110 may carry out at least a portion of operation 1910 depicting facilitating presentation of at least the portion of the at least one financial plan container, wherein the format of the presentation is at least partially specified by a client data property compartment set of the financial plan container.

Referring again to FIG. 11B, in an embodiment, financial plan container portion in which a format is at least partially specified by a client data property compartment set of the financial plan container presentation facilitating module 1110 may include financial plan container portion in which a format is at least partially specified by a financial plan container configuration compartment of the client data property compartment set of the container presentation facilitating module 1112. Referring again to FIG. 19B, in an embodiment, financial plan container portion in which a format is at least partially specified by a container configuration compartment of the client data property compartment set of the financial plan container presentation facilitating module 1112 may carry out at least a portion of operation 1912 depicting facilitating presentation of at least the portion of the at least one financial plan container, wherein the format of the presentation is at least partially specified by a container configuration compartment of the financial plan container.

Referring again to FIG. 11B, in an embodiment, financial plan container portion in which a format is at least partially specified by a container configuration compartment of the client data property compartment set of the financial plan container presentation facilitating module 1112 may include container portion in which a data field format is at least partially specified by a container configuration compartment of the client data property compartment set of the container presentation facilitating module 1114 that is configured to specify a default value of the data field. Referring again to FIG. 19B, in an embodiment, financial plan container portion in which a data field format is at least partially specified by a container configuration compartment of the client data property compartment set of the financial plan container presentation facilitating module 1114 may carry out at least a portion of operation 1914 depicting facilitating presentation of at least the portion of the at least one financial plan container, wherein a format of one or more data fields configured to receive the life data input is stored in the container configuration compartment.

Referring again to FIG. 11B, in an embodiment, financial plan container portion in which a data field format is at least partially specified by a container configuration compartment of the client data property compartment set of the container presentation facilitating module 1114 may include financial plan container portion in which a data field format is at least partially specified by a container configuration compartment of the client data property compartment set of the financial plan container presentation facilitating module 1116 that is configured to specify a default value of the data field. Referring again to FIG. 19B, in an embodiment, container portion in which a data field format is at least partially specified by a container configuration compartment of the client data property compartment set of the container presentation facilitating module 1116 may carry out at least a portion of operation 1916 depicting facilitating presentation of at least the portion of the at least one financial plan container, wherein the format of one or more data fields configured to receive the client data is stored in the container configuration compartment, and wherein a default value of the one or more data fields is stored in a container reference comparison compartment of the financial plan container.

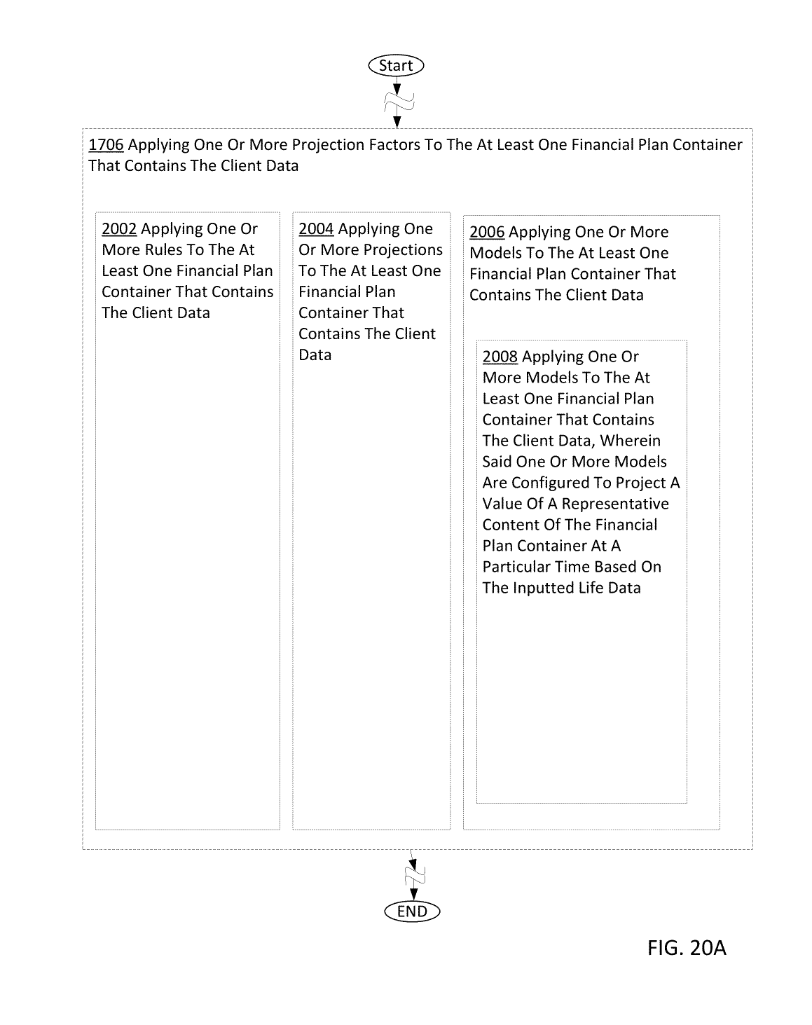

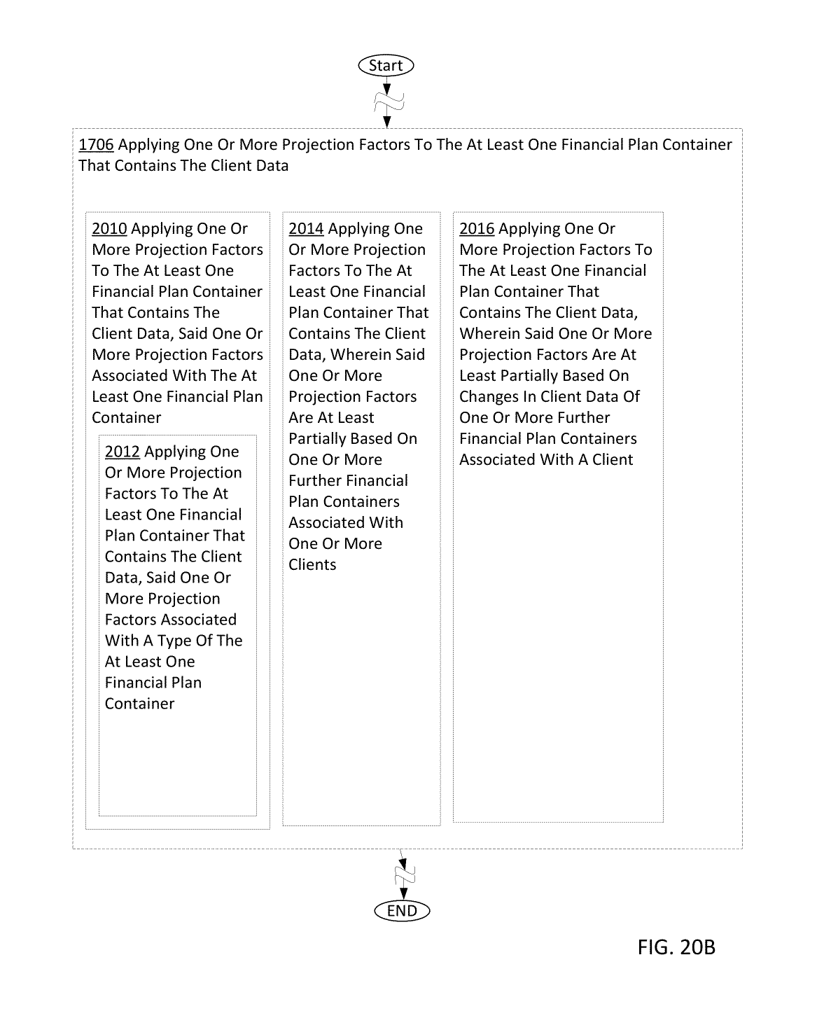

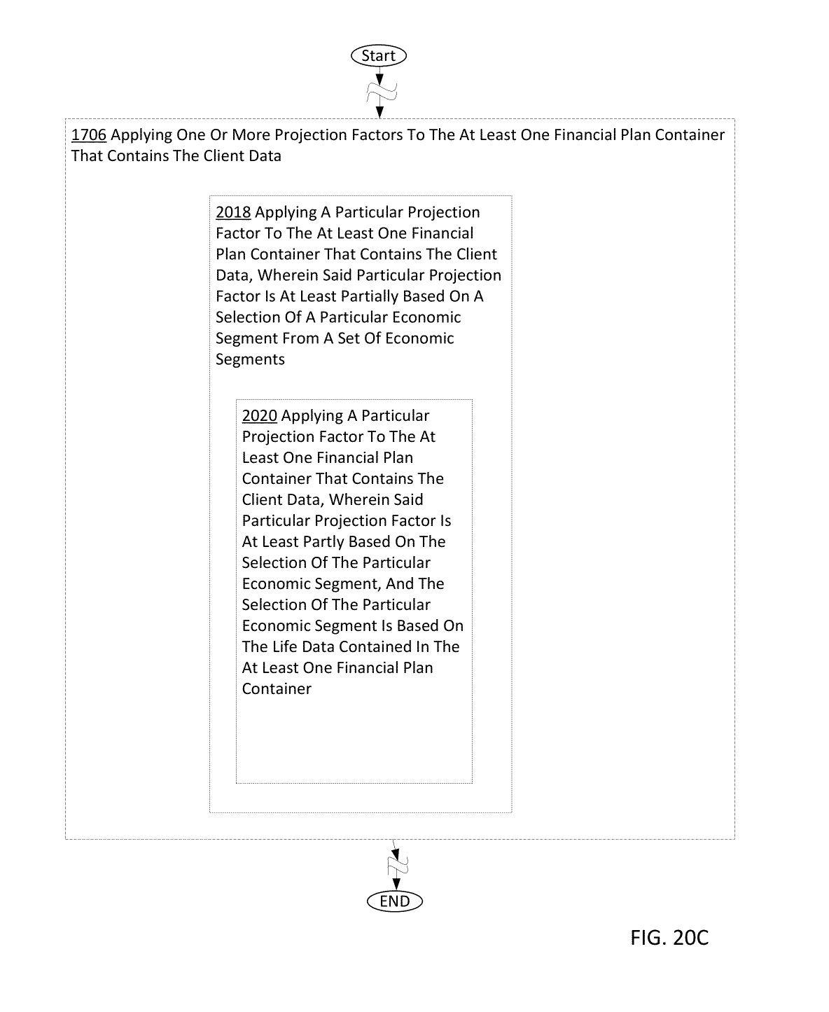

Referring now to FIG. 12, FIGS. 12A-12B show various implementations of projection factor applying to a financial plan container module 856 that is configured to apply one or more projection factors to the at least one container that contains the life data. For example, referring now to FIG. 12A, in an embodiment, projection factor applying to a financial plan container module 856 may include rule applying to a financial plan container module 1202 that is configured to apply one or more rules to the at least one financial plan container that contains the client data. For example, one or more rules may include “set the depreciation rate of this asset at 25% per year,” or “increase the cost of this expense by 2.4% each year to account for grocery inflation.” Referring now to FIG. 20A, in an embodiment, rule applying to a container module 1202 may carry out at least a portion of operation 2002 depicting applying one or more rules to the at least one financial plan container that contains the client data.

Referring again to FIG. 12A, in an embodiment, projection factor applying to a financial plan container module 856 may include projection applying to the financial plan container module 1204 that is configured to apply one or more projections to the at least one financial plan container that contains the client data. For example, one or more projections may be, “this asset will double in value in seven years,” or “in the year 2032, this asset will be worth 175,000 dollars.” In an embodiment, the projections may be container-specific, and in another embodiment, the projections may be general projections that are applied to the specific data in the container. Referring again to FIG. 20A, in an embodiment, projection applying to a container module 1204 may carry out at least a portion of operation 2004 depicting applying one or more projections to the at least one financial plan container that contains the client data.

Referring again to FIG. 12A, in an embodiment, projection factor applying to a financial plan container module 856 may include model applying to a financial plan container module 1206 that is configured to apply one or more models to the at least one financial plan container that contains the client data. For example, one or more models may be the Monte Carlo simulation, or a stochastic asset model. Referring again to FIG. 20A, in an embodiment, model applying to a container module 1206 may carry out at least a portion of operation 2006 depicting applying one or more models to the at least one financial plan container that contains the client data.

Referring again to FIG. 12A, in an embodiment, model applying to a financial plan container module 1206 may include model applying to a financial plan container module 1208 that is configured to project a value of a representative content of the financial plan container at a particular time based on the inputted client data. Referring again to FIG. 20A, model applying to a container module 1208 may carry out at least a portion of operation 2008 depicting applying one or more models to the at least one financial plan container that contains the client data, wherein said one or more models are configured to project a value of a representative content of the financial plan container at a particular time based on the inputted life data.

Referring now to FIG. 12B, in an embodiment, projection factor applying to a financial plan container module 856 may include financial plan container-associated projection factor applying to the financial plan container module 1210 configured to apply one or more projection factors that are associated with the at least one financial plan container, to the at least one financial plan container. For example, the one or more projection factors may be stored in one of the compartments of the container, e.g., a compartment 1565 of container 1500. Referring now to FIG. 20B, in an embodiment, container-associated projection factor applying to the container module 1210 may carry out at least a portion of operation 2010 depicting applying one or more projection factors to the at least one financial plan container that contains the client data, said one or more projection factors associated with the at least one financial plan container.

Referring again to FIG. 12B, in an embodiment, financial plan container-associated projection factor applying to the financial plan container module 1210 may include financial plan container type-associated projection factor applying to the financial plan container module 1212 configured to apply one or more projection factors that are associated with a type of the at least one financial plan container, to the at least one financial plan container. For example, a “house” container may have a number of projection models that are tied to a type of the container, e.g., an “asset” container, e.g., depreciation models, value increase models, inflation-indexed models, and the like. As another example, a “college education” container may have a projection model that is tied to a specific college that was inputted into the “college education” container, based on the historical inflation of tuition costs at that particular college. Referring again to FIG. 20B, in an embodiment, container type-associated projection factor applying to the container module 1212 may carry out at least a portion of operation 2012 depicting applying one or more projection factors to the at least one financial plan container that contains the client data, said one or more projection factors associated with a type of the at least one financial plan container.

Referring again to FIG. 12B, in an embodiment, projection factor applying to a financial plan container module 856 may include projection factor that is at least partially based on one or more further financial plan containers associated with one or more clients applying to the financial plan container module 1214. For example, the projection factors for a particular container may be at least partially based on that particular container of a set of other clients. For example, if a user has a “house” container, and the user lives in Washington, D.C., the system may look at other “house” containers of other users located in Washington D.C. to determine an average property tax expenditure, and apply a projection factor that is based on the other house containers of the other users. Referring again to FIG. 20B, in an embodiment, projection factor that is at least partially based on one or more further containers associated with one or more clients applying to the financial plan container module may carry out at least a portion of operation 2014 depicting applying one or more projection factors to the at least one financial plan container that contains the client data, wherein said one or more projection factors are at least partially based on one or more further financial plan containers associated with one or more clients.

Referring again to FIG. 12B, in an embodiment, projection factor applying to a financial plan container module 856 may include projection factor that is at least partially based on one or more changes in client data of a further financial plan container associated with a client applying to the financial plan container module 1216. For example, a user may have an “income tax” container that calculates her estimated tax rate at 25%. However, another container associated with the same user is a “job” container, and that container indicates that the client is taking a new job, with a 50,000 dollar per year pay increase. This data may cause the “income tax” container to change the calculated estimated tax rate. Thus, in various embodiments, changes to one of the containers that are used to generate the financial plan may have a ripple effect, which may change one or more of the other containers associated with the same client. Referring again to FIG. 20B, in an embodiment, projection factor that is at least partially based on one or more changes in client data of a further container associated with a client applying to the container module 1216 may carry out at least a portion of operation 2016 depicting applying one or more projection factors to the at least one financial plan container that contains the client data, wherein said one or more projection factors are at least partially based on changes in client data of one or more further financial plan containers associated with a client.

Referring now to FIG. 12C, in an embodiment, projection factor applying to a financial plan container module that 856 may include projection factor at least partially based on a selection of a particular economic segment from a set of discrete economic segments applying to a financial plan container module 1218. For example, referring again to FIG. 3, in an embodiment, one or more factors to be applied to the container may be based on a selected economic model for the client that is using the system. As discussed previously, if no economic model can be found, then one may be created and added to the set of economic models. Referring now to FIG. 20C, in an embodiment, projection factor at least partially based on a selection of a particular economic segment from a set of discrete economic segments applying to a container module 1218 may carry out at least a portion of operation 2018 depicting applying a particular projection factor to the at least one financial plan container that contains the client data, wherein said particular projection factor is at least partially based on a selection of a particular economic segment from a set of economic segments.

Referring again to FIG. 12C, in an embodiment, projection factor at least partially based on a selection of a particular economic segment from a set of discrete economic segments applying to a financial plan container module 1218 may include projection factor at least partially based on a container-based selection of a particular economic segment from a set of discrete economic segments applying to a financial plan container module 1220. For example, similarly to as above with respect to module 1218, an economic segment may be selected to apply to the container, and the selection of the economic segment may be based on the data that is contained in the container, e.g., that was inputted by the client through the user interface specified by the container. Referring again to FIG. 20C, in an embodiment, projection factor at least partially based on a container-based selection of a particular economic segment from a set of discrete economic segments applying to a financial plan container module 1220 may carry out at least a portion of operation 2020 depicting applying a particular projection factor to the at least one financial plan container that contains the client data, wherein said particular projection factor is at least partly based on the selection of the particular economic segment, and the selection of the particular economic segment is based on the life data contained in the at least one financial plan container.

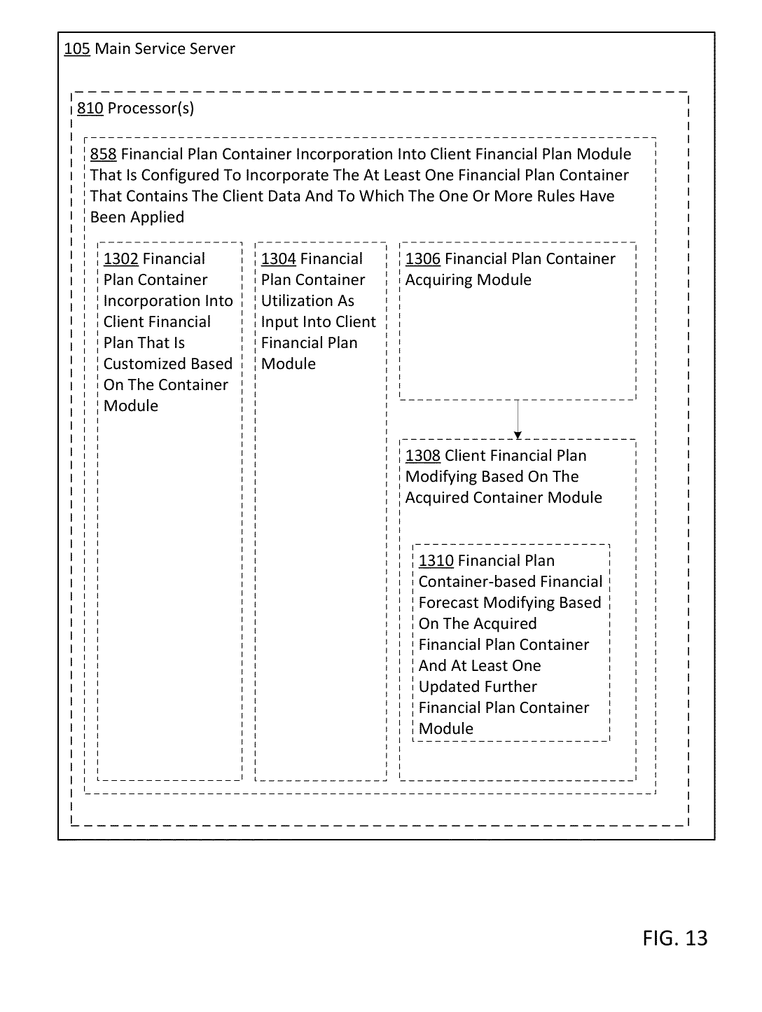

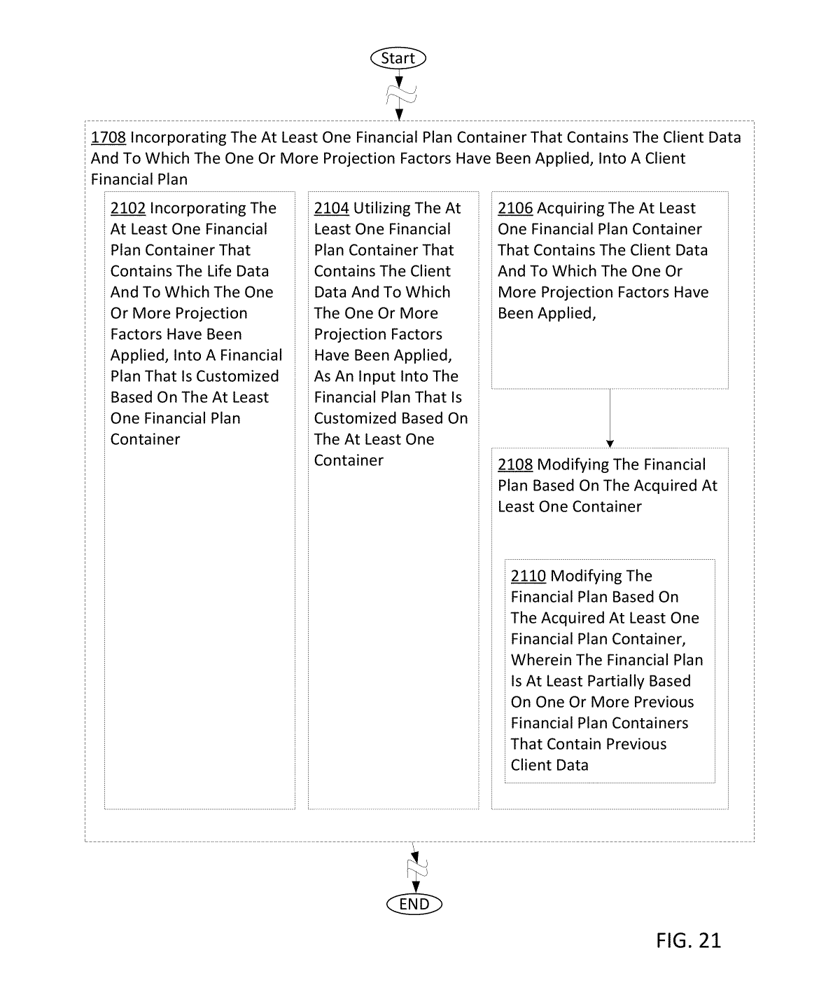

FIG. 13 shows various implementations of financial plan container incorporation into client financial plan module 858 that is configured to incorporate the at least one financial plan container that contains the client data and to which the one or more rules have been applied. For example, referring again to FIG. 13, in an embodiment, financial plan container incorporation into client financial plan module 858 may include financial plan container incorporation into client financial plan that is customized based on the container module 1302. Referring now to FIG. 21A, in an embodiment, financial plan container incorporation into client financial plan that is customized based on the container module 1302 may carry out at least a portion of operation 2102 depicting incorporating the at least one financial plan container that contains the life data and to which the one or more projection factors have been applied, into the client financial plan that is customized based on the at least one financial plan container.

Referring again to FIG. 13, in an embodiment, financial plan container incorporation into client financial plan module 858 may include financial plan container utilization as input into client financial plan module 1304. For example, the container that contains the client data may be used as an input into a financial forecast, so that, when several different containers are grouped together, e.g., a job container, a house container, a savings container, a debt container, and so forth, are combined, a financial forecast that is completely customized to the client can be generated, without requiring specific financial knowledge from the client. Referring again to FIG. 21, in an embodiment, financial plan container utilization as input into client financial plan module 1304 may carry out at least a portion of operation 2104 depicting utilizing the at least one financial plan container that contains the client data and to which the one or more projection factors have been applied, as an input into the client financial plan that is customized based on the at least one container.

Referring again to FIG. 13, in an embodiment, financial plan container incorporation into client financial plan module 858 may include one or more of a financial plan container acquiring module 1306 and a client financial plan modifying based on the acquired container module 1308. For example, when a client enters data into a new container, e.g., a “new car” container, that container may be acquired by the financial forecast engine, and the financial forecast may be updated, modified, or otherwise changed to take the new car into consideration, e.g., by adding a “monthly car payment” expense to a “monthly expenses” container, by changing a value in an “auto insurance” container and in a “property tax” container, and then re-running the financial projections in view of the acquired container and any updated containers. Referring again to FIG. 21, in an embodiment, acquired financial plan container module 1306 may carry out at least a portion of operation 2106 depicting acquiring the at least one financial plan container that contains the client data and to which the one or more projection factors have been applied, and client financial plan modifying based on the acquired container module 1308 may carry out at least a portion of operation 2108 depicting modifying the client financial plan based on the acquired at least one container.

Referring again to FIG. 13, client financial plan modifying based on the acquired container module 1308 may include financial plan container-based financial forecast modifying based on the acquired financial plan container and at least one updated further financial plan container module 1310. For example, when a client enters data into a new container, e.g., a “new car” container, that container may be acquired by the financial forecast engine, and the financial forecast may be updated, modified, or otherwise changed to take the new car into consideration, e.g., by adding a “monthly car payment” expense to a “monthly expenses” container, by changing a value in an “auto insurance” container and in a “property tax” container, and then re-running the financial projections in view of the acquired container and any updated containers. Referring again to FIG. 21, in an embodiment, financial plan container-based financial forecast modifying based on the acquired financial plan container and at least one updated further financial plan container module 1310 may carry out at least a portion of operation 2110 depicting modifying the client financial plan based on the acquired at least one financial plan container, wherein the client financial plan is at least partially based on one or more previous financial plan containers that contain previous client data.

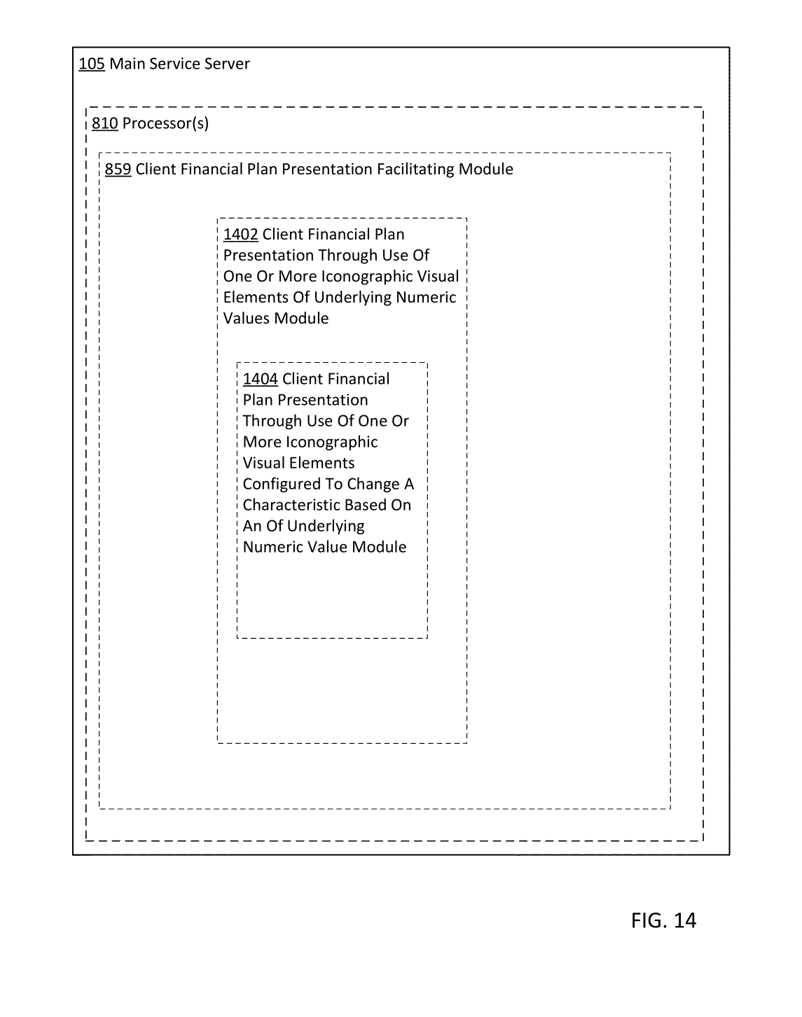

Referring now to FIG. 14, FIG. 14 shows various implementations of financial plan presentation facilitating module 859, according to embodiments. An example of the visual representations generated in financial forecast presentation facilitating module 859, according to one or more embodiments, may be found in FIGS. 23 and 24. In an embodiment, referring again to FIG. 14, financial plan presentation facilitating module 859 may include a client financial plan presentation through use of one or more iconographic visual elements of underlying numeric values module 1402. For example, in an embodiment, cash flow distribution between financial life events is visually represented in the financial plan or forecast. In another embodiment, the timing of life events and between life events also is visually represented in the client financial plan or forecast.

In another embodiment, a visual representation of the health of the overall plan, as measured by the client financial plan or forecast, may be shown. For example, the system may determine that a client is on track to hit an 80% confidence interval that the plan will realize for a particular time period, e.g., ten years out.

In another embodiment, a visual representation of the health of particular events may be shown, e.g., the likelihood of being able to retire at age 55, the likelihood of saving 100,000 dollars for a child's college fund, and so forth.

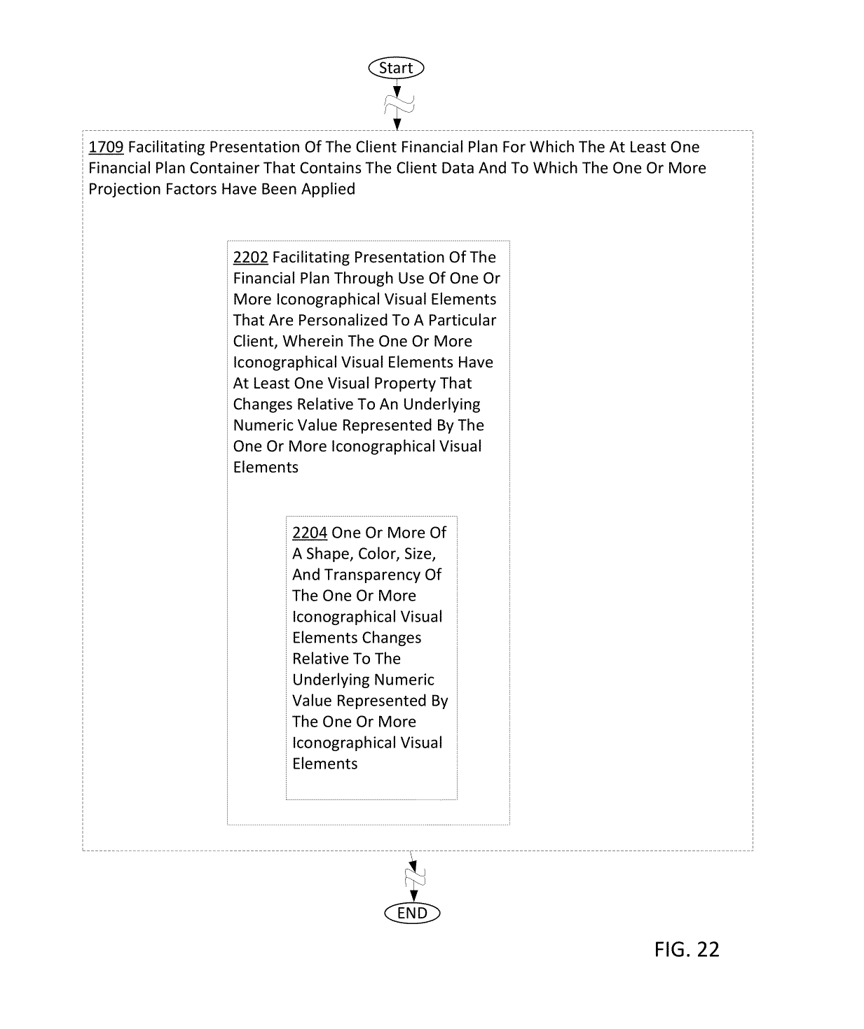

Referring now to FIG. 22, in an embodiment, client financial plan presentation through use of one or more iconographic visual elements of underlying numeric values module 1402 may carry out at least a portion of operation 2202 depicting facilitating presentation of the client financial plan through use of one or more iconographical visual elements that are personalized to a particular client, wherein the one or more iconographical visual elements have at least one visual property that changes relative to an underlying numeric value represented by the one or more iconographical visual elements.

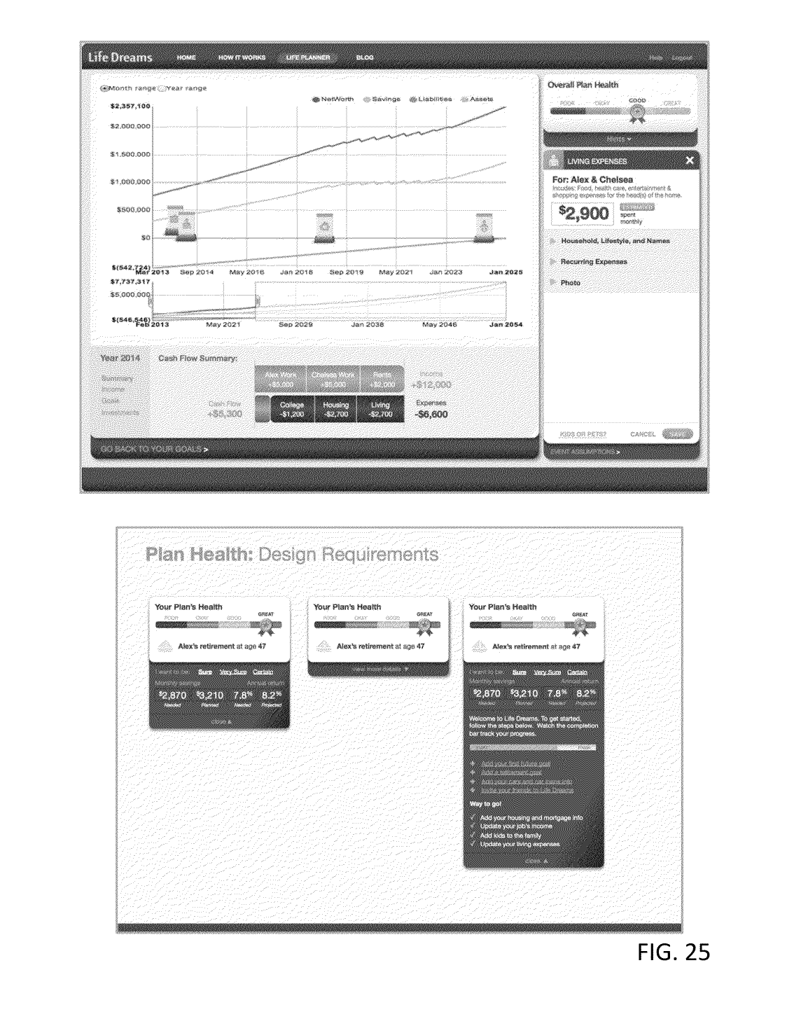

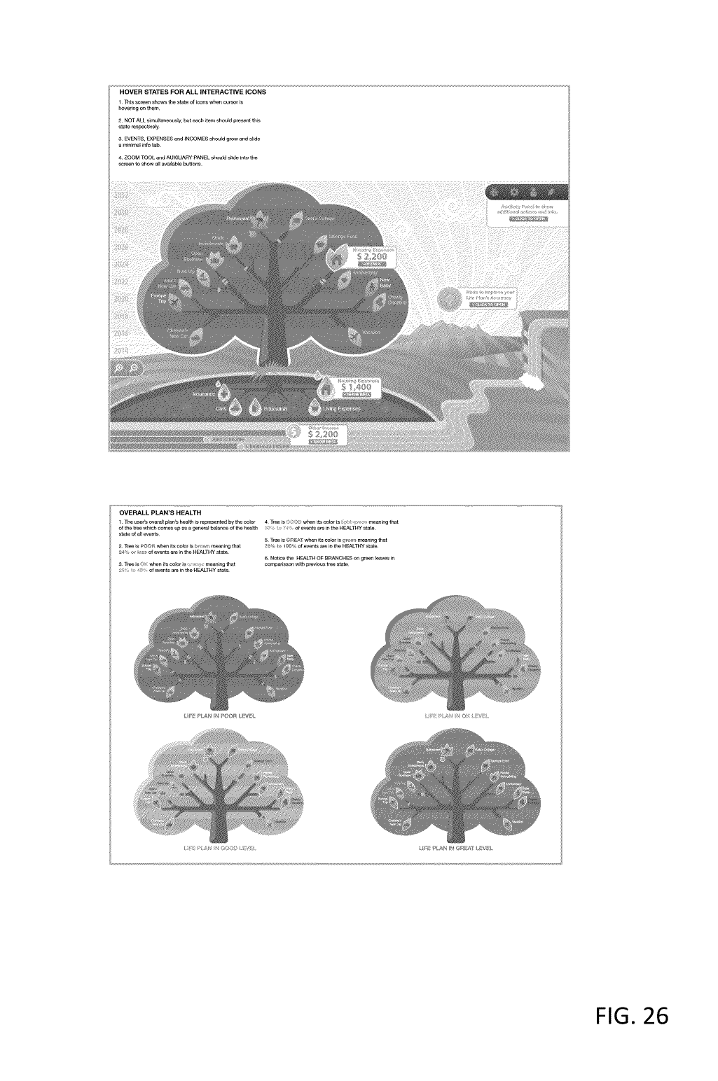

Referring again to FIG. 14, in an embodiment, client financial plan presentation through use of one or more iconographic visual elements of underlying numeric values module 1402 may include client financial plan presentation through use of one or more iconographic visual elements configured to change a characteristic based on an of underlying numeric value module 1404. Similarly to as above, an example of the visual representations generated in client financial plan presentation facilitating module 859, according to one or more embodiments, may be found in FIGS. 25 and 26. Referring again to FIG. 22, in an embodiment, client financial plan presentation through use of one or more iconographic visual elements configured to change a characteristic based on an of underlying numeric value module 1404 may carry out at least a portion of operation 2204 depicting one or more of a shape, color, size, and transparency of the one or more iconographical visual elements changes relative to the underlying numeric value represented by the one or more iconographical visual elements.

FIGS. 23-26 depict various implementations of a representation of the client financial plan or forecast that is generated, e.g., at least partly based on the one or more financial plan containers, and for which presentation to the client may be facilitated. The implementations are intended to be exemplary, and those of skill in the art will recognize that details of the implementations may be easily changed, in keeping with the scope of this disclosure.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1. A computationally-implemented method, comprising:
generating at least one financial plan container that includes a template of one or more variables, said financial plan container configured to receive and/or contain client data, and said template of one or more variables is based on one or more of a type of the financial plan container and financial plan data;
facilitating presentation of at least a portion of the at least one financial plan container that is configured to receive the client data;
applying one or more projection factors to the at least one financial plan container that contains the client data; and
incorporating the at least one financial plan container that contains the client data and to which the one or more projection factors have been applied, into a client financial plan.

2. The computationally implemented method of claim 1, further comprising:
facilitating presentation of the client financial plan for which the at least one financial plan container that contains the client data and to which the one or more projection factors have been applied.

3. The computationally-implemented method of claim 2, wherein said facilitating presentation of the client financial plan for which the at least one financial plan container that contains the client data and to which the one or more projection factors have been applied comprises:
facilitating presentation of the client financial plan through use of one or more iconographical visual elements that are personalized to a particular client, wherein
the one or more iconographical visual elements have at least one visual property that changes relative to an underlying numeric value represented by the one or more iconographical visual elements.

4. (canceled)

5. (canceled)

6. (canceled)

7. The computationally-implemented method of claim 2, wherein said facilitating presentation of the client financial plan for which the at least one financial plan container that contains the client data and to which the one or more projection factors have been applied comprises:
facilitating presentation of the client financial plan as a visual representation of one or more of:
a risk interval of the financial plan; and
a status over time of the client financial plan as an iconographical visual element that is personalized to a particular client.

8. (canceled)

9. The computationally-implemented method of claim 1, wherein said generating at least one financial plan container that includes a template of one or more variables, said financial plan container configured to receive and/or contain client data, and said template of one or more variables is based on one or more of a type of the financial plan container and financial plan data comprises:
generating at least one financial plan container that includes the template of one or more variables, said financial plan container configured to receive client data, and said template of one or more variables is based on the type of the financial plan container.

10. (canceled)

11. (canceled)

12. (canceled)

13. (canceled)

14. The computationally-implemented method of claim 1, wherein said generating at least one financial plan container that includes a template of one or more variables, said financial plan container configured to receive and/or contain client data, and said template of one or more variables is based on one or more of a type of the financial plan container and financial plan data comprises:
generating at least one financial plan container that includes a template of one or more variables, wherein:
the financial plan container is configured to receive client data;
the one or more variables are selected based on the type of the financial plan container; and
one or more values for the one or more variables are based on the financial plan data.

15. The computationally-implemented method of claim 14, wherein said generating at least one financial plan container that includes a template of one or more variables comprises:
generating at least one financial plan container that includes a template of one or more variables, wherein:
the financial plan container is configured to receive client data;
the one or more variables are selected based on the type of the financial plan container; and
the one or more values for the one or more variables are based on financial plan data of one or more further clients that have one or more further financial plans that include one or more further financial plan containers.

16. (canceled)

17. The computationally-implemented method of claim 1, wherein said generating at least one financial plan container that includes a template of one or more variables, said financial plan container configured to receive and/or contain client data, and said template of one or more variables is based on one or more of a type of the financial plan container and financial plan data comprises:
generating at least one financial plan container that includes a template of one or more variables, said financial plan container configured to receive client data, and said one or more variables are selected at least partly based on financial plan data.

18. (canceled)

19. (canceled)

20. (canceled)

21. (canceled)

22. (canceled)

23. (canceled)

24. The computationally-implemented method of claim 1, wherein said generating at least one financial plan container that includes a template of one or more variables, said financial plan container configured to receive and/or contain client data, and said template of one or more variables is based on one or more of a type of the financial plan container and financial plan data comprises:
generating at least one financial plan container that includes the template of one or more variables, wherein the at least one financial plan container is a life card that corresponds to one or more events, occurrences, states, and conditions.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. The computationally-implemented method of claim 1, wherein said generating at least one financial plan container that includes a template of one or more variables, said financial plan container configured to receive and/or contain client data, and said template of one or more variables is based on one or more of a type of the financial plan container and financial plan data comprises:
generating the at least one financial plan container that includes the template of the one or more variables, wherein the template of the one or more variables is modified based on other clients' input to other containers that are similar to the at least one financial plan container.

39. The computationally-implemented method of claim 38, wherein said generating the at least one financial plan container that includes the template of the one or more variables, wherein the template of the one or more variables is modified based on other clients' input to other containers that are similar to the at least one financial plan container comprises:
generating the at least one financial plan container that includes the template of the one or more variables, wherein the template of the one or more variables is modified based on other clients' input to other containers that are the same as the financial plan container.

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. The computationally-implemented method of claim 1, wherein said facilitating presentation of at least a portion of the at least one financial plan container that is configured to receive the client data comprises:
facilitating presentation of the particular financial plan container of the at least one financial plan container, said particular financial plan container configured to receive the client data, and said particular financial plan container selected at least partly based on an indication that a client is providing client data to a financial plan container for a first time.

67. (canceled)

68. (canceled)

69. The computationally-implemented method of claim 1, wherein said applying one or more projection factors to the at least one financial plan container that contains the client data comprises:
applying one or more models to the at least one financial plan container that contains the client data.

70. The computationally-implemented method of claim 69, wherein said applying one or more models to the at least one financial plan container that contains the client data comprises:
applying one or more models to the at least one financial plan container that contains the client data, wherein said one or more models are configured to project a value of a representative content of the financial plan container at a particular time based on the inputted life data.

71. The computationally-implemented method of claim 1, wherein said applying one or more projection factors to the at least one financial plan container that contains the client data comprises:
applying one or more projection factors to the at least one financial plan container that contains the client data, said one or more projection factors associated with the at least one financial plan container.

72. (canceled)

73. The computationally-implemented method of claim 1, wherein said applying one or more projection factors to the at least one financial plan container that contains the client data comprises:
applying one or more projection factors to the at least one financial plan container that contains the client data, wherein said one or more projection factors are at least partially based on one or more further financial plan containers associated with one or more clients.

74. The computationally-implemented method of claim 1, wherein said applying one or more projection factors to the at least one financial plan container that contains the client data comprises:
applying one or more projection factors to the at least one financial plan container that contains the client data, wherein said one or more projection factors are at least partially based on changes in client data of one or more further financial plan containers associated with a client.

75. (canceled)

76. (canceled)

77. (canceled)

78. (canceled)

79. (canceled)

80. The computationally-implemented method of claim 1, wherein said incorporating the at least one financial plan container that contains the client data and to which the one or more projection factors have been applied, into a client financial plan comprises:
utilizing the at least one financial plan container that contains the client data and to which the one or more projection factors have been applied, as an input into the client financial plan that is customized based on the at least one container.

81. The computationally-implemented method of claim 1, wherein said incorporating the at least one financial plan container that contains the client data and to which the one or more projection factors have been applied, into a client financial plan comprises:
acquiring the at least one financial plan container that contains the client data and to which the one or more projection factors have been applied; and
modifying the client financial plan based on the acquired at least one container.

82. The computationally-implemented method of claim 81, wherein said modifying the client financial plan based on the acquired at least one container comprises:
modifying the client financial plan based on the acquired at least one financial plan container, wherein the client financial plan is at least partially based on one or more previous financial plan containers that contain previous client data.

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)
